(19) United States
(12) Patent Application Publication
(10) Pub. No.: US 2023/0295458 A1
(43) Pub. Date: Sep. 21, 2023

(54) COMPOSITION FOR A COATING, COATINGS AND METHODS THEREOF

(71) Applicant: GRAPHITE INNOVATION AND TECHNOLOGIES INC, Dartmouth (CA)

(72) Inventors: Marciel GAIER, Truro (CA); Mohammed ALGERMOZI, Halifax (CA); Ilia RODIONOV, Dartmouth (CA)

(21) Appl. No.: 17/924,190

(22) PCT Filed: May 13, 2021
(86) PCT No.: PCT/CA2021/000042

§ 371 Date: Nov. 9, 2022

Related U.S. Application Data
(60) Provisional application No. 63/024,447, filed on May 13, 2020.

(51) Int. Cl. C09D 163/00; C09D 7/20; C09D 7/40; C09D 7/63; C09D 7/65; C08L 63/00; C08K 5/17; C08K 3/04; C08K 3/22; C09D 5/16

(52) U.S. Cl. CPC C09D 163/00; C09D 7/20; C09D 7/70; C09D 7/63; C09D 7/65; C08L 63/00; C08K 5/17; C08K 3/042; C08K 3/22; C09D 5/16; C08K 2003/2241; C08K 2201/005

(57) ABSTRACT

A composition that can be used to form an epoxy-based coating for use in wet environments, the coating exhibiting anti-fouling/foul-releasing properties, improved corrosion resistance, increased mechanical strength, or bending strength of at least 10 mm (relative to a control coating).

### CROSS REFERENCE TO RELATED APPLICATION

This application claims priority to United States Provisional Patent Application number U.S. 63/024,447, filed May 13, 2020, the entire contents of which are hereby incorporated by reference.

### FIELD

The present disclosure relates generally to coatings for use in wet environments.

### BACKGROUND

The following paragraphs are not an admission that anything discussed in them is prior art or part of the knowledge of persons skilled in the art.

Fouling is the accumulation of unwanted material on solid surfaces to the detriment of function. Fouling materials can consist of either living organisms such as microorganisms, plants, algae, or animals (biofouling) or a non-living substance (inorganic and/or organic). Fouling is usually distinguished from other surface-growth phenomena, in that it occurs on a surface of a component, system or plant performing a defined and useful function, and that the fouling process impedes or interferes with this function. Fouling phenomena are common and diverse, ranging from fouling of ship hulls, natural surfaces in the marine environment (marine fouling), fouling of heat-transfer components through ingredients contained in the cooling water or gases.

Corrosion is also a well-known a process, which converts a refined metal to another form, such as to a metal oxide, hydroxide, or sulfide. It is the gradual destruction of materials (usually metals) by chemical and/or electrochemical reaction with their environment. Corrosion occurs particularly in objects which are exposed to water and/or humidity, for example those exposed to the weather, salt water, and other hostile environments.

Hence, fouling and corrosion are both common on surfaces exposed to water/humidity, such as ship components and other surfaces exposed to, for example, a marine environment, as well as surfaces of apparatus containing water (heat-transfer apparatus and the like).

### INTRODUCTION

The following introduction is intended to introduce the reader to this specification but not to define any invention. One or more inventions may reside in a combination or sub-combination of the compositions or method steps described below or in other parts of this document. The inventors do not waive or disclaim their rights to any invention or inventions disclosed in this specification merely by not describing such other invention or inventions in the claims.

Coatings and Coating Systems

Coatings that exhibit corrosion or fouling resistance, increased mechanical or bending strength, and/or anti-fouling/foul-releasing properties, are expected to play an increasingly important role in view of new environmental regulations, and that fact that dispersion of invasive species into marine ecosystems cause important environmental problems in national and international waters. Further, coatings that exhibit lower or reduced coefficients of friction are expected to play an increasingly important role, as increased underwater hull roughness can result in increased hull frictional resistance or vessel drag; and increased resistance or drag, in turn, results in additional power requirements that lead to an increase in fuel consumption and costs to maintain vessel speed. For example, frictional resistance can account for up to 90% of the total resistance experienced by ships. Generally, there are physical and biological (fouling) sources of hull roughness, including: plate waviness, plate laps, welds, weld quality, mechanical damage, corrosion, steel profile, and coatings condition (physical sources); and, animal fouling, weed fouling, and slime fouling (biological sources).

Factors that contribute to coating market growth are extensive use of coatings to ensure long-term protection of marine assets, and the implementation of the International Maritime Organization (IMO) ballast tank coating rules, a standard that is usually abbreviated as IMO PSPC (Performance Standard for Protective Coatings). Strict environmental regulations and customer preference for eco-friendly products are also boosting previsions. For example, the shipping industry has been searching for the a solution to biofouling since 2001, when the IMO banned the use of tributyltin (TBT) as a biocide in antifouling coatings. Biofouling control measures are often a priority investment for ship-owners, since fouling growth on a ship's hull can often significantly decrease energy efficiency. During a ship's journey, fuel consumption can constitute upwards of 50-60% of its operational cost, and this cost is only further increased from fouling's negative impacts on the hull's drag performance (for example, 84% increase in shaft power for a heavily fouled containership).

Currently, a popular method of biofouling control for the underwater hulls of marine vessels is to coat them with “antifouling coating systems”. The drag performance of a vessel's hull can be improved by choosing the proper coating system for the intended application and environment. Each marine coating system can be different, as they use various mechanisms to protect a ship's hull from biofouling and corrosion. A type of marine coating used to protect against fouling organisms is a biocide-based antifouling. These coatings are used for vessels which undergo long stationary periods to prevent a heavy buildup of fouling over time. Two types include Controlled Depletion Polymer (CDP) and Self Polishing Copolymer (SPC) coatings, which vary by the mechanisms they use for leeching toxic chemicals into the ocean.

Soft foul release coatings are considered an environmentally friendly alternative to CDP and SPC coatings, as they use the sheer force of water to remove fouling organisms without leeching biocides into the environment. These low friction topcoats are primarily silicone-based, and can prevent fouling under dynamic conditions (when the ship is in motion) due to a lower surface energy, slip, and elastomeric properties. Soft foul release coatings have become increasingly popular due to their inherent fuel savings, as they maintain a lower average hull roughness throughout their lifetime. A drawback of these coatings is that they contain silicon oils (1-10%), which can persist in the ocean, where the long-term environmental impact of these silicon oils is not fully understood. Further, silicone-based coatings often have low mechanical strength, due to the use of a pure siloxane backbone.

Hull cleanings both in drydock and in-water have been used to control biofouling growth, with in-water cleanings becoming popular since they avoid the cost of added labour and extra days of drydock. However, many jurisdictions strongly regulate in-water cleanings to prevent the release of toxic substances from antifouling coating systems during cleaning, and to prevent the spread of invasive species. Transversely, in-water hull cleanings have been recognized by the International Maritime Organization (IMO) and the United States Environmental Protection Agency (USEPA) as a measure to limit the transfer of invasive species when performed appropriately.

Generally, antifouling coatings are not designed to be cleaned by existing underwater hull grooming methods. After each hull cleaning, these coatings tend to mechanically degrade, which cuts down their lifetime, decreases their functionality, and pollutes the marine environment. For this reason, ship-owners tend to wait for the next dry-dock period to clean the hull and re-apply the antifouling system, sacrificing their fuel savings and increasing greenhouse gas (GHG) emissions. Another drawback of soft foul release coatings is that they are reliant on their ability to maintain a defect-free surface. However, due their weak adhesion between layers and softness of the topcoat, soft foul release coatings can be damaged during underwater hull cleaning operations. As a result, ship-owners opt not to clean their hulls even when a heavy layer of slime has built up. Heavy slime on a ship's hull has an associated fuel/power penalty which in some cases can be as high as 20%.

In contrast, ultra-hard coatings use resins reinforced with glass flakes and other armouring fillers to address this issue, as they are mechanically robust, long-lasting under periodic abrasive cleanings, and non-toxic. Such coatings are usually applied in two coats at a dry film thickness (DFT) of 500 μm to a properly prepared hull, either during a new build or in drydock for an in-service vessel. However, these coatings offer no antifouling or foul release properties, which contributes to a high surface roughness when compared to the other systems and adds an associated fuel penalty of its own.

Epoxy-Based Coatings

Epoxy-based coatings are popular for use in industrial, automotive, and marine applications, in part because they provide a quick-drying, tough and protective coating. Unlike heat cured powder coatings, epoxy-based coatings are quick and easy to apply, which make them suitable for many applications. For example, they are used on concrete and steel to give resistance to water, alkali, and acids; and, are used on metal cans and containers to prevent rusting.

Epoxy-functional monomers (also referred to as epoxy resins) are the well-known class of reactive monomers and/or pre-polymers that contain epoxide functional groups, and react to form epoxy-based coatings. Generally, epoxy resins react with a hardener, via a polymerization/crosslinking reaction, to form a solid, epoxy-based coating on a surface of a substrate. Epoxy resins may be reacted (for example, “cross-linked” or “cured”) with a wide range of hardeners, including acids (and acid anhydrides), phenols, alcohols, thiols, polyfunctional amines, amides, or combinations thereof.

Epoxy-based coatings are generally formulated based on an end product's performance requirements. When properly catalyzed and applied, epoxy resins can produce a hard, chemical and solvent resistant finish. Specific selection and combination of the epoxy resin and hardener, as well as any additionally added components (which may be referred to as additives), determine the final characteristics and suitability of the epoxy-based coating for a given environment. Epoxy-based coatings can have a wide range of applications, including metal coatings, use in electronics/electrical components/LEDs, high tension electrical insulators, paint brush manufacturing, fiber-reinforced plastic materials and structural adhesives.

Following their application to a substrate, epoxy-based coatings initially provide some corrosion resistance; however water permeability does happens over time, for example after 2 to 5 years. This causes significant wear and failure of the coating, requiring a new coating application. A common defect behind this failure is crystalline defects created during the curing of the epoxy resin, such as micro-cracks, pinholes, and/or structure-induced defects. These defects undesirably allow water, oxygen, and/or corrosive ions to penetrate the epoxy-based coating. Unfortunately, the emergence of these defects is inevitable. Epoxy-based coatings are also not known to have significant antifouling/foul-releasing properties; and may exhibit rather high coefficients of friction, which can be deleterious for some applications.

Compositions and Methods of the Present Disclosure

One or more embodiments of the present disclosure attempts to provide a composition that can be used to form an epoxy-based coating. In one or more embodiments, the present disclosure provides a composition that comprises epoxy-functional monomers, a diluent, and a hydrophobicity-modifying additive.

The epoxy-functional monomers of the composition provide the base for forming the epoxy-based coating, and comprise one or a combination of liquid monomers, or pre-polymers that contain epoxide functional groups. The epoxy-functional monomers can react, at least via the epoxide functional groups, to form an infusible, insoluble polymer network (also referred to as the epoxy-based coating) that comprises polymerized and/or cross-linked epoxy-functional monomers.

Generally, when purchased commercially, epoxy-functional monomers are viscous, or very viscous (for example, about 250 to about 3000 cps; about 1000 to about 3000 cps; or about 1500 to about 3000 cps; or about 3000 cps to >20 000 ops; or about 8000 cps); and so the diluent is included to reduce said viscosity and therefore improve processability of the composition. As such, the diluent has a lower viscosity that the epoxy-functional monomers; for example, a viscosity less than 1000 cps, such as between about 1 cps to about 800 ops. In some embodiments, the diluent comprises a reactive diluent that is reactive in an epoxide polymerization (for example, contains reactive functional groups that can at least react with the epoxy-functional monomers, such as hydroxyl, acrylate, maleimide, or epoxide functional groups), a non-reactive diluent (for example, does not contain reactive functional groups), or a combination thereof. In some embodiments, the reactive diluent comprises the hydrophobicity-modifying additive (for example, as described below).

Generally, epoxy-based coatings do not exhibit significant antifouling/foul-releasing properties, and so the hydrophobicity-modifying additive is included in the composition to improve those properties. Hydrophobicity-modifying additives of the present disclosure increase the hydrophobicity of the epoxy-based coatings into which they are incorporated (relative to epoxy-based coatings that do not comprise the additive; also referred to as a control coating), due to the additive's own hydrophobic properties. These hydrophobic properties can be measured by the critical surface tension of wetting. In some embodiments, the critical surface tension for a suitable hydrophobicity-modifying additive is between about 15 to about 60 mN/m, or between about 15 to about 55 nM/m, or between about 15 to about 40 mN/m, or between about 20 to about 30 mN/m when the hydrophobicity-modifying additive is present in the compositions up to about 10 wt %. In other embodiments, the critical surface tension for a suitable hydrophobicity-modifying additive is between about 15 to about 60 mN/m, or between about 15 to about 55 nM/m, or between about 15 to about 40 mN/m, or between about 20 to about 30 mN/m when the hydrophobicity-modifying additive is present in the compositions up to about 20 wt %. By increasing the hydrophobicity of the epoxy-based coating, the hydrophobicity-modifying additive contributes to reducing the coating's surface energy, which imparts improved antifouling/foul-releasing properties to the coating. The additive can be incorporated into epoxy-based coatings, in part because it is reactive in an epoxide polymerization (for example, contains reactive functional groups that can at least react with the epoxy-functional monomers, such as epoxide, acrylate, hydroxyl, or maleimide functional groups). In some embodiments of the present disclosure, the hydrophobicity-modifying additive comprises an acrylate oligomer, bis-maleimide oligomer, an epoxy-functional silane, an epoxy-functional polydialkylsiloxane, or a combination thereof.

In one or more embodiments, the present disclosure provides a composition further comprising a wear-inhibiting additive.

In some embodiments, the wear-inhibiting additive included in the composition comprises unmodified graphene nanoplatelets, unmodified graphite flakes, carbon black, fullerene, titanium dioxide, aluminum oxide, Ca magnesium silicate zinc oxide, or a combination thereof. Such additives can act as high-barrier fillers, increasing the diffusion path of the water, oxygen, and/or corrosive ions in a coating, making it difficult for them to reach the surface of a substrate and cause corrosion. In some embodiments, said additives may be included because they can increase mechanical or bending strength of a coating into which they are incorporated.

In some embodiments, the wear-inhibiting additive comprises unmodified graphene nanoplatelets, unmodified graphite flakes, titanium dioxide, aluminum oxide, Ca magnesium silicate, or a combination thereof. Graphene nanoplatelets may be included because they can exhibit a strength about 300 times greater than steel, all while being very flexible. Some embodiments that use graphene nanoplatelets as a wear-inhibiting additive in the composition have improved mechanical strength and/or bending strength to the epoxy-based coating into which the additive is incorporated (relative to epoxy-based coatings that do not comprise said additive, also referred to as a control coating). Further, graphene nanoplatelets can be manufactured with different flake sizes (for example, from 1 to 100 μm); such as large, thin flakes. When incorporated into a coating, such large, thick flakes can act as a physical and/or chemical barrier against corrosion. Some embodiments that use graphene nanoplatelets as wear-inhibiting additives have improved corrosion resistance to the epoxy-based coating into which the additives are incorporated (relative to a control coating). Graphite flakes may be incorporated as a wear-inhibiting additive in the composition as they can reduce the coefficient of friction of the epoxy-based coating into which the additive is incorporated (relative to epoxy-based coatings that do not comprise said additive, also referred to as a control coating). Titanium dioxide, aluminum oxide, or Ca magnesium silicate may be incorporated as a wear-inhibiting additive in the composition as they can increase mechanical or bending strength of a coating into which they are incorporated (relative to a control coating).

In one or more embodiments, the present disclosure provides a composition further comprising an amphiphilicity-modifying additive. Generally, epoxy-based coatings exhibit slip, or wet coefficient of friction values between about 0.2 and about 0.6, where industry standard is in a range from about 0.03 to about 0.08. As such, the amphiphilicity-modifying additive is included in the composition to improve this property.

The amphiphilicity-modifying additives of the present disclosure impart at least partial amphiphilicity to the surface of the epoxy-based coatings into which they are incorporated (relative to epoxy-based coatings that do not comprise the additive; also referred to as a control coating), due to the additive's own amphiphilic or hydrophilic properties. Amphiphilic refers to having both hydrophilic and hydrophobic properties. In one or more embodiments, the amphiphilic or hydrophilic properties of the amphiphilicity-modifying additives result, at least in part, from the additives comprising hydrophilic functional groups. In some embodiments, the hydrophilic functional groups are functional groups capable of hydrogen-bonding (i.e., accepting and/or donating) and/or charged functional groups capable of forming/attracting hydration spheres. In some embodiments, these functional groups are terminal groups or end groups, or pendant groups or side-chain groups. In one or more embodiments, the amphiphilicity-modifying additive is hydrophilic. For example, the amphiphilicity-modifying additives may comprise an oligomer or polymer having a hydrophilic backbone, and may comprise hydrophilic end groups and/or hydrophilic side-chains. In some embodiments, the amphiphilicity-modifying additive is amphiphilic, comprising both hydrophobic portions and hydrophilic portions. For example, the amphiphilicity-modifying additives may comprise an oligomer or polymer having a hydrophobic backbone, with hydrophilic end groups and/or hydrophilic side-chains; or the additives may comprise a co-polymer, such as a block or graft co-polymer, where at least one polymer of the co-polymer is hydrophilic (for example, due to its backbone and/or functional groups) and at least one polymer of the co-polymer is hydrophobic (for example, due to its backbone and/or pendant functional groups). In some embodiments, the functional groups capable of hydrogen-bonding (i.e., accepting and/or donating) comprise hydroxyl groups, hydroxyalkyl groups, fluorohydroxyalkyl groups, ether groups, ketone or aldehyde groups, ester groups, carboxylic acid groups, amine groups, amide groups, imine groups, nitrile groups, or a combination thereof. In some embodiments, the functional groups capable of forming/attracting hydration spheres comprise charged groups. In some embodiments, the charged functional groups comprise ammonium groups, carboxylate groups, alkoxy or aryloxy groups, nitro groups, or a combination thereof.

By imparting at least partial amphiphilicity to the surface of the epoxy-based coating, the amphiphilicity-modifying additive contributes to the formation of a partially hydrated, lubricious layer on the surface of the epoxy-based coating when the coating is immersed in a wet environment. The formation of this layer can render the surface slippery, and can make it difficult for fouling organisms/materials to attach, and remain attached to the surface of the coating. As a result, the amphiphilicity-modifying additives may reduce the wet coefficient of friction, and in addition to the hydrophobicity-modifying additives, the amphiphilicity-modifying additives may improve the antifouling/foul-releasing properties of the epoxy-based coating into which they've been incorporated, relative a control coating that does not include the amphiphilicity-modifying additive.

One or more compositions of the present disclosure can be used to form an epoxy-based coating by reacting the composition with a hardener, which may otherwise be referred to as curing the composition to form a cured epoxy-based coating. One or more compositions may be formulated to be sold in kits with instructions for using the composition with a hardener. In some embodiments, the kit separately includes a hardener. A hardener can trigger, and in some cases participate in the reaction (for example, polymerization and/or crosslinking) that converts at least the epoxy-functional monomers into an infusible, insoluble polymer network (which may be referred to as an epoxy-based coating). For example, the hardener may be reactive in an epoxide polymerization, such that it can trigger the polymerization, as well as act as a cross-linker in the reaction. In some embodiments, the hardener comprises polyfunctional acids (and acid anhydrides), phenols, alcohols, and thiols; or polyfunctional amines, amides, or combinations thereof. In some embodiments, the hardener comprises an amine hardener, an amide hardener, or a combination thereof. In other embodiments, the hardener is a silamine hardener, sometimes referred to as a aminosilane hardener. In some embodiments, the epoxy-based coating is formed on a substrate, where the substrate is a surface of a marine vessel (for example, boat, ship, etc.).

One or more embodiments of the present disclosure attempts to provide a composition that can be used to form an epoxy-based coating that exhibits anti-fouling/foul-releasing properties, improved corrosion resistance, increased mechanical strength, or bending strength of at least 10 mm (relative to a control coating). In some embodiments, the hydrophobicity-modifying additive is included in the composition to provide an epoxy-based coating that exhibits antifouling/foul-releasing properties. In some embodiments, the hydrophobicity-modifying is included in an amount sufficient to provide an epoxy-based coating having a contact angle of at least 90° (when measured with an Ossila Goniometer following ASTM D7334-08(2013); relative to a control coating). In some embodiments, the wear-inhibiting additive is included in the composition to provide an epoxy-based coating that exhibits improved corrosion resistance, increased mechanical strength, or bending strength of at least 10 mm (relative to a control coating). In some embodiments, the wear-inhibiting additive is included in an amount sufficient to provide a coating having improved corrosion resistance of at least 1000 hours when measured by salt fog resistance, an increased mechanical strength with a D-shore hardness of at least 30D or at least 40D, or a bending strength of at least 10 mm when measured by a cylindrical bed test. In further embodiments, the wear-inhibiting additive is included in the composition to provide an epoxy-based coating that exhibits reduced coefficient of friction (relative to a control coating). In some embodiments the wear-inhibiting additive is included in an amount sufficient to provide a coating having a coefficient of friction of <0.3 (for example, a coefficient of friction of about 0.1, indicating <10% force lost to friction). In some embodiments, the amphiphilicity-modifying additive is included in the composition to provide an epoxy-based coating that exhibits reduced wet coefficient of friction (relative to a control coating). In some embodiments, the amphiphilicity-modifying additive is included in an amount sufficient to provide a coating having a coefficient of friction of ≤0.4, or ≤0.2 when measured using an ASM 925 COF meter (American Slipmeter) following ASTM D2047, such as about 0.05 to about 0.15.

One or more embodiments of the present disclosure attempts to provide a composition that can be used to form an epoxy-based coating that combines the benefits of ultra-hard coatings with soft-foul release products. The epoxy-based coatings of the present disclosure may allow ship-owners to enjoy the benefits of a hard cleanable surface while obtaining fuel savings from its foul release properties without leaching biocides or silicone oils. One or more embodiments of the present disclosure attempts to provide a composition that can be used to form an epoxy-based coating that can cleaned by most hull grooming methods and water jet pressures. In some embodiments, the benefits of epoxy-based coatings of the present disclosure may be due, in part, to the use of graphene as a nano-scale armouring additive. As described above, graphene is known for its high mechanical strength, ultra-low friction, and incredible toughness.

One or more embodiments of the present disclosure also provides an additives composition for use in forming a coating, the composition comprising the above-described hydrophobicity-modifying additive and wear-inhibiting additive, and optionally the amphiphilicity-modifying additive. In use, the additives composition is added to a pre-cured coating composition in amounts sufficient for forming a coating having a contact angle of at least 90° (when measured with an Ossila Goniometer following ASTM D7334-08(2013)); having improved corrosion resistance of at least 1000 hours when measured by salt fog resistance, increased mechanical strength with a D-shore hardness of at least 30D or at least 40D, or bending strength of at least 10 mm when measured by a cylindrical bed test; and/or optionally having a wet coefficient of friction of ≤0.4, or ≤0.3, or ≤0.2, or in a range of about 0.05 to about 0.15 (when measured using an ASM 925 COF meter (American Slipmeter) following ASTM D2047).

Further, one or more embodiments of the present disclosure provides a method for forming one or more of the above-described compositions. In some embodiments, the method comprises mixing the hydrophobicity-modifying additive into a first mixture comprising the epoxy-functional monomers and the diluent. In some embodiments, the method further comprises mixing the amphiphilicity-modifying additive into the first mixture. In some embodiments, the method further comprises mixing the wear-inhibiting additive and dispersant into the first mixture.

### BRIEF DESCRIPTION OF THE FIGURES

Embodiments of the present disclosure will now be described, by way of example only, with reference to the attached Figures.

FIG. 1 depicts shelf-life stability testing of samples 1-7 after one day, one week, two weeks, three weeks, and one month, wherein the compositions comprise epoxy-functional monomers and diluent, graphene nanoplatelets and graphite flakes, and: (1) no shelf-life additive; (2) 0.5% of shelf-life additive S-NCN (NACCONOL 90G); (3) 0.1% S-NCN (NACCONOL 90G); (4) 0.5% of shelf-life additive S-SP (SOLPLUS D610); (5) 0.1% S-SP (SOLPLUS D610); (6) 0.5% of shelf-life additive S-KS (K-SPERSE A504); and (7) 0.1% S-KS (NACCONOL 90G).

FIG. 2 depicts shelf-life stability testing of the samples 1-7 of FIG. 1 after one day, one week, one month, and two months; and samples 4, 5, and 7 after one month in a full composition, based on composition 51 described below.

FIG. 3 depicts a cured epoxy-based coating of the present disclosure.

FIG. 4 depicts a 1000× magnification of the epoxy-based coating of FIG. 3.

FIG. 5 depicts a cured control coating.

FIG. 6 depicts a 1000× magnification of the control coating of FIG. 5.

FIG. 7 depicts an Fourier Transform Infrared (FTIR) spectrum of an epoxy resin from wavenumbers (1/cm) from 3800 to 1800 (A) and from 1800 to 400 (B).

FIG. 8 depicts an FTIR spectrum of a hardener from wavenumbers (1/cm) from 3800 to 2000 (A) and from 2000 to 400 (B).

FIG. 9 depicts an FTIR spectrum of the N—H bond of the hardener vs a cured coating; where the arrows A indicate wavenumbers 2918-2850 1/cm which relate to N—H bond are not seen for cured coating due to OH bond overlay.

FIG. 10 depicts an FTIR spectrum of additive Additol VXW 6208 from wavenumbers (1/cm) from 3800 to 2000 (A) and from 2000 to 400 (B).

FIG. 11A depicts an FTIR spectrum of BMI 1700 Additive from wavenumbers (1/cm) from 3800 to 2000 (1) and from 2000 to 400 (2); 11B depicts an FTIR spectrum comparing of the BMI 1700 Additive (A) and other pre-cured compositions (B, Comp #42; and C, Comp #48).

FIG. 12 depicts comparison FTIR spectra of the epoxy oxirane C—O group.

FIG. 13 depicts “hydrophobicity” tests of the surface of epoxy-based coatings formed from compositions 41, 42, 43 (See Example 1), where fewer water droplets left on the surface indicates lower the surface energy.

FIG. 14 depicts results of a pencil hardness scratch test of epoxy-based coatings of the present disclosure relative to commercially available soft foul-release coatings.

FIG. 15 depicts static biofouling growth of epoxy-based coatings of the present disclosure (XGIT; composition 206-Si), polyvinyl chloride (PVC) negative control, and a soft foul release (SFR) coating.

FIG. 16 depicts fouling rate comparisons of the coated panels of FIG. 15 (XGIT composition 206-Si, PVC, and SFR).

FIG. 17 depicts FTIR spectra of the epoxy-functional epoxide-siloxane monomer Silikopon ED (top) and bis-phenol epoxy-functional monomers (bottom).

FIG. 18 depicts the FTIR spectra of cured epoxy-based coatings comprising epoxy-functional epoxide-siloxane monomers of the present disclosure (1; Composition 204-Si), (2; Composition 207-Si), (3; Composition 208-Si), (4; Composition 209-Si).

FIG. 19 depicts a graphical comparison of wet friction coefficient values measured for “Base-line” composition #1, and compositions #200-Si, 204-Si, 206-Si, 208-Si, 209-Si, and 210-Si.

FIG. 20 depicts pictorially results of static marine fouling tests performed on coatings described in the present disclosure, as compared to commercially available foul-release systems, wherein N were north-facing racks and S were south-facing racks.

FIG. 21 depicts graphically results from FIG. 20.

FIG. 22 depicts an FTIR spectrum of additive Epoxy-functional Polydimethylsiloxane (BYK-Silclean 3701) from wavenumbers (1/cm) from 5000 to 2800 (A) and from 2800 to 400 (B).

FIG. 23 depicts an FTIR spectrum of additive Glycidoxypropyltrimethoxysilane (Epoxy functional silane) (Andisil 187 Silane) from wavenumbers (1/cm) from 5000 to 2600 (A) and from 2600 to 400 (B).

FIG. 24 depicts an FTIR spectrum of additive Silicone glycol modified liquid hydrocarbons (ADDITOL VXW 6210N) from wavenumbers (1/cm) from 5000 to 2600 (A) and from 2600 to 400 (B).

FIG. 25 depicts a cured epoxy-based coating of the present disclosure, formed from composition 206-Si at 10× magnification.

### DETAILED DESCRIPTION

### Definitions

Unless defined otherwise, all technical and scientific terms used herein have the same meaning as commonly understood by one of ordinary skill in the art to which this invention belongs.

As used in the specification and claims, the singular forms “a”, “an” and “the” include plural references unless the context clearly dictates otherwise.

The term “comprising” as used herein refers to the list that follows is non-exhaustive and may or may not include any other additional suitable items, for example one or more further feature(s), component(s) and/or ingredient(s) as appropriate.

Used herein, (a) “composition for a coating”, (b) “coating composition”, (c) “pre-cured composition”, or (d) “pre-cured coating composition” refers to a composition of the present disclosure that has yet to be reacted or cured with a hardener to form a coating.

Used herein, (a) “coating formed from the composition”, (b) “coating formed from the coating composition”, (c) “cured coating”, or (d) “cured epoxy-based coating” refers to a coating comprising a reaction product of a composition of the present disclosure and a hardener (i.e., a coating that has been cured).

Used herein, (a) “coatings that do not comprise such additives”, (b) “control coating”, or (c) “control epoxy-based coating” refers to coatings consisting of a reaction product of a hardener and a composition that consists of suitably diluted epoxy-functional monomers.

Used herein, “curing composition” refers to a pre-cured composition that has been mixed with a hardener, but has yet to cure to form a cured epoxy-based coating.

Used herein, to be “incorporated into [a/the] polymerization” refers to a compound or molecule (for example, an additive, monomer, oligomer, pre-polymer) that comprises functional groups that are reactive in an epoxide polymerization, and/or that are reactive with side-chains groups, pendent groups, end groups, or terminal groups of epoxy-functional monomers (for example, siloxane/silicone/polysiloxane side-chains), such that the compound or molecule act as a reagent (for example, a monomer, cross-linker, etc.) in the reaction. Used herein, to be “entrapped during [a/the] polymerization” refers to a compound or molecule (for example, an additive, monomer, oligomer, pre-polymer) that becomes physically entangled in the infusible, insoluble polymer network (the epoxy-based coating) as it forms.

Used herein “oligomer” or “lower molecular weight polymer” refers to a polymer comprising a smaller number of repeat units, whose physical properties are significantly dependent on the length of the chain. For example, a smaller number of repeat units may be between 1-100, or between 1-50, or between 1-20, or between 1-10. For further example, a large number of repeat units may be in the hundreds, or thousands, or more.

Used herein, “monomer(s)” refers to (i) a monomer or system of monomers capable of polymerization by reactive groups to a higher molecular weight, such as a cured coating; and/or (ii) a pre-polymer, which refers to a monomer or system of monomers that have been reacted to an intermediate molecular mass state that is capable of further polymerization by reactive groups to a higher molecular weight, such as a cured coating. Mixtures of reactive polymers with un-reacted monomers may also be referred to herein as “monomer(s)”.

As used herein, “A, B, . . . X, and/or Y” refers to “A, B, . . . X, and Y”; or “one of A, B, . . . X, or Y”; or any combination of A, B, . . . X, Y.

“Reactive in an epoxy polymerization”, when used in the context of herein described additives or diluents, refers to comprising or containing reactive functional groups that can at least react with herein described epoxy-functional monomers to form an infusible, insoluble polymer network (herein described epoxy-based coating). “Reactive in an epoxy polymerization”, when used in the context of herein described hardeners, refers to (a) triggering the curing of a pre-cured composition; (b) being incorporated into the polymerization (for example, as a monomer and/or cross-linker) of at least the epoxy-functional monomers as the pre-cured compositions are cured to form epoxy-based coatings; or (c) comprising or containing reactive functional groups that can at least react with herein described epoxy-functional monomers to form an infusible, insoluble polymer network (herein described epoxy-based coating).

Used herein, “epoxy-functional” refers to a compound or molecule (for example, an additive, monomer, pre-polymer) that is at least reactive in an epoxy polymerization and comprises at least one epoxide functional group, a non-limiting representative example of which is as follows:

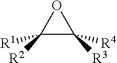

Whereas, “Epoxy-based” refers to a coating formed from at least one epoxy-functional compound or molecule.

In the context of the present disclosure, “epoxy-functional monomers” and “epoxy resin” are used interchangeably. Further, in the context of the present disclosure “polymerization of the epoxy-functional monomers” refers to polymerizing at least the epoxy-functional monomers during the curing of the pre-cured composition, but is not meant to exclude any other components of the pre-cured composition from the reaction. As used herein, “polymerization” refers to the formation of polymer chains; and in some embodiments, also refers to crosslinking said polymer chains.

Herein, a “reduced-friction” coating, or a “coating having a reduced coefficient of friction”, or “coating having a reduced wet coefficient of friction” is a cured coating of the present disclosure that has a coefficient of friction, or wet coefficient of friction that, in some embodiments, is lower than the coefficient of friction, or wet coefficient of friction of a control coating.

Herein, a “coating having improved corrosion resistance” is a coating that exhibits a higher corrosion resistance, or a lower corrosion rate, than a control coating. Corrosion resistance is defined as the propensity of a material to slow or prevent corrosion. Corrosion resistance of a metal can be measured, for example, using the method described in B117.27681-Corrosion.

Herein, a “coating having improved foul-releasing properties” is a coating that eases detachment of fouling material from a substrate to which the coating is applied (compared to a control coating). Herein, a “coating having improved antifouling properties” is a coating that slows or prevents fouling of the substrate to which the coating is applied.

Used herein, “fouling materials” refers to materials that can comprise either living fouling organisms such as microorganisms, plants, algae, or animals (biofouling) or a non-living substance (inorganic and/or organic). “Fouling organisms” refers to an animal or plant species (for example, microorganisms, plants, algae, or small animals) that exist in wet environments and attach to surface(s) of material(s) immersed in said wet environment. It is estimated that there are more than 4000 species of fouling organisms, with two main categories of fouling organisms: (i) micro-fouling organisms, including microbial and bacterial organisms, which may quickly colonize an immersed object to form a bio-film, or slime; and (ii) macro-fouling organisms, including larger animals and plants that adhere either as individuals or in large colonies. Common slimes include: diatoms, bacteria, protozoa. Common organisms include: oysters, clams, tube worms, mussels, barnacles, hydroids, bryozoans, ectocarpus (brown algae), enteromorpha (green algae), rhodophycea (red algae).

Epoxy-Functional Monomers

As described above, one or more embodiments of the present disclosure provides compositions that can be used to form an epoxy-based coating (otherwise referred to as a pre-cured composition), wherein the compositions comprise epoxy-functional monomers. Said epoxy-functional monomers provide the base for forming the epoxy-based coating as they provide the main film-forming component of the herein described epoxy-based coatings, and comprise one or a combination of liquid monomers or pre-polymers that contain epoxide functional groups.

In one or more embodiments of the present disclosure, the epoxy-functional monomers comprise, consist essentially of, or consist of a reaction product of epichlorohydrin and one or more of hydroxyl-functional aromatics, alcohols, thiols, acids, acid anhydrides, cycloaliphatics and aliphatics, polyfunctional amines, and amine functional aromatics; a reaction product of the oxidation of unsaturated cycloaliphatics; bisphenol diglycidyl ethers; epoxy-functional epoxide-siloxane monomers; or a combination thereof.

In one or more embodiments of the present disclosure, the epoxy-functional monomers comprise, consist essentially of, or consist of a reaction product of epichlorohydrin with hydroxyl-functional aromatics, alcohols, thiols, acids, acid anhydrides, cycloaliphatics and aliphatics, polyfunctional amines, or amine functional aromatics, or comprise a reaction product of the oxidation of unsaturated cycloaliphatics. In one or more embodiments of the present disclosure, the epoxy-functional monomers comprise, consist essentially of, or consist of a reaction product of epichlorohydrin with hydroxyl-functional aromatics, alcohols, thiols, acids, acid anhydrides, cycloaliphatics, polyfunctional amines, or amine functional aromatics, or comprise a reaction product of the oxidation of unsaturated cycloaliphatics. In one or more embodiments of the present disclosure, the epoxy-functional monomers comprise, consist essentially of, or consist of a reaction product of epichlorohydrin with hydroxyl-functional aromatics, alcohols, acids, acid anhydrides, cycloaliphatics, or comprise a reaction product of the oxidation of unsaturated cycloaliphatics. In one or more embodiments of the present disclosure, the epoxy-functional monomers comprise, consist essentially of, or consist of a reaction product of epichlorohydrin with hydroxyl-functional aromatics, alcohols, cycloaliphatics; or comprise, consist essentially of, or consist of a reaction product of the oxidation of unsaturated cycloaliphatics. In one or more embodiments of the present disclosure the epoxy-functional monomers do not comprise, or are otherwise free of elastomeric monomers, pre-polymers, or resins. In one or more embodiments, the epoxy-functional monomers do not comprise, or are free of elastomeric monomers, pre-polymers, or resins that comprise, or consist essentially of butenes, polybutenes, butadienes, polybutadienes, nitrites acrylonitiriles, polysulfides, urethanes, urethane-modified resins (for example, urethane-modified epoxy resins), or combinations thereof. In one or more embodiments of the present disclosure, the epoxy-functional monomers do not comprise, or are free of epoxy-functional elastomeric monomers, pre-polymers, or resins. In one or more embodiments, the epoxy-functional monomers do not comprise, or are free of epoxy-functional elastomeric monomers, pre-polymers, or resins that comprise, or consist essentially of butenes, polybutenes, butadienes, polybutadienes, nitrites acrylonitiriles, polysulfides, urethanes, urethane-modified resins (for example, urethane-modified epoxy resins), or combinations thereof.

In one or more embodiments of the present disclosure, the epoxy-functional monomers comprise, consist essentially of, or consists of bisphenol diglycidyl ethers, epoxy-functional epoxide-siloxane monomers, or a combination thereof.

In some embodiments, the bisphenol diglycidyl ethers are derived from bisphenol A, bisphenol F, or a combination thereof. In some embodiments, the bisphenol diglycidyl ethers are derived from bisphenol S, bisphenol A, bisphenol F, or a combination thereof.

In one or more embodiments of the present disclosure, the epoxy-functional monomers are formed from epoxy-functional monomers and siloxane/silicone monomers, pre-polymers, or resins, or a system of said monomers, pre-polymers, or resins, that have been reacted and covalently bonded to form a monomer of intermediate molecular mass that is capable of further polymerization by reactive epoxy and/or siloxane groups to form a cured coating. In one or more embodiments, the epoxy-functional epoxide-siloxane monomers are not formed from a physical mixture of a pre-polymerized epoxy resin and silicone resin. In one or more embodiments, the epoxy-functional epoxide-siloxane monomers are not formed from a physical mixture of an pre-polymerized epoxy resin and silicone resin that includes coupling agents (for example, silane coupling agents), or other agents, to facilitate miscibility of the epoxy resin and silicone resins.

In some embodiments, the epoxy-functional epoxide-siloxane monomers comprise an epoxy-backbone with siloxane or polysiloxane side-chains. In some embodiments, the epoxy-functional epoxide-siloxane monomers comprise an epoxy-functional epoxide (for example, ether linkage) backbone comprising siloxane or polysiloxane side-chains. In some embodiments, the epoxy-functional epoxide-siloxane monomers comprises an epoxy-functional epoxide polyether backbone covalently modified with siloxane or polysiloxane side-chains. In some embodiments, the epoxy-functional epoxide-siloxane monomers comprise an epoxy-backbone with linear, branched, or crosslinked siloxane or polysiloxane side-chains. In some embodiments, each siloxane or polysiloxane side-chain has a linear structure, branched structure, or a cross-linked three-dimensional structure. In some embodiments, the siloxane side-chains are functionalized with epoxy groups, alkoxy groups, hydroxyl groups, or hydroxyalkyl groups. In some embodiments, the epoxy-functional epoxide-siloxane monomers comprise an epoxy-functional epoxide backbone comprising siloxane or polysiloxane side-chains functionalized with alkoxy groups, wherein at least one side-chain comprises a cross-linked three-dimensional structure. In some embodiments, the at least one side-chain comprising a cross-linked three-dimensional structure is a cross-linked silicone resin. In one or more embodiments, the siloxane or polysiloxane side-chains may account for about 20% to about 50% of the monomer's molecular weight. In some embodiments, the epoxy-functional epoxide-siloxane monomer is a product of a polymer analogous reaction comprising isocyanate oligomers, silane oligomers, and epoxy oligomers. In some embodiments, the epoxy-functional epoxide-siloxane monomer is a product of a polymer analogous reaction comprising polyurethane oligomers, silane oligomers, and epoxy oligomers. In some embodiments, the epoxy-functional epoxide-siloxane monomers comprise one or a combination of 3-ethylcyclohexylepoxy copolymer modified with dimethylsiloxane side-chains, epoxy bisphenol A (2,2-Bis(4′-glycidyloxyphenyl)propane) modified with the poly-dimethylsiloxane side-chains, a siloxane modified hybrid epoxy resin, a siliconeepoxide resin, or an epoxy-functional epoxide-backbone functionalized with a crosslinked silicone resin comprising terminal alkoxy groups. In some embodiments, the epoxy-functional epoxide-siloxane pre-polymer comprises, consists essentially of, or consists of Silikopon® ED (a siliconeepoxide resin, otherwise referred to as a silicone epoxy resin, having an epoxy-functional epoxide-backbone functionalized with a crosslinked silicone resin with terminal alkoxy groups), Silikopon® EF (a siliconeepoxide resin, otherwise referred to as a silicone epoxy resin, having an epoxy-functional epoxy-backbone functionalized with a crosslinked silicone resin having terminal alkoxy groups, where the Silikopon® EF may have fewer terminal alkoxy groups than Silikopon® ED), EPOSIL Resin 5550® (a siloxane modified hybrid epoxy resin), or a combination thereof.

The type and amount of epoxy-functional monomer that is selected for use in the pre-cured composition is, in part, dependent on the performance requirements of the epoxy-based coating, and/or the type of surface or substrate the coating is to be formed on.

Generally, epoxy-functional monomers derived from bisphenol A and bisphenol F are considered as equivalents that provide coatings with similar properties. Further, epoxy-functional monomers derived from bisphenol A and bisphenol F may be used in a blend (a mix of bisphenol A and F) or as a hybrid (one molecule comprising components of both bisphenol A and F). In some embodiments, epoxy-functional monomers derived from bisphenol A may be selected to reduce costs, as it is often less expensive than bisphenol F. In other embodiments, epoxy-functional monomers derived from bisphenol F may be selected to impart more corrosion resistance to the cured epoxy-based coating, as coating formed from bisphenol F are generally known to be more corrosion resistant than those formed from bisphenol A. Further, epoxy-functional monomers derived from bisphenol F may be selected if it is desired that the cured epoxy-based coating is food-safe. Epoxy-functional monomers derived from bisphenol F may be selected if it is desirable to reduce diluent usage, as bisphenol F is generally less viscous than bisphenol A. Epoxy-functional monomers derived from bisphenol F may be selected if it is desirable for the cured epoxy-based coating to have reduced biotoxicity.

One or more of the epoxy-functional epoxide-siloxane monomers may be selected to impart increased durability to the cured epoxy-based coating, relative to silicone-oil containing coatings (for example, soft-foul release coatings). The epoxy-functional epoxide-siloxane monomers may be selected to impart increased thermal resistance to the cured epoxy-based coating; or they may be selected to contribute to the overall anti-fouling/foul-releasing properties of the cured coating.

In some embodiments, the epoxy-functional monomers make up about 35 wt % to about 90 wt % of the pre-cured composition; or any range of wt % between about 35 wt % and about 90 wt %. In other embodiments, the epoxy-functional monomers make up about 45 wt % to about 80 wt % of the pre-cured composition. In other embodiments, the epoxy-functional monomers make up about 35 wt % to about 70 wt % of the pre-cured composition. In other embodiments, the epoxy-functional monomers make up about 40 wt % to about 65 wt % of the pre-cured composition. In other embodiments, the epoxy-functional monomers make up about 55 wt % of the pre-cured composition.

Diluents

As described above, one or more embodiments of the present disclosure provides pre-cured compositions that comprise epoxy-functional monomers and a diluent. The diluent is included to reduce the viscosity of the epoxy-functional monomers, which can have viscosities in a range of about 250 cps to >20 000 cps; 1000 cps to >20 000 cps; or about 3000 cps to >20 000 cps (for example, around 8000 cps). Different diluents can have different coefficients of dilution. For example, a diluent may have a linear coefficient of dilution wherein, for example, mixing 50% of a diluent having a viscosity that is 1 cps and 50% of a component having a viscosity of 100 cps, the final viscosity of the mixture is 50.5 cps. Alternatively, a diluent may have an exponential coefficient of dilution.

In some embodiments, the diluent has a lower viscosity than the epoxy-functional monomers; for example, a viscosity less than 1000 cps, such as between about 1 cps to about 800 cps. In some embodiments, the diluent has a viscosity that, once added to the pre-cured composition, provides a final viscosity of the pre-cured composition that is in a range of about 700 to about 1600 cps, or about 800 to about 1600 cps, so that the pre-cured composition can be applied to a substrate via brushing or spray coating. In some embodiments, enough diluent is added to provide the pre-cured composition with a final viscosity of about 1400 cps.

The amount of diluent that is selected for use in the pre-cured composition is, in part, dependent on the processibility requirements of the pre-cured composition, and/or the type of surface or substrate the coating is to be formed on. In some embodiments, the diluent makes up about 1 wt % to about 35 wt % of the pre-cured composition; or any range of wt % between 1 wt % and 35 wt %. In other embodiments, the diluent make up about 15 wt % to about 30 wt % of the pre-cured composition. In other embodiments, the diluent make up about 20 wt % to about 30 wt % of the pre-cured composition.

In some embodiments, the diluent is also included to reduce or prevent air bubbles from being trapped within the cured epoxy-based coating, thereby reducing the porosity of the cured coating. Reducing the viscosity of the pre-cured composition can facilitate the release of air bubbles from the pre-cured composition prior to curing, which in turn can reduce the number of defects (for example, pores) that form in the cured coating as it is curing. Such defects can otherwise render a surface of a substrate (upon which the cured coating is formed) vulnerable to, for example, corrosion.

In some embodiments, the diluent comprises, or consists essentially of, or consists of a reactive diluent that is reactive in an epoxide polymerization, a non-reactive diluent, or a combination thereof. The type of diluent, or combination of diluent that is selected for use in the pre-cured composition is, in part, dependent on the performance requirements of the cured epoxy-based coating, and/or the type of surface or substrate the coating is to be formed on. In some embodiments, a reactive diluent may be selected if preserving or increasing the mechanical strength (for example, hardness and/or toughness) of the cured coating is desired, for example, because the diluent becomes incorporated into the epoxide polymerization. In other embodiments, a reactive diluent may be selected if it is desirable to use a diluent that won't evaporate, because the diluent is not a volatile organic compound (VOC). In some embodiments, a reactive diluent may be selected if preserving or increasing the hydrophobicity of the cured coating is desired. In some embodiments, a non-reactive diluent may be selected to reduce costs, as they are generally less expensive than reactive diluents. In other embodiments, a non-reactive diluent may be selected to reduce or prevent air bubbles from being trapped within the cured coating, thereby reducing the porosity of the cured coating. In yet other embodiments, a non-reactive diluent may be selected to slow down curing the pre-cured composition to increase handling time, so that an end user has more time to apply the pre-cured composition to a substrate. In further embodiments, a combination of reactive and non-reactive diluent may be selected for pre-cured compositions comprising lower amounts of VOC components, wherein a lower amount of a non-reactive diluent and a higher amount of a reactive diluent is used. In some embodiments, such combinations of reactive and non-reactive diluents may be selected to reduce the environmental impact of the cured epoxy-based coating and/or to decrease off-gassing explosion risk.

Reactive diluents of the present disclosure are diluents that are reactive in an epoxide polymerization, such that they become incorporated into the polymerization of at least the epoxy-functional monomers as the pre-cured compositions are cured to form cured epoxy-based coatings. In some embodiments, the reactive diluents are reactive in an epoxide polymerization because they comprise functional groups that can at least react with the epoxy-functional monomers, such as an epoxide functional group (which may otherwise be referred to as a glycidyl ether group), an acrylate functional group, an maleimide functional group, a hydroxyalkyl functional group, or a hydroxide functional group, otherwise referred to as a hydroxyl functional group.

In some embodiments, the reactive diluents have a lower polarity as indicated by a lower critical surface tension of wetting. In some embodiments, the polarity of the reactive diluents is indicative of its hydrophobicity, wherein a lower polarity indicates a higher hydrophobicity. In some embodiments, reactive diluents have a lower polarity/higher hydrophobicity because they comprise alkyl-based or aryl-based functional groups. For example, in some embodiments, the reactive diluent comprises alkyl (C12-C14) glycidyl ether, which has a relatively low polarity and relatively high hydrophobicity due to its long alkyl (C12-C14) chain. Further, in some embodiments, use of alkyl (C12-C14) glycidyl ether as a diluent can provide a cured coating having better surface wetting, and better substrate adhesion. As is described below in more detail (i.e., see Hydrophobicity-modifying additive), incorporating reactive diluents having a lower polarity (and, in turn, having a higher hydrophobicity) into the pre-cured compositions can improve the anti-fouling/foul-releasing properties of the cured epoxy-based coatings. Particularly, including lower polarity reactive diluents into the pre-cured compositions can decrease the surface energy of the resultant coatings, which can improve the antifouling/foul-releasing properties of the coatings. As such, in some embodiments, one or more of the hydrophobicity-modifying additives may act as a reactive diluent.

In some embodiments, the reactive diluents include poly[(phenyl glycidyl ether)-co-formaldehyde], alkyl (C12-C14) glycidyl ether, phenyl glycidyl ether, butyl glycidyl ether, 2-ethylhexyl glycidyl ether, o-cresol glycidyl ether, cycloaliphatic glycidyl ether, dipropylene glycol n-propyl ether, dipropylene glycol dimethyl ether, or a combination thereof. In some embodiments, the reactive diluents includes poly[(phenyl glycidyl ether)-co-formaldehyde],alkyl (C12-C14) glycidyl ether, or a combination thereof.

In contrast to reactive diluents, non-reactive diluents of the present disclosure are not reactive in an epoxide polymerization, such that the diluents do not comprise reactive functional groups. In some embodiments, the non-reactive diluent catalyze the polymerization of the pre-cured compositions as they are being cured to form cured epoxy-based coatings (for example, via reactive functional groups, such as hydroxyl functional groups (OH), etc.). In other embodiments, the non-reactive diluents can become entrapped during said polymerization. For example, the non-reactive diluents may be retained in the microstructure of the cured epoxy-based coatings. In some embodiments, this may be less desirable; depending on the volume of diluent retained, retention of the diluent may be detrimental to the coating (for example, by acting as a soft phase within the coating and reducing its hardness) and wear resistance. In some embodiments, upwards of 30 wt % of the non-reactive diluents may be retained before having a detrimental impact on the coating; however, generally, for every 5 wt % of diluent added, it can be expected that the hardness of cured coating will decrease by 3 D-shore hardness points. In other embodiments, the non-reactive diluents evaporate from the cured epoxy-based coating following its formation, otherwise known as off-gassing.

In some embodiments, the non-reactive diluents include nonyl phenol, cyclohexanedimethanol, n-butyl alcohol, benzyl alcohol, isopropyl alcohol, propylene glycol, phenol, methyl acetate, xylene, methyl ethyl ketone or a combination thereof. In other embodiments, the non-reactive diluents are non-VOCs (non-volatile organic compounds), such as benzyl alcohol, which may reduce off-gassing from the cured epoxy-based coating. In some embodiments, use of a non-VOC diluent reduces the environmental impact of the pre-cured composition and/or the cured epoxy-based coating. In further embodiments, the non-reactive diluent is benzyl alcohol. In further embodiments, the non-reactive diluent is methyl acetate, xylene, methyl ethyl ketone, or a combination thereof. In one or more embodiments, the non-reactive diluents methyl acetate, methyl ethyl ketone, xylene, or combinations thereof may be selected to facilitate compatibility (for example, co-solubility, miscibility) of the epoxy-functional epoxide-siloxane monomers with other components (for example, hydrophobicity-modifying additives, wear-inhibiting additives, amphiphilicity-modifying additives) of the pre-cured composition of the present disclosure. In one or more embodiments, the non-reactive diluents methyl acetate, methyl ethyl ketone, xylene, or combinations thereof may be selected to impart good drying properties when applying the curing composition by spraying. In one or more embodiments, the non-reactive diluents methyl acetate, methyl ethyl ketone, xylene, or combinations thereof may be selected to avoid or reduce formation of craters, pinholes, blushing, orange peel, and/or other visual defects characteristic of a poorly compatible composition. In one or more embodiments, methyl acetate may be selected as a eco-friendly solvent in the pre-cured composition (for example, because it is exempt from the list of volatile organic compounds (VOCs), as listed by the United States Environmental Protection Agency).

Hydrophobicity-Modifying Additives

As described above, one or more embodiments of the present disclosure provides a pre-cured composition that comprises epoxy-functional monomers, a diluent, and a hydrophobicity-modifying additive. A hydrophobicity-modifying additive is included in the pre-cured compositions to increase the hydrophobicity of the resultant, cured epoxy-based coatings, and therefore improve the coatings' antifouling/foul-releasing properties (relative to control epoxy-based coatings).

Generally, for fouling to occur, a surface has favorable characteristics for organisms to adhere, as the organisms compete with water for binding to the surface. For some organisms (for example, micro-foulers), there is a zone of minimal bio-adhesion at a surface tension of approximately 22-24 mN/m. A least favorable surface energy for bio-adhesion is around 23 mN m⁻¹, with a range from about 20 to about 25 mN m⁻¹, or from about 20 to 30 mN m⁻¹, where bio-adhesion is minimal due to formation of weak boundary layers between the surface and adhesive proteins of fouling organisms. For example, surfaces comprising methylsilicones generally have a surface energy in this range. Another factor for whether fouling will occur is surface roughness; a smoother surface (for example, defect-free surface) offers less space and surface area for adhesion of fouling organisms to occur.

Generally, surfaces with energies near the range of about 20 to about 25 mNm⁻¹ can reduce the ability of fouling organisms to adhere to the surface because the thermodynamic cost for water to rewet the surface at this value of surface energy is minimized, while the movement of the surface results in removal of weakly bonded foulers by shear stress acting on the coating. By increasing the hydrophobicity of the cured epoxy-based coating, the hydrophobicity-modifying additive contributes to reducing the coating's surface energy (for example, to a range of about 20 to about 25 mN m⁻¹), which can reduce the ability of fouling organisms to adhere to the cured coating, thereby imparting improved antifouling/foul-releasing properties. Hydrophobicity-modifying additives of the present disclosure increase the hydrophobicity of the cured epoxy-based coatings due to the additives' own hydrophobic properties. In some embodiments, the hydrophobicity properties of the hydrophobicity-modifying additives are, in part, due to the additives comprising alkyl-based or aryl-based functional groups. For example, the hydrophobicity-modifying additives may comprise alkyl-based or aryl-based functional groups comprising a carbon chain length of 1-15, or a carbon ring size of 1-10. In some embodiments, the hydrophobicity properties of the hydrophobicity-modifying additives are, in part, due to the additives having a higher molecular weight (for example, a polymeric additive vs. a small-molecule additive). Without wishing to be bound by theory, the hydrophobicity-modifying additive may increase the hydrophobicity of the cured epoxy-based coatings due, at least in part, to a moiety of the additive (for example, a moiety that is not reactive in an epoxide polymerization) migrating to the surface of the coating as it cures.

Hydrophobic properties of the hydrophobicity-modifying additives can be measured and/or indicated by the additive's critical surface tension of wetting. In some embodiments, the critical surface tension for a suitable hydrophobicity-modifying additive is between about 15 to about 60 mN/m, or between about 15 to about 55 nM/m, or between about 15 to about 40 mN/m, or between about 20 to about 30 mN/m when the hydrophobicity-modifying additive is present in the pre-cured composition at a range of up to about 10 wt % or up to about 20 wt %. Hydrophobic properties of the cured epoxy-based coatings, which is indicative of the coatings' surface energies and antifouling/foul-releasing properties, can in turn be measured by contact angle. In some embodiments, the hydrophobicity-modifying additives are included in the pre-cured compositions in an amount sufficient for the cured epoxy-based coatings to have a contact angle of at least 90° when measured with an Ossila Goniometer following ASTM D7334-08(2013). Contact angle is a measure of surface wettability, and is generally measured where a liquid-vapor interface meets a solid surface. The larger the angle, the lower the wettability (for example, higher hydrophobicity) of the surface. A cured epoxy-based coating having a contact angle of at least 90° is sufficiently hydrophobic to have a surface energy that reduces the ability of fouling organisms to adhere to the coating. In some embodiments, the hydrophobicity-modifying additive is included in an amount sufficient for the cured epoxy-based coatings to have a contact angle of about 90° to about 130°, or about 90° to about 120°, about 95° to about 120°, about 100° to about 120°, or about 100° to about 115°, or about 110°, or about 120°; or at any range between about 90° and about 130°.

Further, the hydrophobicity-modifying additives are reactive in an epoxide polymerization, such that they become incorporated into the polymerization of at least the epoxy-functional monomers as the pre-cured compositions are being cured. In some embodiments, the hydrophobicity-modifying additives are reactive in an epoxide polymerization because they comprise functional groups that can react with at least the epoxy-functional monomers, such as an epoxy functional group, acrylate functional group, or a maleimide functional group. In other embodiments, the hydrophobicity-modifying additives become entrapped during said polymerization. In some embodiments, the hydrophobicity-modifying additive comprises at least one Si-based additive, at least one fluoro-based additive, at least one maleimide-based additive, or a combination thereof. In some embodiments, the hydrophobicity-modifying additive comprises a fluoro-based oligomer, a bis-maleimide oligomer, an epoxy-functional silane, an epoxy-functional polydialkylsiloxane, or a combination thereof.

In some embodiments wherein the hydrophobicity-modifying additive comprises at least one Si-based additive; or wherein the hydrophobicity-modifying additive comprises an epoxy-functional silane, an epoxy-functional polydialkylsiloxane, or a combination thereof; the hydrophobicity-modifying additive may further function as a reactive diluent (i.e., see Diluents above) due, at least in part, to their relatively low viscosities (for example, a viscosity less than 1000 cps, such as between about 1 cps to about 800 cps).

In some embodiments wherein the hydrophobicity-modifying additive comprises at least one Si-based additive, at least one fluoro-based additive, or a combination thereof; or wherein the hydrophobicity-modifying additive comprises an epoxy-functional silane, an epoxy-functional polydialkylsiloxane, or a combination thereof; the critical surface tension for the hydrophobicity-modifying additive is between about 15 to about 60 mN/m, or between about 15 to about 55 nM/m, or between about 15 to about 40 mN/m, or between about 20 to about 30 mN/m when the hydrophobicity-modifying additive is present in the pre-cured compositions up to about 10 wt %. In other embodiments, wherein the hydrophobicity-modifying additive comprises at least one maleimide-based additive; or wherein the hydrophobicity-modifying additive comprises a bis-maleimide oligomer; the critical surface tension for the hydrophobicity-modifying additive is between about 15 to about 60 mN/m, or between about 15 to about 55 nM/m, or between about 15 to about 40 mN/m, or between about 20 to about 30 mN/m when the hydrophobicity-modifying additive is present in the pre-cured compositions up to about 20 wt %.

In some embodiments, the hydrophobicity-modifying additives are not reactive in an epoxide polymerization, but become embedded as the pre-cured compositions are being cured into a cured epoxy-based coating. In such embodiments, the hydrophobicity-modifying additives may comprise polydimethylsiloxane (PDMS)-silica or fumed-silica, which may be applied (for example, sprayed, brushed, etc.) on to the surface of the coating as it is curing into a cured epoxy-based coating to increase the cured coating's hydrophobic properties.

The type and amount of hydrophobicity-modifying additive that is selected for use in the pre-cured compositions are, in part, dependent on the performance requirements of the cured epoxy-based coating, and/or the type of surface or substrate the coating is to be formed on.

In some embodiments, a Si-based or fluoro-based additive are selected for their hydrophobic properties, and are maintained at low concentrations in the pre-cured composition to avoid impacting the mechanical strength of the cured coating. In some embodiments, a Si-based additive is selected to reduce the potential environmental and health impact of the cured coating relative to those comprising fluoro-based additives, as such additives have been known release micro-plastics into the environment, or to be cancer-causing. In other embodiments, a maleimide-based additive is selected to facilitate the formation of a hard cured coating that is smooth/glossy (for example, surface roughness <0.3 μM), and is largely free of defects. In yet other embodiments, a maleimide-based additive is selected to impart the cured epoxy-based coating with a high temperature resistance (for example, up to 250° C.).

In some embodiments, the hydrophobicity-modifying additive comprises, or consists essentially of an epoxy-functional polydialkylsiloxane. In some embodiments, the epoxy-functional polydialkylsiloxane comprises, or consists essentially of, or consists of epoxy-functional polydimethylsiloxane. Epoxy-functional polydimethylsiloxane, and similar epoxy-functional polydialkylsiloxanes, may be selected when a large reduction in coating surface energy (i.e., large increase in coating hydrophobicity) is required for the cured epoxy-based coating to have increased antifouling/foul-releasing properties (relative to a control cured coating). In some embodiments, to affect the antifouling/foul-releasing properties of the cured coating, the epoxy-functional polydimethylsiloxane is present in the pre-cured compositions in a range of about 0.05 wt % to about 10 wt %, or in a range of about 0.5 wt % to about 8 wt %; or at any range of wt % between about 0.05 wt % and about 10 wt %.

In some embodiments, the hydrophobicity-modifying additive comprises, or consists essentially of an epoxy-functional silane. In some embodiments, the epoxy-functional silane comprises, or consists essentially of, or consists of glycidoxypropyltrimethoxysilane. Glycidoxypropyltrimethoxysilane, and similar epoxy-functional silanes, may be selected to increase adhesion of the cured coatings to a substrate, in addition to increasing coating hydrophobicity. For example, glycidoxypropyltrimethoxysilane may promote adhesion via its trimethoxysilane moiety. Such trimethoxy functional groups are susceptible to hydrolysis, thus forming reactive silanol functional groups that can react with other reactive functional groups, for example, hydroxyl (OH) groups, on the surface of a substrate, thereby promoting adhesion. In some embodiments, to affect the antifouling/foul-releasing properties of the cured coating, and/or to affect increased substrate adhesion, the glycidoxypropyltrimethoxysilane is present in a pre-cured composition in a range of about 0 wt % to about 6 wt %, or in a range of about 1 wt % to about 2 wt %, or at any range of wt % between about 0 wt % and about 6 wt %.

In some embodiments, the hydrophobicity-modifying additive comprises, or consists essentially of a bis-maleimide oligomer. In some embodiments, the hydrophobicity-modifying additive comprises, or consists essentially of, or consists of bis-maleimide oligomer BMI 689, BMI 737, BMI 1100, BMI 1400, BMI 1500, BMI 1700, or a combination thereof.

In some embodiments, the bis-maleimide oligomer BMI-689 has the representative structure of

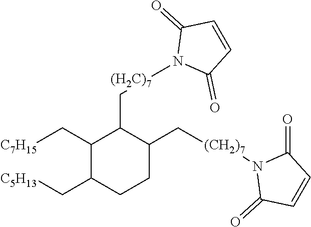

In some embodiments, the bis-maleimide oligomer BMI-1500 has the representative structure of

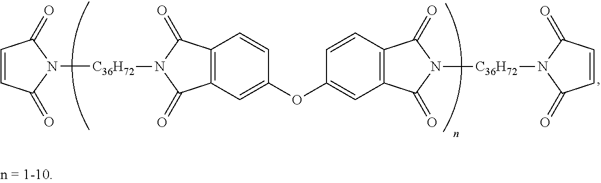

In some embodiments, the bis-maleimide oligomers BMI-1400 or BMI-1700 has the representative structure of:

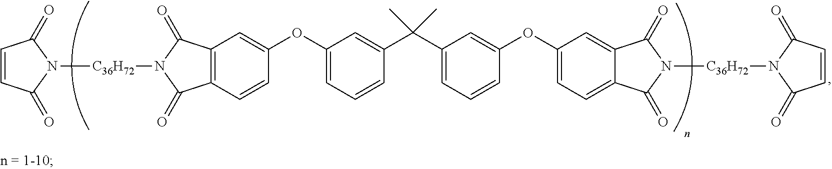

Wherein BMI-1400 is a lower viscosity version of BMI-1700.

In some embodiments, the BMI 1400 or BMI 1700 is present in the pre-cured compositions in a range of about 10 wt % to about 25 wt %; or of about 10 wt % to about 20 Wt %, or at any range of wt % between about 10 wt % and about 25 wt %.

In some embodiments, the hydrophobicity-modifying additive comprises, or consists essentially of, or consists of a fluoro-based oligomer. In some embodiments, the hydrophobicity-modifying additive comprises, consists essentially of, or consists of a fluoroalkylated acrylate oligomer. In some embodiments, the fluoroalkylated acrylate oligomer is Sartomer® CN4002 (fluorinated acrylate oligomer). The fluoroalkylated acrylate oligomer may be included in the pre-cured compositions to increase the contact angle of the cured epoxy-based coatings by about 2 to about 5 degrees on average, when measured with an Ossila Goniometer following ASTM D7334-08(2013). In some embodiments, the fluoroalkylated acrylate oligomer is present in the pre-cured compositions in a range of about 0.05 wt % to about 5 wt %, or about 0.05 wt % to about 3 wt %, or at any range of wt % between about 0.05 wt % and about 5 wt %.

In some embodiments, the hydrophobicity-modifying additive comprises fluoro-based additive poly(3,3,3-trifluoropropylmethylsiloxane). In some embodiments, the poly(3,3,3-trifluoropropylmethylsiloxane) is selected if it is preferred that the hydrophobicity-modifying additive becomes entrapped, and not polymerized during the epoxide polymerization. In some embodiments, the poly(3,3,3-trifluoropropylmethylsiloxane) is selected for use with the epoxy-functional epoxide-siloxane monomers, as the poly(3,3,3-trifluoropropylmethylsiloxane) may react with the siloxane/polysiloxane side-chains in the presence of an aminosilane hardener such that the poly(3,3,3-trifluoropropylmethylsiloxane) becomes incorporated into the polymerization of at least the epoxy-functional epoxide-siloxane monomers as the pre-cured compositions are being cured. In some embodiments, the poly(3,3,3-trifluoropropylmethylsiloxane) is present in the pre-cured compositions in a range of about 1 wt % to about 5 wt %. In some embodiments, the hydrophobicity-modifying additive may be DNST—Dynasylan® AMEO-T (an aminosilane composition containing more than 90 wt % (3-aminopropyl)triethoxysilane), which may also be selected to increase adhesion of the cured coatings to a substrate. In some embodiments, Dynasylan® AMEO-T is selected for use with the epoxy-functional epoxide-siloxane monomers as a hardener.

Wear-Inhibiting Additives

As described above, one or more embodiments of the present disclosure provides pre-cured compositions further comprising a wear-inhibiting additive. A wear-inhibiting additive is included in the pre-cured composition to provide cured epoxy-based coatings having improved corrosion resistance, increased mechanical strength, or a bending strength of at least 10 mm (relative to a control coating). In some embodiments, the wear-inhibiting additive is included in the composition to provide an epoxy-based coating that exhibits reduced coefficient of friction (relative to a control coating).

Wear-inhibiting additives of the present disclosure are included in the pre-cured composition in an amount sufficient to provide cured epoxy-based coatings having improved corrosion resistance of at least 1000 hours when measured by salt fog resistance, an increased mechanical strength with a D-shore hardness of at least 30D or at least 40D, or a bending strength of at least 10 mm when measured by a cylindrical bed test. In some embodiments, the wear-inhibiting additives are included in an amount sufficient to provide cured epoxy-based coatings having improved corrosion resistance of about 1500 hours to about 8500 hours, or about 4000 hours to about 7000 hours when measured by salt fog resistance; or an increased mechanical strength with a D-shore hardness of about 65D to about 90D, or about 65D to about 85D; or about 70D to about 80D, or at any D-shore hardness between about 30D and about 90D. In some embodiments the wear-inhibiting additive is included in an amount sufficient to provide a coating having a coefficient of friction of <0.3 (for example, a coefficient of friction of about 0.1, indicating <10% force lost to friction).

In some embodiments, the wear-inhibiting additives comprise, or consist essentially of, or consist of unmodified graphene nanoplatelets, unmodified graphite flakes, carbon black, fullerene, titanium dioxide, aluminum oxide, Ca magnesium silicate, zinc oxide, or a combination thereof. In some embodiments, the wear-inhibiting additives comprise, or consist essentially of, or consist of unmodified graphene nanoplatelets, unmodified graphite flakes, titanium dioxide, aluminum oxide, Ca magnesium silicate, or a combination thereof.

In one or more embodiments, the wear-inhibiting additives comprise, or consist essentially of, or consist of unmodified graphene nanoplatelets, unmodified graphite flakes, or a combination thereof. In some embodiments, unmodified graphene nanoplatelets or unmodified graphite are graphene nanoplatelets or graphite flakes that have not been chemically-modified prior to being incorporated into the pre-cured composition. In some embodiments, the graphene nanoplatelets or graphite flakes have not been chemically-modified with a coupling agent, such as a silane, amino, or metal complex coupling agent, that would otherwise couple with and functionalize the surface of the graphene nanoplatelets or graphite flakes. In some embodiments, the graphene nanoplatelets or graphite flakes have not been chemically-modified with oxidizing agents that would otherwise oxidize the surface of the graphene nanoplatelets or graphite flakes and form graphene oxide or graphite oxide. In one or more embodiments the wear-inhibiting additives do not comprise, or do not consist essentially of, or are free of modified graphene nanoplatelets, modified graphite, or a combination thereof. In one or more embodiments the wear-inhibiting additives do not comprise, or do not consist essentially of, or are free of graphene oxide, graphite oxide, or a combination thereof. Graphene oxide or graphite oxide can be difficult to disperse in the epoxy-functional monomers and/or the pre-cured compositions of the present disclosure. In one or more embodiments, the unmodified graphene nanoplatelets, unmodified graphite, or a combination thereof are dispersed in the pre-cured composition of the present disclosure without needing prior chemical modification to facilitate dispersion.

The type and amount of wear-inhibiting additive that is selected for use in the pre-cured composition is, in part, dependent on the performance requirements of the resultant, cured epoxy-based coating, and/or the type of surface or substrate the coating is to be formed on.

In some embodiments, one or a combination of unmodified graphene nanoplatelets, unmodified graphite flakes, carbon black, fullerene, titanium dioxide, aluminum oxide, Ca magnesium silicate, and zinc oxide may be selected to increase corrosion resistance, as said additives can act as high-barrier fillers. High-barrier fillers can increase the diffusion path of water, oxygen, and/or corrosive ions in a coating, making it difficult for them to reach the surface of a substrate and cause corrosion, thereby increasing the corrosion resistance of the resultant cured coating (relative to a control cured coating). In some embodiments, to affect an increase in corrosion resistance, such wear-inhibiting additives are included in the pre-cured compositions in a range of about 0.05 wt % to about 60 wt %, or any range of wt % between about 0.05% and about 60 wt %, depending on characteristics such as size, geometry, surface area.

In some embodiments, the wear-inhibiting additive comprises, consists essentially of, or consists of unmodified graphene nanoplatelets, unmodified graphite flakes, or a combination thereof. Graphene nanoplatelets (GNPs) are a sub-form of graphene: instead of being one-atom thick, GNPs are thicker and can comprise up to 60 layers of graphene (and be up to about 30 nm thick). Graphene nanoplatelets may be included because they can exhibit a strength about 300 times greater than steel, a hardness that is harder than diamond, and an excellent conduction of heat and electricity, all while being very flexible. Further, graphene nanoplatelets can provide solid lubrication and reduce a coating's coefficient of friction; and/or, can increase a coating's foul-releasing efficacy. In some embodiments, selecting graphene nanoplatelets as a wear-inhibiting additive can impart improved mechanical strength and/or bending strength to the resultant, cured epoxy-based coatings (relative to a control coating). Further, graphene nanoplatelets can be manufactured with different flake sizes (for example, from 1 to 100 μm); such as large, thin flakes that have a high surface area. When incorporated into a coating, such large, think flakes can act as a physical and/or chemical barrier against corrosion. Due to the high surface area, lower concentrations of graphene nanoplatelets are required to provide a barrier against corrosion. In some embodiments, selecting graphene nanoplatelets as wear-inhibiting additives can impart improved corrosion resistance to the resultant, cured epoxy-based coating (relative to a control coating).

In some embodiments, to affect an increased corrosion resistance, improved mechanical strength, and/or improved bending strength in the cured epoxy-based coating, the unmodified graphene nanoplatelets included in the pre-cured composition have a flake size of at least 3 μm; or about 3 μm to about 100 μm; or about 3 μm to about 50 μm; or about 5 μm to about 10 μm; or at any flake size between about 3 μm and about 100 μm. In some embodiments, to affect an increased corrosion resistance, improved mechanical strength, and/or improved bending strength in the cured epoxy-based coating, the unmodified graphene nanoplatelets are present in the pre-cured composition in a range of about 0.05 wt % to about 10 wt %; or about 0.1 wt % to about 10 wt %; or about 0.1 wt % to about 5 wt %; or about 0.1 wt % to about 2.5 wt %; or about 0.1 wt % to about 1 wt %; or about 0.3 wt %; or at any range of wt % between about 0.05 wt % and about 10 wt %. In some embodiments, to affect a reduced coefficient of friction in the cured epoxy-based coating, the unmodified graphite flakes included in the pre-cured composition have a flake size of at least 3 μm; or about 3 μm to about 100 μm; or about 3 μm to about 50 μm; or about 10 μm to about 20 μm; or at any flake size between about 3 μm and about 100 μm. In some embodiments, to affect reduced coefficient of friction in the cured epoxy-based coating, the unmodified graphite flakes are present in the pre-cred composition in a range of about 0.1 wt % to about 25 wt %; about 1 wt % to about 15 wt %; or about 1 wt % to about 10 wt %; or about 1 wt % to about 5 wt %; or about 5 wt %; or at any range of wt % between about 0.1 wt % and about 25 wt %.

In some embodiments, the wear-inhibiting additives comprise, or consist essentially of, or consists of titanium dioxide, aluminum oxide, Ca magnesium silicate (for example, a talc), or a combination thereof. In some embodiments, selecting titanium dioxide, aluminum oxide, Ca magnesium silicate (for example, a talc), or a combination thereof as a wear-inhibiting additive can impart increased corrosion resistance by acting as high-barrier fillers (relative to a control coating). In some embodiments, selecting titanium dioxide, aluminum oxide, Ca magnesium silicate (for example, a talc), or a combination thereof as a wear-inhibiting additive can impart improved mechanical strength and/or bending strength to the resultant, cured epoxy-based coatings (relative to a control coating). In one or more embodiments, to affect an increased corrosion resistance, improved mechanical strength, and/or improved bending strength in the cured epoxy-based coating, the titanium dioxide, aluminum oxide, Ca magnesium silicate (for example, a talc), or a combination thereof are present in the pre-cured composition in a range of about 5 wt % to about 30 wt %; or about 5 wt % to about 25 wt %; or about 5 wt % to about 10 wt %; or about 10 wt % to about 25 wt %; or about 10 wt % to about 20 wt %; or about 10 wt % to about 17 wt %; or about 7 to 8 wt %; or about 10 wt %; or about 17 wt %; or about 25 wt %; or at any range of wt % between about 5 wt % and about 30 wt %.

Amphiphilicity-Modifying Additives

As described above, one or more embodiments of the present disclosure provides pre-cured compositions further comprising an amphiphilicity-modifying additive. An amphiphilicity-modifying additive is included in the pre-cured composition to provide cured epoxy-based coatings having reduced wet coefficient of frictions and/or improved antifouling/foul-releasing properties (relative to a control coating).

The amphiphilicity-modifying additives impart at least partial amphiphilicity to the surface of the epoxy-based coatings into which they are incorporated (relative to a control coating), due to the additive's own amphiphilic or hydrophilic properties. Amphiphilic refers to having both hydrophilic and hydrophobic properties. In some embodiments, the amphiphilicity-modifying additive is amphiphilic, comprising both hydrophobic portions and hydrophilic portions. In other embodiments, amphiphilicity-modifying additive is hydrophilic. The amphiphilic or hydrophilic properties of the amphiphilicity-modifying additives result, at least in part, from the additives comprising hydrophilic functional groups. In some embodiments, the functional groups are hydrophilic, at least in part, due to the functional group's hydrogen-bonding capacity (i.e., accepting and/or donating). In some embodiments, the functional groups are hydrophilic, at least in part, due to the functional group being charged and capable of forming/attracting hydration spheres.

Without wishing to be bound by theory, the amphiphilicity-modifying additives may impart at least partial amphiphilicity to the surface of the epoxy-based coatings due to a phase separation (for example, partial phase separation), or migration of the hydrophilic portions and/or hydrophilic functional groups of the additive to the coating surface, thereby creating areas or regions of relative hydrophilicity throughout the areas or regions of relative hydrophobicity imparted by the epoxy-functional monomers, diluent, hydrophobicity-modifying additive, and/or other components of the pre-cured compositions. These area or regions of hydrophilicity can draw water/aqueous solutions to them when the coating is in a wet environment, contributing, at least in part, to the formation of a partially hydrated, lubricious layer on top of the coating surface when immersed in a wet environment. In some embodiments, this hydration layer on the coating surface increases the slip of the coating (for example, renders the surface slippery), thereby reducing the wet coefficient of friction. In some embodiments, this hydration layer on the coating surface reduces the likelihood that fouling organisms will be able to adhere to, and/or remain attached on the surface of the cured epoxy-based coatings, improving the antifouling/foul-releasing properties of the coating. In some embodiments, the amphiphilicity-modifying additives allow the cured coatings into which they are incorporated to resist and/or reduce fouling attachment. In some embodiments, additives allow the coatings to reduce adhesion strength of fouling organisms.

The type and amount of amphiphilicity-modifying additive that is selected for use in the pre-cured compositions is, in part, dependent on the performance requirements of the cured epoxy-based coating, the type of surface or substrate the coating is to be formed on, and/or compatibility with the other components of the pre-cured composition.

In some embodiments, the amphiphilicity-modifying additives of the present disclosure are included in the pre-cured composition in an amount sufficient to provide cured epoxy-based coatings having a wet coefficient of friction of ≤0.2 when measured using an ASM 925 COF meter (American Slipmeter) following ASTM D2047. In some embodiments, the amphiphilicity-modifying additive is included in an amount sufficient to provide a coating having a wet coefficient of friction of ≤0.4, or ≤0.3 when measured using an ASM 925 COF meter (American Slipmeter) following ASTM D2047. In some embodiments, the amphiphilicity-modifying additives are included in an amount sufficient to provide cured epoxy-based coatings having a wet coefficient of friction of from about 0.05 to about 0.4; or about 0.05 to about 0.3; or about 0.05 to about 0.2; or about 0.05 to about 0.15; or about 0.06 to about 0.11; or about 0.08 to about 0.12; or at any range between about 0.05 and about 0.4.

In one or more embodiments, the amphiphilicity-modifying additives that are included in the pre-cured compositions (i) have a glass transition temperature from about −30° C. to about 10° C.; (ii) have a viscosity of about 100 to about 2500 cps; (iii) are soluble in solvents comprising acetates, ketones, and/or aromatic hydrocarbons; (iv) have compatibility with the other components of the pre-cured composition to avoid or reduce formation of craters, pinholes, blushing, orange peel, and/or other visual defects characteristic of a poorly compatible composition; or (v) have a combination thereof. In some embodiments, the amphiphilicity-modifying additives have a viscosity of about 100 to about 2500 cps; and are soluble in solvents comprising acetates, ketones, and/or aromatic hydrocarbons; which facilitates the compatibility of the amphiphilicity-modifying additive with the other components of the pre-cured composition.

In one or more embodiments, the amphiphilicity-modifying additives are reactive in an epoxide polymerization, such that they become incorporated into the polymerization of at least the epoxy-functional monomers as the pre-cured compositions are being cured. In some embodiments, the amphiphilicity-modifying additives are reactive in an epoxide polymerization because they comprise functional groups that can react with at least the epoxy-functional monomers, such as a hydroxyl or hydroxylalkyl functional group. In some embodiments, the amphiphilicity-modifying additives are not reactive in an epoxide polymerization, but become embedded as the pre-cured compositions are being cured into a cured epoxy-based coating.

As described above, the amphiphilicity-modifying additive may comprise functional groups capable of hydrogen-bonding (i.e., accepting and/or donating). In some embodiments, the functional groups capable of hydrogen-bonding comprise hydroxyl groups, hydroxyalkyl groups, fluorohydroxyalkyl groups, ether groups, ketone or aldehyde groups, ester groups, carboxylic acid groups, amine groups, amide groups, imine groups, nitrile groups, or a combination thereof. As described above, the amphiphilicity-modifying additive may comprise charged functional groups capable of forming/attracting hydration spheres. In some embodiments, the charged functional groups comprise ammonium groups, carboxylate groups, alkoxy or aryloxy groups, nitro groups, or a combination thereof. In some embodiments, these hydrophilic functional groups are terminal groups or end groups, or pendant groups or side-chain groups. In some embodiments, these hydrophilic functional groups are terminal groups or end groups, or pendant groups, or side-chain groups of an otherwise hydrophobic additive.

In some embodiments, the amphiphilicity-modifying additive are oligomers or lower molecular weight polymers. In some embodiments, the amphiphilicity-modifying oligomers or lower molecular weight polymers may be linear or branched. In some embodiments, the amphiphilicity-modifying oligomers or lower molecular weight polymers have carbon-based (for example, C—C) backbones. In other embodiments, the amphiphilicity-modifying oligomers or lower molecular weight polymers have an organo-element (e.g., C—O, C—Si, C—Si—O) backbones. In some embodiments, the amphiphilicity-modifying oligomers or lower molecular weight polymers have in molecular weight in a range of about 300 g/mol to about 10000 g/mol, or at any range between about 300 g/mol and about 10000 g/mol, For example, the amphiphilicity-modifying additives may comprise an oligomer or polymer having a hydrophobic backbone, with hydrophilic end groups and/or hydrophilic side-chains; or the additives may comprise a co-polymer, such as a block or graft co-polymer, where at least one polymer of the co-polymer is hydrophilic (e.g., due to its backbone and/or functional groups) and at least one polymer of the co-polymer is hydrophobic (for example, due to its backbone and/or functional groups). In some embodiments, amphiphilicity-modifying additives may comprise an oligomer or polymer having a hydrophilic backbone. In other embodiments, said hydrophilic backbone may comprise hydrophilic end groups and/or hydrophilic side-chains. In some embodiments, a hydrophilic backbone comprises a polyether backbone. In other embodiments, a hydrophobic backbone comprises a carbon backbone, a siloxane backbone, otherwise referred to as a silicone backbone.

In one or more embodiments, the amphiphilicity-modifying additive comprises, consists essentially of, or consists of polyethers, polysiloxanes, polyelectrolytes, polyatomic alcohols, or a combination thereof. In one or more embodiments, the amphiphilicity-modifying additive is selected from the group consisting of polyethers, polysiloxanes, polyelectrolytes, polyatomic alcohols, and a combination thereof. In one or more embodiments, the amphiphilicity-modifying additive is selected from the group consisting of polyethers, polysiloxanes, polyelectrolytes, and a combination thereof. In one or more embodiments, the polyether, polysiloxane, polyelectrolyte, or polyatomic alcohol, comprise hydrophilic terminal groups or end groups, or hydrophilic pendant groups or side-chain groups.

In one or more embodiments, the amphiphilicity-modifying additive comprises, or consists essentially of polyethers. Polyethers are hydrophilic, due in part due to the ether linkages comprising their backbone, and/or due to their hydroxyl end-groups. In some embodiments, polyethers are hydrophilic, due in part to comprising hydrophilic pendant groups or hydrophilic sidechains. In some embodiments, polyethers may be amphiphilic, due in part to their hydrophilic polyether backbone, and hydrophobic end-groups and/or hydrophobic pendant groups or sidechains. In one or more embodiments, the polyether is linear or branched. In some embodiments, the polyether comprises polyether polyols with one or more functional end-groups, such as a hydroxyl group. In some embodiments, the polyether comprises polyalkylene glycols. In some embodiments, a polyalkylene glycol is selected to reduce potential health impacts of the cured coating due to their lower toxicity. In some embodiments, molecular weight of the polyalkylene glycol is selected to be in a range of about 200 to about 600 to meet viscosity requirements of the pre-cured composition, as polyalkylene glycols having a molecular weight between about 200 g/mol to about 600 g/mol have a relatively low viscosity (for example, less than 1000 cps, less than 500 cps, less than 250 cps, less than 100 cps). In some embodiments, the polyalkylene glycols is polyethylene glycol. In some embodiments, molecular weight of the polyalkylene glycol is selected to be in a range of about 400 to about 600 to increase the slip (and decrease the wet coefficient of friction), and increase the subsequent anti-fouling/foul-releasing properties of the cured epoxy-based coating. In one or more embodiments, polyalkylene glycol is present in the pre-cured compositions in a range of about 0.5 wt % to about 10 wt %, or in a range of about 1 wt % to about 5 wt %, or at any range of wt % between about 1 wt % and about 5%, or between about 1 wt % and about 10 wt %. In one or more embodiments, the polyalkylene glycol comprises polyethylene glycol (PEG). In some embodiments, polyethylene glycol is selected due to its lower toxicity. In some embodiments, the polyethylene glycol is PEG 400. In other embodiments, the polyethylene glycol is LIPOXOL® 400 (Polyethylene glycol with average M, of about 400 g/mol, or between about 200 to about 600 g/mol). In some embodiments, the amphiphilicity-modifying additive PEG 400 may be selected to further function as a diluent.

In one or more embodiments, the amphiphilicity-modifying additive comprises, or consists essentially of polysiloxanes (sometimes referred to as silicones), the polysiloxanes comprising hydrophilic terminal groups or end groups, and/or hydrophilic pendant groups or side-chain groups. So functionalized, the polysiloxanes are amphiphilic, due in part to their relatively hydrophobic backbone, and their relatively hydrophilic terminal groups, end groups, pendant groups and/or side-chain groups. In one or more embodiments, the polysiloxane is linear or branched. In some embodiments, the hydrophilic terminal groups or end groups, and/or hydrophilic pendant groups or side-chain groups of the polysiloxane comprise a hydroxyl group, a hydroxyalkyl group, a fluorohydroxyalkyl group or a combination thereof. A hydroxyl-functionalized, a hydroxyalkyl-functionalized, and/or a fluorohydroxyalkyl-functionalized polysiloxane may be selected to increase mar or scratch resistance, reduce the wet friction coefficient of the cured epoxy-based coating, increase the contact angle of the cured epoxy-based coating (for example, to between about 1000 to about 1100), improve surface smoothness, and/or increase flexibility of the cured epoxy-based coatings into which the polysiloxane is incorporated. In some embodiments, molecular weight of the polysiloxane is selected to be in a range of about 800 g/mol to about 10000 g/mol, or about 1000 g/mol to about 9000 g/mol to meet viscosity requirements of the pre-cured composition, as polysiloxanse having a molecular weight between about 800 g/mol to about 10000 g/mol have a relatively low viscosity (for example, less than 1000 cps, less than 500 cps, less than 250 cps, less than 100 cps). In one or more embodiments, a hydroxyl-functionalized, a hydroxyalkyl-functionalized, and/or a fluorohydroxyalkyl-functionalized polysiloxane may be selected to reduce the wet friction coefficient of the cured epoxy-based coating, and/or increase the contact angle of the cured epoxy-based coating (for example, to between about 1000 to about 110°).

In one or more embodiments, the polysiloxane is present in the pre-cured compositions in a range of about 1 wt % to about 20 wt %, or in a range of about 5 wt % to about 15 wt %, or at any range of wt % between about 1 wt % and about 20 wt %, or at any range of wt % between about 5 wt % and about 15 wt %. In one or more embodiments, the polysiloxane comprises a linear di-functional silicone pre-polymer with hydroxyl terminal end groups. In some embodiments, the polysiloxane is Silmer® OH Di-10 (a linear di-functional silicone pre-polymer with hydroxyl terminal end groups). In one or more embodiments, the polysiloxane comprises hydroxyalkyl modified silicones. In some embodiments, the hydroxyalkyl modified silicones comprises four primary hydroxyl groups, a branched alkyl group with two primary hydroxyl groups, or a combination thereof. In some embodiments, the polysiloxane is Silmer® OHT Di-10, Silmer® OHT Di-50, SilmerO OHT Di-100, or a combination thereof (hydroxyalkyl modified silicones of various chain lengths comprising four primary hydroxyl groups, and terminal branched alkyl groups with two primary hydroxyl groups). In some embodiments, the Silmer® OHT Di-10, Silmer® OHT Di-50, Silmer® OHT Di-100, or a combination thereof is present in the pre-cured compositions in a range of about 2 wt % to about 15 wt %, or in a range of about 3 wt % to about 12 wt %, or at any range of wt % between about 2 wt % and about 15 wt %. In one or more embodiments, the polysiloxane comprises a fluorohydroxylalkylated dimethyl siloxane oligomer. In one or more embodiments, the polysiloxane comprises a reactive fluorosilicone comprising primary hydroxyl groups. In some embodiments, the polysiloxane is Silmer® OHF B10 (reactive fluorosilicone comprising primary hydroxyl groups). In some embodiments, the Silmer® OHF B10 is present in the pre-cured compositions in a range of about 0.05 wt % to about 10 wt %, or in a range of about 0.05 wt % to about 6 wt %, or at any range of wt % between about 0.05 wt % and about 10 wt %. In one or more embodiments, the polysiloxane comprises a hydroxyalkyl-functional polydialkylsiloxane. In some embodiments, the polysiloxane is a hydroxyalkyl-functional polydimethylsiloxane. In some embodiments, the hydroxyalkyl-functional polydimethylsiloxane is present in the pre-cured compositions in a range of about 0.05 wt % to about 10 wt %, or in a range of about 0.05 wt % to about 5 wt %, or at any range of wt % between about 0.05 wt % and about 10 wt %.

In one or more embodiments, the amphiphilicity-modifying additive comprises polyelectrolytes. In some embodiments, the polyelectrolytes are oligomers or low molecular weight polymers. Polyelectrolytes comprise charged functional groups that, in some embodiments, are capable of forming/attracting hydration spheres. In some embodiments, the charged functional groups comprise ammonium groups, carboxylate groups, alkoxy or aryloxy groups, nitro groups, or a combination thereof. In some embodiments, the charged functional groups are terminal or end groups. In other embodiments, the charged functional groups are pendant or side-chain groups. In some embodiments, the polyelectrolytes have an organic (for example, C—C) backbone. In other embodiments, the polyelectrolytes have an organo-element (for example, C—O, C—Si, C—Si—O) backbone. In one or more embodiments, the polyelectrolytes are amphiphilic, due in part due to a relatively hydrophobic backbone (for example, C—C, Si—O, etc.) in combination with their relatively hydrophilic charged terminal groups, end groups, pendant groups, and/or side-chain groups. In one or more embodiments, the polyelectrolyte is linear or branched. In one or more embodiments, the polyelectrolyte has a glass transition temperature of about −30° C. to about 5° C. In one or more embodiments, the polyelectrolyte has a viscosity between about 500 cps to about 2500 cps.

In some embodiments, the polyelectrolyte comprises a relatively hydrophobic siloxane backbone, and relatively hydrophilic ammonium terminal groups, end groups, pendant groups and/or side-chain groups. In some embodiments the ammonium terminal groups, end groups, pendant groups, and/or side-chain groups are quaternary ammonium groups. In some embodiments the ammonium terminal groups, end groups, pendant groups, and/or side-chain groups are alkyl quaternary ammonium groups. In one or more embodiments, such an ammonium-functionalized polysiloxane may be selected to reduce yellowing or oil-spotting that may occur with other silicones. In some embodiments, such an ammonium-functionalized polysiloxane may be selected to prevent growth of bacteria, biofilms, and/or other life forms on the surface of the cured epoxy-based coating. In some embodiments, such an ammonium-functionalized polysiloxane may be selected to impart the surface of the cured epoxy-based coating with a static charge. In some embodiments, the static may prevent the growth of the bacteria, biofilms and/or other life forms on the cured coating's surface. In one or more embodiments, the ammonium-functionalized polysiloxane is incorporated into the pre-cured composition in combination with at least one other amphiphilicity-modifying additive, such as the polyethers, polysiloxanes, or polyatomic alcohols. In one or more embodiments, the ammonium-functionalized polysiloxane is incorporated into the pre-cured composition in combination with one or more of the hydroxyl-functionalized, hydroxyalkyl-functionalized, and/or fluorohydroxyalkyl-functionalized polysiloxane, and the polyalkylene glycol amphiphilicity-modifying additives. In one or more embodiments, the ammonium-functionalized polysiloxane is incorporated into the pre-cured composition in combination with the epoxy-functional epoxide-siloxane monomers. In one or more embodiments, the ammonium-functionalized polysiloxane is incorporated into the pre-cured composition in combination with at least one other amphiphilicity-modifying additive and the epoxy-functional epoxide-siloxane monomers.

In one or more embodiments, polyelectrolyte is present in the pre-cured compositions in a range of about 0.5 wt % to about 10 wt %, or in a range of about 1 wt % to about 5 wt %, or at any range of wt % between about 0.5 wt % and about 10 wt %, or at any range of wt % between about 1 wt % and about 5 wt %. In one or more embodiments, the polyelectrolyte comprises a dialkyl quaternary ammonium modified polysiloxane. In some embodiments, the polyelectrolyte is Silquat®3180 (a silicone quaternary compound). In some embodiments, the Silquat®3180 is present in the pre-cured compositions in a range of about 0.05 wt % to about 10 wt %, or in a range of about 0.05 wt % to about 5 wt %, or at any range between about 0.05 wt % and about 10 wt %.

In one or more embodiments, the amphiphilicity-modifying additive comprises polyatomic alcohols. Polyatomic alcohols may comprise two or more hydroxyl groups. In some embodiments, the hydroxyl groups are terminal groups, or end groups. In other embodiments, the hydroxyl groups are pendant groups, or side-chain groups. In some embodiments, the polyatomic alcohols have an organic (for example, polyolefin, C—C, etc.) backbone. In one or more embodiments, the polyatomic alcohols are amphiphilic, due in part to a relatively hydrophobic backbone (for example, C—C) in combination with the relatively hydrophilic hydroxyl terminal groups, end groups, pendant groups, and/or side-chain groups. In one or more embodiments, the polyatomic alcohol is linear or branched. In some embodiments, the polyatomic alcohol comprises a relatively hydrophobic polyolefin or C—C backbone, and relatively hydrophilic hydroxyl terminal groups, end groups, pendant groups, and/or side-chain groups. In one or more embodiments, the polyatomic alcohol has a glass transition temperature of about −30° C. to about 10° C. In one or more embodiments, the polyatomic alcohol is selected to meet viscosity requirements of the pre-cured composition, wherein the polyatomic alcohol has a relatively low viscosity (for example, less than 2000 cps, less than 1500 cps, less than 1000 cps, less than 500 cps). In one or more embodiments, a polyatomic alcohol is selected to provide cured epoxy-based coatings having reduced wet coefficient of frictions (WCOF). In some embodiments, a solid polyatomic alcohol may be avoided (for example, sorbitol, mannitol, etc.), as they may not blend or disperse well in the pre-cured compositions, may not reduce the wet coefficient of friction, and/or may phase out of the pre-cured compositions at temperatures below 0° C.

In one or more embodiments, the polyatomic alcohol is incorporated into the pre-cured composition in combination with at least one other amphiphilicity-modifying additive, such as the polyethers, polysiloxanes, or polyelectrolytes. In one or more embodiments, the polyatomic alcohol is incorporated into the pre-cured composition in combination with one or more of the hydroxyl-functionalized, hydroxyalkyl-functionalized, and/or fluorohydroxyalkyl-functionalized polysiloxane, the polyalkylene glycol, and the ammonium-functionalized polysiloxane amphiphilicity-modifying additives. In one or more embodiments, the polyatomic alcohol is incorporated into the pre-cured composition in combination with the epoxy-functional epoxide-siloxane monomers. In one or more embodiments, the polyatomic alcohol is incorporated into the pre-cured composition in combination with at least one other amphiphilicity-modifying additive and the epoxy-functional epoxide-siloxane monomers. In one or more embodiments, the polyatomic alcohol is incorporated into the pre-cured composition in combination with at least one other amphiphilicity-modifying additive and/or the epoxy-functional epoxide-siloxane monomers to maintain the contact angle of the cured epoxy-based coating at or above about 100°; or to prevent the contact angle from decreasing to below 100°.

In one or more embodiments, polyatomic alcohol is present in the pre-cured compositions in a range of about 0.5 wt % to about 10 wt %, or in a range of about 1 wt % to about 5 wt %, or at any range of wt % between about 0.5 wt % and about 10 wt %, or at any range of wt % between about 1 wt % and about 5 wt %. In one or more embodiments, the polyatomic alcohol comprises glycerol.

Dispersant

One or more embodiments of the present disclosure provides pre-cured compositions that further comprise at least one dispersant for dispersing the wear-inhibiting additive in the composition. In some embodiments, at least one dispersant is included in the pre-cured compositions to maintain the wear-inhibiting additive suspended in the compositions. In other embodiments, at least one dispersant is included in the pre-cured compositions to prolong the shelf-life of the compositions. For example, the dispersant may be included to maintain all components of the pre-cured compositions—additives or otherwise—in suspension, such that none of the components settle, or precipitate out of the compositions.

In some embodiments of the present disclosure, the at least one dispersant is a polymeric dispersant. In some embodiments, the polymeric dispersant is Additol VXW 6208, Soldplus D610, K-Sperse A504, or a combination thereof. Additol VXW 6208 is a water-based solution of modified acrylic copolymers. K-Sperse A504 comprises a polyester-polyamide co-polymer having anhydride functional groups.

The type and amount of dispersant that is selected for use in the pre-cured composition is, in part, dependent on the performance requirements of the epoxy-based coating, the types of wear-inhibiting additives that are used, and/or the required shelf-life of the pre-cured composition.

In some embodiments, Additol VXW 6208, Soldplus D610, K-Sperse A504, or a combination thereof may be selected to maintain the wear-inhibiting additive suspended in the composition when one or more of unmodified graphene nanoplatelets, unmodified graphite flakes, carbon black, fullerene, titanium dioxide, aluminum oxide, Ca magnesium silicate, and zinc oxide are used as the wear-inhibiting additive. In some embodiments, Additol VXW 6208 may be selected to maintain the wear-inhibiting additive suspended in the composition when at least graphene nanoplatelets and/or graphite flakes are used as the wear-inhibiting additive. For example, the Additol VXW 6208 may be homogeneously mixed into the pre-cured composition to keep the graphene nanoplatelets and/or graphite flakes suspended. In some embodiments, Soldplus D610, K-Sperse A504, or a combination thereof may be selected to prolong the shelf-life of the pre-cured composition. In some embodiments, Soldplus D610, K-Sperse A504, or a combination thereof may be selected to prolong the shelf-life of the pre-cured composition by about 6 months. In some embodiments, to affect maintaining the wear-inhibiting additive suspended in the pre-cured composition, and/or to affect prolonging the shelf-life of the composition, the polymeric dispersant is present in the pre-cured composition in a range of about 0.1 wt % to about 5 wt %; or about 0.1 wt % to about 0.5 wt %; or about 1 wt % to about 2 wt %; or about 1 wt % to about 3 wt %; or about 1 wt % to about 4 wt %; or about 1 wt % to about 5 wt %, or at any range of wt % between about 0.1 wt % and about 5 wt %.

In some embodiments, the dispersant is one that can disperse organic and/or inorganic pigments (for example, carbon black, fullerene, titanium dioxide, aluminum oxide, Ca magnesium silicate, zinc oxide, or a combination thereof). In some embodiments, the dispersant is K-Sperse A504 (for organic and inorganic pigments); HYPERMER KD2-LQ-(CQ); HYPERMER KD24-SS-(RB); Solplus D610 (for dispersion of organic pigments and silica sand in epoxy-based coatings); Additol VXW 6208 (for dispersion of organic pigments); HPERMER KD6-LQ-MV (for dispersion of carbon materials, metal oxides and titanate); Disperbyk 140 (for carbon black, organic pigment, titanium dioxide).

Defoamer

One or more embodiments of the present disclosure provides pre-cured compositions that further comprise at least one defoamer. In some embodiments, the at least one defoamer is included in the pre-cured compositions to reduce or inhibit air entrapment/bubble formation in the cured epoxy-based coatings. Reducing or inhibiting air entrapment/bubble formation in the cured coatings also reduces or inhibits defect formation (for example, reduced roughness; reduced porosity), which would otherwise result in fouling of the coating or corrosion of the substrate. In other embodiments, the at least one defoamer is included in the pre-cured compositions to decrease the surface energies of the resultant, cured epoxy-based coatings, thereby increasing the coatings' hydrophobicity and improving the coatings' antifouling/foul-releasing properties (relative to control epoxy-based coatings; see Hydrophobicity-Modifying Additive above).

In some embodiments of the present disclosure, the at least one defoamer comprises a silicone-modified defoamer. Silicone-modified defoamers work by penetrating and destroying foam lamellas. In some embodiments, the silicone-modified defoamer comprises, consists essentially of, or consists of Additol VXW 6210N, BYK-A 530, or a combination thereof. Additol VXW 6210N is a silicone modified defoamer, and comprises silicone glycol modified liquid hydrocarbons. BYK-A 530 is a silicone defoamer. In some embodiments, the silicone-modified defoamer comprises, consists essentially of, or consists of an organo-modified siloxane containing fumed silica. In some embodiments, the organo-modified siloxane containing fumed silica is Tego Airex 900®.

The type and amount of defoamer that is selected for use in the pre-cured composition is, in part, dependent on the performance requirements of the epoxy-based coating, and/or the bubble-formation tendencies of the cured coating.

In some embodiments, Additol VXW 6210N, BYK-A 530, or a combination thereof may be selected to reduce or inhibit bubble formation in the cured epoxy-based coatings. In other embodiments, Additol VXW 6210N, BYK-A 530, or a combination thereof may be selected to decrease surface energies of the cured epoxy-based coatings, thereby increasing the coatings' hydrophobicity and improving the coatings' antifouling/foul-releasing properties (relative to control epoxy-based coatings). In some embodiments, Additol VXW 6210N may be selected to reduce or inhibit bubble formation in the cured epoxy-based coatings; and to decrease surface energies of the cured epoxy-based coatings. In some embodiments, to affect reducing/inhibiting bubble formation in the cured epoxy-based coatings, and/or to affect decreasing surface energies of the cured epoxy-based coatings, Additol VXW 6210N is present in the pre-cured composition in a range of about 0.5 wt % to about 6 wt %; or about 1 wt % to about 6 wt %; or about 2 wt % to about 6 wt %; or about 3 wt % to about 6 wt %; or about 4 wt % to about 6 wt %; or about 5 wt % to about 6 wt %; or at any range of wt % between about 0.5 wt % and about 6 wt %. In further embodiments, BYK-A 530 is present in the pre-cured composition in a range of about 0.2 wt % to about 2 wt %; or about 0.2 wt % to about 1 wt %; or about 0.2 wt % to about 1 wt %; or about 0.2 wt % to about 0.8 wt %; or at any range of wt % between about 0.2 wt % and about 2 wt %.

In some embodiments, the organo-modified siloxane containing fumed silica or Tego Airex 900® is selected to reduce or inhibit bubble formation in the cured epoxy-based coatings. In other embodiments, the organo-modified siloxane containing fumed silica or Tego Airex 900® is selected to decrease surface energies of the cured epoxy-based coatings, thereby increasing the coatings' hydrophobicity and improving the coatings' antifouling/foul-releasing properties (relative to control epoxy-based coatings). In some embodiments, Tego Airex 900® may be selected to reduce or avoid formation of craters, pinholes, blushing, orange peel, and/or other visual defects. In some embodiments, the organo-modified siloxane containing fumed silica or Tego Airex 900® is selected to reduce porosity in the cured epoxy-based coating. In some embodiments, to affect reducing/inhibiting bubble formation in the cured epoxy-based coatings, reducing porosity, to reduce or avoid visual defects, and/or to affect decreasing surface energies of the cured epoxy-based coatings, the organo-modified siloxane containing fumed silica or Tego Airex 900® is present in the pre-cured composition in a range of about 0.05 wt % to about 2 wt %; or about 0.1 wt % to about 2 wt %; or about 0.2 wt % to about 2 wt %; or about 0.4 wt % to about 2 wt %; or about 0.8 wt % to about 2 wt %; or about 1.5 wt % to about 2 wt; or at any range of wt % between about 0.05 wt % and about 2 wt %.

Rheological Additive

One or more embodiments of the present disclosure provides pre-cured compositions that further comprise at least one rheological additive. In some embodiments, the at least one rheological additive is included in the pre-cured compositions to modify the viscosity of the pre-cured and/or curing composition. The at least one rheological additive may modify the viscosity of the pre-cured and/or curing composition by increasing the viscosity so that there is at least reduced sagging of the curing composition when it is applied to a surface or a substrate (relative to a control coating). In some embodiments, the at least one rheological additive may modify the viscosity of the pre-cured and/or curing composition by decreasing the viscosity so that the curing composition has a sufficiently low viscosity to be applied to a surface or a substrate via brushing, rolling, spraying, etc. (relative to a control coating). In some embodiments, the at least one rheological additive modifies the viscosity of the pre-cured and/or curing composition so that the curing composition can be applied to a surface or a substrate via brushing, rolling, spraying, etc., while also at least reducing sagging of the curing composition when it is applied to a surface or a substrate, to at least reduce formation of macroscopic defects and roughness, such as curtains, droplet runs, or other sag-related defects (relative to a control coating). Such defects may occur in the absence of the rheological additive, and may lead to increased roughness of the cured coating's surface, worsened hydrodynamics, and/or additional sites of growth for fouling materials. In some embodiments, the at least one rheological additive is included in the pre-cured compositions to increase the thixotropic properties of the pre-cured or curing compositions. Increasing the thixotropic properties of the pre-cured or curing compositions may improve the processibility and handling of the pre-cured or curing compositions, by making the compositions easier to mix, stir, or apply to a surface or substrate. In other embodiments, the at least one rheological additive is included in the pre-cured compositions to contribute to solids suspension. In some embodiments, the solids or pigments. In some embodiments, at least one rheological additive is included in the pre-cured compositions to prolong the shelf-life or package stability of the compositions.

The type and amount of rheological additive that is selected for use in the pre-cured composition is, in part, dependent on the performance requirements of the epoxy-based coating, and/or the type of surface or substrate the coating is to be formed on. In one or more embodiments of the present disclosure, the at least one rheological additive comprises, consists essentially of, or consists of a fumed silica, a castor oil derivative, a clay, or a combination thereof. In one or more embodiments of the present disclosure, the at least one rheological additive comprises, consists essentially of, or consists of a fumed silica, a castor oil derivative, bentonite, montmorillonite, a modified montmorillonite clay (for example, Claytone HY®), or a combination thereof. In some embodiments, the castor oil derivative comprises, consists essentially of, or consists of an organo-modified castor oil derivative. In some embodiments, the castor oil derivative is Thixatrol ST®.

In one or more embodiments, the at least one rheological additive may act as a hydrophobicity-modifying additive. For example, in some embodiments, the at least one rheological additive comprises, or consists essentially of polydimethylsiloxane (PDMS)-silica or fumed-silica, which may also act as a hydrophobicity-modifying additive and be applied (for example, sprayed, brushed, etc.) on to the surface of the coating as it is curing into a cured epoxy-based coating to increase the cured coating's hydrophobic properties.

In one or more embodiments, to affect the rheological properties of the pre-cure or curing compositions, the at least one rheological additive is present in the pre-cured composition in a range of about 0.01 wt % to about 5 wt %; about 0.01 wt % to about 3 wt %; or about 0.05 wt % to about 2; or about 0.05 wt % to about 1 wt %; or at any range of wt % between about 0.01 wt % and about 3 wt %, or at any range of wt % between about 0.01 wt % and about 5 wt %. In further embodiments, Thixatrol ST® is present in the pre-cured composition in a range of about 0.05 wt % to about 1 wt %.

Curing Catalyst

One or more embodiments of the present disclosure provides pre-cured compositions that further comprise a curing catalyst. Curing catalysts of the present disclosure are reactive in accelerating curing the pre-cured compositions to form the cured epoxy-based coatings.

In some embodiments, the curing catalyst is reactive in accelerating curing, such that it catalyzes the polymerization and/or crosslinking of the pre-cured composition. In other embodiments, the curing catalyst can catalyze the polymerization and/or crosslinking of the pre-cured composition as well as act as a cross-linker in the reaction. In some embodiments, the curing catalyst can catalyze the polymerization and/or cross-linking of the pre-cured composition at lower reaction temperatures (for example, about −5° C. to about 0° C.). In some embodiments, the curing catalysts are reactive because they comprise functional groups that can react with at least the epoxy-functional monomers as the pre-cured compositions are being cured, such as amine functional groups.

In some embodiments, the curing catalyst is included in the pre-cured compositions, and does not begin to catalyze the polymerization and/or cross-linking of composition until a hardener is added to the composition (i.e., see Hardener below). In other embodiments, the curing catalyst is added to the hardener, which begins accelerating curing upon addition to the pre-cured composition.

In some embodiments, the curing catalyst is used when the hardener selected for curing the pre-cured composition (described below) reacts slowly at or below ambient temperatures (for example, if the hardener is polyamine). In other embodiments, when the selected hardener reacts quickly at or below ambient temperatures (for example, if the hardener is phenalkamine), a curing catalyst may not be needed.

In some embodiments of the present disclosure, the curing catalyst is a non-reactive diluent (see Diluents above), and is included in the pre-cured composition. In some embodiments, the curing catalyst comprises benzyl dimethylamine (BDMA), imidazole, ureas (for example, trisubstituted ureas), urons, N,N-di-(2-hydroxyethyl)aniline, 2,4,6-tris[(dimethyllamino)methyl]phenol, triethanolamine, or a combination thereof, and is included in the hardener.

In some embodiments, the curing catalyst comprises an alcohol that may be included in the pre-cured composition or the hardener, such as nonyl phenol, cyclohexanedimethanol, n-butyl alcohol, benzyl alcohol, isopropyl alcohol, propylene glycol, phenol, 2,4,6-tris[(dimethyllamino)methyl]phenol, triethanolamine, or a combination thereof. Using alcohols as the curing catalyst can simplify curing speed adjustments, such that there is no need to recalculate the hardener to epoxy stoichiometry. Alcohol curing catalysts can be added until either the desired reactivity is achieved, or until some performance characteristic of the cured epoxy-based coating declines to an unacceptable level, requiring further reformulation. Without wishing to be bound by theory, it has been reported that when excess epoxy resin and/or high temperatures are used in curing, the curing catalyst tris-(dimethyl amino methyl) phenol may cause some epoxy-homopolymerization. Further, without wishing to be bound by theory, it has been suggested that crosslinking of epoxy resin may occur through reaction of epoxide with the primary hydroxyl groups of triethanolamine when it is used to accelerate mixtures containing a stoichiometric excess of epoxide groups.

In other embodiments, the curing catalyst comprises benzyl dimethylamine (BDMA), imidazole, ureas (for example, trisubstituted ureas), urons, N,N-di-(2-hydroxyethyl)aniline, or a combination thereof, and is added to the hardener. Using said curing catalysts may require recalculation of hardener to epoxy stoichiometry to maintain optimum long-term performance; for example, if the curing catalyst is less efficient and requires higher concentrations, etc.

In some embodiments, the curing catalyst is included in the pre-cured composition or the hardener if: the epoxy-based coating is not completely curing; it was necessary to cure the epoxy-based coating at lower temperatures; and/or the epoxy-based coating is taking too long to cure (for example, 1 week to cure). In some embodiments, the curing catalyst is included in a range of about 1 wt % to about 5 wt %; or about 1 wt % to about 10 wt %; or at any range of wt % between about 1 wt % and about 10 wt %.

In some embodiments, 2,4,6-tris[(dimethyllamino)methyl]phenol may be selected and added to the hardener to catalyze curing the pre-cured composition. In other embodiments, 2,4,6-tris[(dimethyllamino)methyl]phenol may be selected to catalyze curing the pre-cured composition at lower temperatures. In some embodiments, to affect catalyzing the curing the pre-cured composition, 2,4,6-tris[(dimethyllamino)methyl]phenol is present in the hardener in a range of about 1 wt % to about 5 wt %; or about 1 wt % to about 10 wt %; or at any range of wt % between about 1 wt % and about 10 wt %.

Hardener

As described above, one or more pre-cured compositions can be used to form cured epoxy-based coatings by reacting the compositions with a hardener. Hardeners of the present disclosure are reactive in curing the pre-cured compositions to form a cured epoxy-based coating.

Hardeners of the present disclosure can trigger, and in some cases participate in the curing reaction (for example, the polymerization and/or crosslinking of at least the epoxy-functional monomers) that converts the pre-cured composition into an infusible, insoluble polymer network that is the cured epoxy-based coating. In some embodiments, the hardeners participate in the curing reaction by acting as cross-linkers. Generally, curing involves crosslinking and/or chain extension through the formation of covalent bonds between individual chains of polymer (for example, formed by polymerizing at least the epoxy-functional monomers), thereby forming rigid, three-dimensional structures and high molecular weights (for example, an epoxy-based coating).

Hardeners of the present disclosure are reactive in an epoxide polymerization, such that they can become incorporated into the polymerization (for example, as a cross-linker) of at least the epoxy-functional monomers as the pre-cured compositions are cured to form epoxy-based coatings. In some embodiments, the hardeners are reactive in an epoxide polymerization because they comprise functional groups that can at least react with the epoxy-functional monomers, such as an amine functional group, or an amide functional group.

Hardeners of the present disclosure begin triggering the curing reaction upon addition to the pre-cured composition. As such, the pre-cured compositions and hardeners may be provided in two separate containers: one containing the compositions and another containing the hardeners. In some embodiments, these are called bi-component (or “two-component” or “two-part”) resin systems. To use such systems, the pre-cured compositions are first mixed with a hardener, which triggers the cure of the composition into the infusible, insoluble polymer network. The resulting mixture is then applied to a substrate. Generally, application of heat or radiation is not necessary to cure bi-component resin systems. In some embodiments, bi-component resin systems can cure in as little as 2 minutes, or take longer, depending on the nature and concentration of the resin/catalyst/hardener, as well as the curing conditions (for example, cooler temperatures).

In some embodiments of the present disclosure, the hardener comprises an amine hardener, an amide hardener, or a combination thereof. In some embodiments, the hardener is polymeric. In other embodiments, the hardener is a small molecule. For example, in some embodiments, the amine hardener, amide hardener, or combination thereof comprises: a reaction product of triethylenetetramine with phenol and formaldehyde and polyethylenepolyamines; polyamide; triethylenetetramine and olyoxypropylenediamine; polyether amine; polyamine; phenalkamine and polyamide; phenalkamine; or a combination thereof. In some embodiments, the amine hardener, amide hardener, or combination thereof comprises: Phenalkamine, West System® Hardener Extra Slow 209, West System® 206 Slow Hardener, WEST SYSTEM 205 Slow Hardener, West System Hardener Fast 205, PRIAMINE 1071-LQ-GD (a polyamine), GX-1120XB80 (KH) (a polyamide), KMH-100 (phenalkamine), DNST, KH 3001—Accelerator (a triamine), EPIKURE 3292FX60, EPIKURE 3253, and GX-1120XB80 (KH) (a polyamide). In other embodiments, the hardener comprises polyfunctional acids (and acid anhydrides), phenols, alcohols, thiols, or combinations thereof.

In some embodiments, a particular hardener may be selected if it is desirable: (i) to have more time to apply the pre-cured composition and hardener mixture to a substrate (for example, long working time), and for the cured coating to have good surface finishing (glossy) (A West System Hardener Extra Slow 209); (ii) to have low temperature curing, a fast re-coating window, and short working time (West System Hardener Fast 205); (iii) for the cured coating to have good water resistance, long pot life, increased hydrophobicity, and good surface finishing(glossy), and for the coating to cure at ambient temperatures (PRIAMINE 1071-LQ-GD, a polyamine); (iv) for the cured coating to have a very good surface appearance, and low surface defects, as well as a long curing time (GX-1120XB80 (KH), a polyamide); (v) for the cured coating to be hard and hydrophobic, to use a natural source (green chemistry) for a hardener, and to have low temperature curing (KMH-100, phenalkamine); and/or (vi) to catalyze the curing reaction, for example, in combination with polyamides/polyamines (KH 3001—Accelerator, a triamine; EPIKURE 3253); (vii) to reduce viscosity and get reduce or inhibit bubbles via VOC content (EPIKURE 3292FX60, 60% xylene/butanol; GX-1120XB80 (KH), a polyamide).

In some embodiments, a particular hardener may be selected if the epoxy-functional monomers of the pre-cured composition comprise an epoxy-functional epoxide-siloxane monomers. When the epoxy-functional monomers are an epoxy-functional epoxide-siloxane monomer, the hardener selected may comprise a silamine hardener, otherwise referred to as an aminosilane hardener. Silamine hardeners comprise silane functional groups (for example S—H), and amine functional groups, such as primary and secondary amine groups. Without wishing to be bound by theory, the silane functional groups may crosslink with the siloxane side-chains of the epoxy-functional epoxide-siloxane monomer during curing; and/or the amine functional groups may crosslink with the epoxy functional groups of the epoxy-functional epoxide-siloxane monomer during curing.

In one or more embodiments, the silamine hardener may be selected from aminopropyltriethoxysilane (Andisil 1100, or Dynasylan® AMEO), bis(3-triethoxysilylpropyl)amine (Dynasylan 1146), or N-2-aminoethyl-3-aminopropyltrimethoxysilane (Dynasylan DAMO), or a combination thereof. In one or more embodiments, the amount of silamine hardener used to cure the pre-cured composition is calculated based on the amine equivalent weight of the hardener, where the epoxy-to-amine ratio is maintained equimolar (for example, see below).

In some embodiments, the hardener comprises primary amine-modified phenalkamine, benzyl dimethylamine, N,N-di-(2-hydroxyethyl)aniline, triethanolamine, aminopropyltriethoxysilane, bis(3-triethoxysilylpropyl)amine, or a combination thereof.

In some embodiments, the hardener is selected such that the degree of crosslinking that occurs during the curing of the pre-cured composition is about 60% to about 99%, or about 70% to about 99%, or about 80% to about 99%, or about 90% to about 99%, or about 99%. In some embodiments, the cured epoxy-based coating exhibits reduced porosity, amine blushing, and/or amine blooming relative to a control coating.

In some embodiments, the hardener is reactive in curing the pre-cured compositions to form a cured epoxy-based coating at temperatures between about −5° C. to about 100° C. In some embodiments, the hardener is reactive in curing the pre-cured compositions to form a cured epoxy-based coating at ambient temperatures and conditions. In other embodiments, the hardener is selected such that the pre-cured composition can be cured at lower reaction temperatures (for example, about −5° C. to about 0° C.). In such embodiments, the hardener comprises phenalkamine.

To affect curing of the pre-cured compositions, hardeners of the present disclosure are added to the composition at a ratio of epoxy resin to hardener of 1:1 to 1:1/5; or 1:2.3 to 1:3. In some embodiments, a ratio of 1:2.3 to 1:3 may be selected to increase the rate of the curing reaction, which can facilitate curing at lower temperatures. In some embodiments, using less hardener relative to the epoxy resin can lead to an incomplete curing reaction, low mechanical properties, and/or an non-functional coating; whereas, using too much hardener relative to the epoxy resin can accelerate the curing reaction, and can leave unreacted hardener on the coating, causing a loss or reduction in coating function.

The amount of hardener used for curing the pre-cured composition can also be expressed in terms of equivalent weights. For example: an epoxy resin contains epoxy groups that react with a hardener to produce a cross-linked polymer. If an epoxy resin is said to have an equivalent weight of 150 g/eq, that means that 150 g of resin contains one reactive epoxy group. It may also mean that 300 g of epoxy resin has two reactive epoxy groups, i.e. there is one epoxy for every 150 g. Some epoxy resins may have 3 or 4 reactive epoxy groups, but the equivalent weight still represents the weight of resin that has one reactive group. Just as an epoxy resin has an equivalent weight, a hardener also has an equivalent weight. An amine hardener has reactive N—H groups than can react with an epoxy group. The equivalent weight of an amine may be expressed as having an amine equivalent weight 30 g/eq. This means that 30 g of material has one N—H group or that 60 g has 2 N—H groups or that 90 g has 3 N—H groups. A NH₂ group on an amine hardener is considered to have 2 N—H groups. Therefore, if there is an epoxy resin with an equivalent weight of 150 g/eq epoxy being mixed with an amine hardener having an equivalent weight of 30 g/eq amine, for a complete curing reaction to occur, one equivalent of epoxy reacts with one equivalent of N—H amine:
One equivalent epoxy resin weighs 150 g;
One equivalent amine hardener weighs 30 g;
The mix ratio by weight is 150 g epoxy per 30 g amine, which is 5 g epoxy per 1 g of amine;
For this system the mix ratio is a fixed weight ratio, that can be expressed in several different ways: 50 g epoxy for 10 g amine; 20 g amine for 100 g of epoxy.

In one or more embodiments of the present disclosure, any one or more of the hydrophobicity-modifying additives, the graphite flakes, the graphene nanoplatelets, the amphiphilicity-modifying additives, the dispersants, the defoamers, the rheological additives, and the curing catalysts—wherein the additives are not epoxy-functionalized, or are not a wear-inhibiting additive (with the exception of the graphite flakes, or the graphene nanoplatelets)—can be first added to and/or dispersed in the hardener prior to being added to any one or more of the pre-cured compositions of the present disclosure.

Method and Application

As described above, one or more embodiments of the present disclosure provides a method for forming one or more of the pre-cured compositions.

In one or more embodiments of the present disclosure, the method comprises mixing epoxy-functional monomers and a diluent to form a first mixture; mixing into the first mixture a hydrophobicity-modifying additive, a wear-inhibiting additive, a dispersant, an amphiphilicity-modifying additive, a defoamer, and/or a rheological additive; and forming the composition for a coating.

In one or more embodiments of the present disclosure, the method comprises mixing the hydrophobicity-modifying additive into a first mixture comprising the epoxy-functional monomers and the diluent. In some embodiments, the method further comprises mixing the wear-inhibiting additive and dispersant into the first mixture. In some embodiments, the method further comprises mixing a defoamer and/or a curing catalyst into the first mixture. In some embodiments, the method further comprises mixing the amphiphilicity-modifying additive into the first mixture. In some embodiments, the method further comprises mixing a rheological additive into the first mixture.

In some embodiments, the first mixture comprising the epoxy-functional monomers and diluent is formed by adding a select amount of the epoxy-functional monomers to a select amount of the diluent, and mixing until the mixture appears homogeneously mixed. In some instances, high sheer mixing is used, and may cause bubble formation, in which case the first mixture may be left to rest and degas until the bubbles appear to be reduced or gone. In one or more embodiments of the present disclosure, the method comprises mixing the dispersant into the first mixture to form a second mixture; mixing the wear-inhibiting additive into the second mixture to form a third mixture; and mixing the hydrophobicity-modifying additive into the third mixture to form a fourth mixture. In some embodiments, the method further comprises mixing a rheological additive into the second mixture or the third mixture. In some embodiments, the method further comprises mixing the amphiphilicity-modifying additive into the third mixture or the fourth mixture. In some embodiments, a selected amount of the dispersant is added into the first mixture and mixed under high sheer to form the second mixture; then a selected amount of the wear-inhibiting additive is added to form the third mixture and mixed under high sheer (for example, >3000 rpm) until the wear-inhibiting additive is well-dispersed (for example, agglomerations of <2 particles of wear-inhibiting additive, confirmed under microscope); once the wear-inhibiting additive is well-dispersed, a selected amount of the hydrophobicity-modifying additive is added to the third mixture and mixed under high sheer until the mixture is homogeneously mixed.

In one or more embodiments of the present disclosure, the method comprises mixing a first hydrophobicity-modifying additive into the first mixture to form a second mixture; mixing the dispersant into the second mixture to form a third mixture; mixing the wear-inhibiting additive into the third mixture to form a fourth mixture; mixing a defoamer into the fourth mixture to form a fifth mixture; and mixing a second hydrophobicity-modifying additive into the fifth mixture to form a sixth mixture. In some embodiments, the method further comprises mixing the amphiphilicity-modifying additive into the first mixture or the second mixture. In some embodiments, the method further comprises mixing the amphiphilicity-modifying additive into the fifth mixture or the sixth mixture. In some embodiments, the method further comprises mixing a rheological additive into the third mixture or the fourth mixture. In some embodiments, a selected amount of the first hydrophobicity-modifying additive is added into the first mixture and mixed under high sheer to form the second mixture; a selected amount of the dispersant is added into the second mixture and mixed under high sheer to form the third mixture; a selected amount of the wear-inhibiting additive is added to form the forth mixture and mixed under high sheer until the wear-inhibiting additive is well-dispersed; once the wear-inhibiting additive is well-dispersed, a selected amount of defoamer is added into the fourth mixture and mixed under high sheer to form the fifth mixture; and a select amount of the second hydrophobicity-modifying additive is added into the fifth mixture and mixed under high sheer until the mixture is homogeneously mixed.

In one or more embodiments of the present disclosure, the method comprises mixing the hydrophobicity-modifying additive into a first mixture comprising the epoxy-functional monomers and the diluent. In some embodiments, the method further comprises mixing the amphiphilicity-modifying additive into the first mixture. In some embodiments, the method further comprises mixing the wear-inhibiting additive and dispersant into the first mixture. In some embodiments, the method further comprises mixing a defoamer and/or a curing catalyst into the first mixture. In some embodiments, the method further comprises mixing a rheological additive into the first mixture.

In one or more embodiments of the present disclosure, the method comprises mixing a dispersant into a first mixture comprising a first epoxy-functional monomer and diluent to form a second mixture; mixing a wear-inhibiting additive into the second mixture to form a third mixture; mixing a rheological additive into the third mixture to form a fourth mixture; mixing a hydrophobicity-modifying additive into the fourth mixture to form a fifth mixture; and mixing a second amphiphilicity-modifying additive into the fifth mixture to form a sixth mixture. In some embodiments, the method further comprises mixing a defoamer into the first or second mixture and/or the fifth mixture or the sixth mixture. In some embodiments, the method further comprises mixing a first amphiphilicity-modifying additive into the fourth mixture. In some embodiments, the method further comprises mixing a mixture comprising a second epoxy-functional monomer and diluent into the the fifth or sixth mixture. In some embodiments, the first and/or second epoxy-functional monomers comprise the epoxy-functional epoxide-siloxane monomers.

In one or more embodiments, the first mixture comprising the epoxy-functional monomers, wherein the epoxy-functional monomers comprise the epoxy-functional epoxide-siloxane monomers, and diluent is formed by adding a select amount of the epoxy-functional monomers to a select amount of the diluent, and mixing until the mixture appears homogeneously mixed. In some instances, high sheer mixing is used, and may cause bubble formation, in which case the first mixture may be left to rest and degas until the bubbles appear to be reduced or gone. In some instances, the mixing occurs at about 1000 rpm. In some embodiments, mixing the wear-inhibiting additive into the second mixture to form the third mixture occurs at about 5000 to about 6000 rpm; mixing the rheological additive into the third mixture to form the fourth mixture occurs at about 4000 to about 5000 rpm; mixing the hydrophobicity-modifying additive into the fourth mixture to form the fifth mixture occurs at about 2000 to about 3000 rpm; and mixing the amphiphilicity-modifying additive into the fifth mixture occurs at about 1000 to about 2000 rpm. In some embodiments, the wear-inhibiting additive and rheological additive are added together. In some embodiments, the hydrophobicity-modifying additive and amphiphilicity-modifying additive are added together.

In some embodiments, mixing under high sheer comprises monitoring the temperature of the mixture under high sheer to maintain the temperature at or below 70° C., wherein the higher temperatures facilitate homogenizing the mixture. In some embodiments, selecting an amount of any one of the composition components (for example, epoxy-functional monomers, diluents, additives, dispersants, defoamers) is dependent on the desired properties of the cured epoxy-based coating.

In one or more embodiments of the present disclosure, the method further comprises mixing a hardener into the formed composition for a coating. In some embodiments, the method further comprises mixing a curing catalyst into the hardener.

As further described above, one or more embodiments of the present disclosure also provides an additives composition for use in forming a coating, the composition comprising the hydrophobicity-modifying additive and the wear-inhibiting additive, and optionally the amphiphilicity-modifying additive. In one or more embodiments, the additives composition is added to a diluted mixture of epoxy-functional monomers, or to a ready-mixed pre-cured coating composition in amounts sufficient for forming a coating having a contact angle of at least 90° (when measured with an Ossila Goniometer following ASTM D7334-08(2013)); and/or having improved corrosion resistance of at least 1000 hours when measured by salt fog resistance, increased mechanical strength with a D-shore hardness of at least 30D or at least 40D, or bending strength of at least 10 mm when measured by a cylindrical bed test and/or optionally having a wet coefficient of friction of ≤0.4, or ≤0.3, or ≤0.2, or in a range of about 0.05 to about 0.15 (when measured using an ASM 925 COF meter (American Slipmeter) following ASTM D2047).

One or more embodiments of the present disclosure provides for coating a surface of a substrate with a pre-cured composition mixed with a hardener, referred to herein as a curing composition. In some embodiments, this involves a) cleaning and drying the surface, b) optionally applying at least one primer coat to the surface, and c) applying at least one coat of the curing composition on top of the optional primer coat(s) to produce a cured, epoxy-based coating. The substrate to be coated may be of various natures, such as metal (for example steel), ceramic, fiberglass, carbon fiber, wood, and plastic.

In some embodiments of the present disclosure, the substrate (once coated) is for use in a wet environment. Such an environment is one in which the substrate comes regularly in contact with water. Examples of substrates may include sensors to track water parameters (such as temperature, depth, salinity, dissolved gases, pH, and others in oceans, estuarine and coastal ecosystems, freshwater environments), automobile parts, agriculture equipment, aquiculture equipment, water-power generation equipment, and oil-gas industry equipment. Examples of marine equipment include boats, ships and vessels, in particular the hulls and ballasts thereof, buoys, fish traps, underwater equipment (including underwater robotic equipment, sensors, etc.), submarines, etc. In some embodiments, the substrate includes marine equipment, preferably ship hulls, and sensors for use in wet environments.

In some embodiments, the surface of the substrate to which the curing composition will be applied is prepared by cleaning, drying and abrading it. For example, first the surface is cleaned so that it is free of contaminants such as grease, oil, wax, or mold. In some embodiments, it the surface is to be sanded, the surface is cleaned before it is sanded to avoid abrading contaminant(s) into the surface. Secondly, the surface is dried, as much as possible, to help promote adhesion of the cured coating. Then, especially in the case of hardwoods and non-porous surfaces, the surface is abraded, for example by sanding so that is become rough as this also promotes adhesion of the cured coating. In other embodiments, a surface is prepared to be coated via one of the following standards: SSPC-SP1, SSPC-SP2, SSPC-SP-5, SSPC-SP WJ-1/NACE WJ-1, and/or SSPC-SP16.

A curing composition of the present disclosure may be applied to a substrate as follows. First, a substrate, prepared as described above, is provided. Then, a primer coating is optionally applied, generally in one or two coats, on the substrate. One or more coats (preferably two or more) of the curing composition is applied on the optional primer coating, or applied on the substrate, to form a cured epoxy-based coating. In some embodiments, the epoxy-based coating is formed on the primer coating. When a primer coating is used, the primer must be compatible with the curing composition, such that the cured coating will adhere to the primer. In some embodiments, the primer is also epoxy-based. In other embodiments, the epoxy-based coating is formed on the substrate. In some embodiments, in particular those in which a sensor for use in a wet environment is the substrate to be coated, the curing composition is directly applied on the substrate (for example, sensor) without an intervening primer coating or tie coat. Once formed on the substrate, the cured epoxy-based coating is the top coating (for example, the cured coating is in direct contact with the environment). In some embodiments, a curing composition of the present disclosure may be applied to a substrate according to one or more of the following standards or acts: SSPC-SP-1, SSPC-SP-11, SSPC-SP-5, SSPC-SP WJ-1/NACE WJ-1, SSPC-SP WJ-2/NACE WJ-2, SSPC-SP WJ-3/NACE WJ-3, SSPC-SP WJ-4/NACE WJ-4, SSPC-VIS-3, SSPC-VIS-4, SSPC-PA-2 LEVEL 3, SSPC-GUIDE 15, SSPC-GUIDE 6, NACE RPO 287-95, ASTM D-4285, Occupational Safety And Health (Part 11, Canada Labour Code; Policy Volume Of The Tb Manual); Canadian Environmental Protection Act, and Canadian Fishery Act.

In some embodiments, the optional primer coating is an epoxy primer. Epoxy primers are generally applied to protect the surface of the substrate. Some epoxy primers are designed to prevent osmosis of water to the surface of the substrate; for example, for steel and fiberglass. Some epoxy primers may also provide some measure of protection against corrosion. Finally, such primers may add base strength in case top layers of the coating are damaged. Many epoxy primer coatings are commercially available. Non-limiting examples of primer coatings include Intershield® 300 sold by International®, Amercoat® 235 sold by PPG®, Recoatable Epoxy Primer sold by Sherwin Williams® and Jotamastic® 80 sold by Jotun®. Intershield® 300 is a pure epoxy coating sold for use as a universal primer. Amercoat® 235 is a two-component, multi-purpose phenalkamine epoxy. Recoatable Epoxy Primer by Sherwin Williams® is a catalyzed polyamide/bisphenol A epoxy primer designed for fast dry and quick or extended recoatability. Jotamastic® 80 is a two-component polyamine cured epoxy mastic coating that is a surface tolerant, high solids product.

In some embodiments of the present disclosure, the curing composition is applied uncured (or partially cured) to a substrate, and is then allowed to cure via reaction with a hardener to form the cured epoxy-based coating. The curing composition can be applied to the substrate by a variety of coating techniques, including painting, brushing, spraying, rolling, or dipping the composition on the substrate. The cured epoxy-based coatings formed from the curing composition can be from about 1 μm to about 400 μm in thickness, preferably from about 100 μm to about 200 μm in thickness.

Compositions for a Coating, and Coatings thereof

As described above, one or more embodiments of the present disclosure attempts to provide a pre-cured composition that can be used to form an epoxy-based coating that exhibits anti-fouling/foul-releasing properties, improved corrosion resistance, increased mechanical strength, bending strength of at least 10 mm, reduced amine blushing, reduced amine blooming, reduced porosity, reduced coefficient of friction, reduced wet coefficient of friction, or exhibited curing at lower temperatures (relative to a control coating).

In one or more embodiments, the hydrophobicity-modifying additive is included in the pre-cured composition to provide the epoxy-based coating with antifouling/foul-releasing properties. In some embodiments, the hydrophobicity-modifying is included in an amount sufficient to provide an epoxy-based coating having a contact angle of at least 90° (when measured with an Ossila Goniometer following ASTM D7334-08(2013); relative to a control coating). In some embodiments, the hydrophobicity-modifying additive is included in an amount sufficient for the cured epoxy-based coatings to have a contact angle of about 90° to about 130°, or about 90° to about 120°, about 95° to about 120°, about 100° to about 120°, or about 100° to about 115°, or about 110°, or about 120°, or at any range between about 90° and about 130°.

In one or more embodiments, the wear-inhibiting additive is included in the pre-cured composition to provide the epoxy-based coating with improved corrosion resistance, increased mechanical strength, or bending strength of at least 10 mm (relative to a control coating). In some embodiments, the wear-inhibiting additive is included in the pre-cured composition to provide an epoxy-based coating that exhibits reduced coefficient of friction (relative to a control coating). In some embodiments, the wear-inhibiting additive is included in an amount sufficient to provide a coating having improved corrosion resistance of at least 1000 hours when measured by salt fog resistance, an increased mechanical strength with a D-shore hardness of at least 30D or at least 40D, or a bending strength of at least 10 mm when measured by a cylindrical bed test. In some embodiments, the wear-inhibiting additive is included in an amount sufficient to provide cured epoxy-based coatings having improved corrosion resistance of about 1500 hours to about 8500 hours, or about 4000 hours to about 7000 hours when measured by salt fog resistance; or an increased mechanical strength with a D-shore hardness of about 65D to about 90D; or about 65D to about 85D; or about 70D to about 80D, or at any D-shore hardness between about 30D and about 90D. In some embodiments the wear-inhibiting additive is included in an amount sufficient to provide cured epoxy-based coatings having a coefficient of friction of <0.3 (for example, a coefficient of friction of about 0.1, indicating <10% force lost to friction). In some embodiments, such a reduced coefficient of friction is advantageous in wet environments, and in particular, in applications in which the aero/hydrodynamic performance of the coated piece is of import. In other embodiments, a reduced coefficient of friction may facilitate achieving higher speeds, decreased fuel consumption, or higher efficiencies in an application.

In one or more embodiments, the amphiphilicity-modifying is included in the pre-cured composition to provide the epoxy-based coating with a reduced wet coefficient of friction (WCOF) and/or improved antifouling/foul-releasing properties. In some embodiments, the amphiphilicity-modifying is included in an amount sufficient to provide a coating having a wet coefficient of friction of ≤0.4 or ≤0.3 when measured using an ASM 925 COF meter (American Slipmeter) following ASTM D2047. In some embodiments, the amphiphilicity-modifying is included in an amount sufficient to provide a coating having a wet coefficient of friction of ≤0.2 when measured using an ASM 925 COF meter (American Slipmeter) following ASTM D2047. In some embodiments, the amphiphilicity-modifying additives are included in an amount sufficient to provide a coating having a wet coefficient of friction of from about 0.05 to about 0.4, or about 0.05 to about 0.3, or about 0.05 to about 0.2; or about 0.05 to about 0.15; or about 0.06 to about 0.11; or about 0.08 to about 0.12; or at any range between about 0.05 and about 0.4. In some embodiments, such a wet coefficient of friction is advantageous in wet environments, and in particular, in applications in which the aero/hydrodynamic performance of the coated piece is of importance. In other embodiments, such a wet coefficient of friction may improve the antifouling/foul-releasing properties of the epoxy-based coating into which they've been incorporated, for example, by resisting and/or reducing fouling attachment, and/or reducing adhesion strength of fouling organisms.

In one or more embodiments, the curing catalyst is included in the pre-cured composition such that the pre-cured composition can be cured at lower temperatures to form an epoxy-based coating. In some embodiments, the curing catalyst is included in an amount sufficient to catalyze curing the pre-cured composition at lower temperatures of, for example, about −5° C. to about 0° C.

In one or more embodiments, the hardener that is added to the pre-cured composition to form the epoxy-based coating is selected such that the degree of crosslinking that occurs during the curing of the pre-cured composition is about 60% to about 99%, or about 70% to about 99%, or about 80% to about 99%, or about 90% to about 99%, or about 99%. In some embodiments, the cured epoxy-based coating exhibits reduced porosity, amine blushing, and/or amine blooming.

In one or more embodiments of the present disclosure, the pre-cured and curing compositions are solventborne compositions. Solventborne compositions are essentially, or substantially anhydrous compositions. While some additives of solventborne compositions may contain some amount of water/aqueous solution, because those additives are not the main film-forming component, the amount of water they would introduce would not be sufficient to render the composition a waterborne composition. In contrast, waterborne compositions are aqueous compositions. Curing solvent-borne compositions involves a polymerization and/or crosslinking reaction to form an infusible, insoluble polymer network. In contrast, curing waterborne compositions tends to be technically challenging. Generally, the composition cures without a polymerization and/or crosslinking reaction; instead, another mechanism of physical polymer merging occurs to form a cured coating. As a result, cured coatings formed from waterborne compositions are not suitable for use in wet environments; the lack of an infusible, insoluble polymer network results in the coating peeling, bubbling, or otherwise losing adherence to the surface or substrate to which the waterborne composition was applied.

In one or more embodiments of the present disclosure, the cured epoxy-based coating exhibits anti-fouling/foul-releasing properties, improved corrosion resistance, increased mechanical strength, bending strength of at least 10 mm, a wet coefficient of friction ≤0.2, reduced amine blushing, reduced amine blooming, or reduced porosity in the absence of primer coatings, tie coatings, and/or functional top-coatings. In some embodiments, the cured epoxy-based coatings adhere to a substrate in the absence of primer coatings. Commercial coatings generally use primer coatings, tie coatings, and/or functional top-coatings that add multiple layers to a general coating, which may increase drying time, for example, up to 1 to 3 days, relative to a general coating that does not use primer coatings, tie coatings, and/or functional top-coatings. Generally, it takes one day per coating layer for the full coating to dry. Commercial foul-releasing/anti-fouling coatings require 5 coating layers (two primer layers, one tie layer, two top coating layers), and thus require 5 days to dry. In contrast, the cure epoxy-based coatings described herein can dry in about 2 to 3 days, as opposed to up to 5 days, when used in the absence of primer coatings, tie coatings, and/or functional top-coatings.

In one or more embodiments of the present disclosure, the pre-cured composition excludes environmentally persistent materials or components, such as fluoro-based components and VOCs. In some embodiments, excluding environmentally persistent materials or components reduces environmental impact of the cured epoxy-based coating. In some embodiments, the cured epoxy-based coating does not leach or off-gas environmentally harmful (for example, toxic) substances/components into the environment, such as copper and copper-based compounds, heavy metals such as lead or arsenic, tributyl tin, silicone oils, or greenhouse gasses. In further embodiments, the cured epoxy-based coating does not leach micro-plastics into the environment.

In one or more embodiments of the present disclosure, due to their improved properties (for example, mechanical strength, hardness, anti-fouling/foul-releasing properties, etc.), the cured epoxy-based coatings described herein can last as a functional coating on a substrate for about 5 to about 8 years; in contrast, commercial coatings do not tend to last more than 3 to 4 years. In some embodiments, the cured epoxy-based coatings described herein do not deteriorate when subject to SSPC-1 solvent cleaning, contrary to some commercial coatings. In some embodiments, due to their improved properties (for example, mechanical strength, hardness, anti-fouling/foul-releasing properties, etc.), the cured epoxy-based coatings described herein have a surface roughness down to about 0.01 μm; this improves surface flow (for example, reduces drag when moving through a wet environment) and anti-fouling/foul-releasing properties. In some embodiments, due to their improved properties (for example, mechanical strength, hardness, etc.), the cured epoxy-based coatings described herein can resist scratching at least when manually scratched using a screwdriver at 45° with 5 kg of force. In further embodiments, the cured epoxy-based coatings described herein maintain their flexibility in view of their improved mechanical strength/hardness.

In one or more embodiments of the present disclosure, due to their improved properties (for example, mechanical strength, hardness, anti-fouling/foul-releasing properties, etc.), the cured epoxy-based coatings described herein may provide a coating that combines the benefits of ultra-hard coatings with soft-foul release products. The epoxy-based coatings of the present disclosure may allow ship-owners to enjoy the benefits of a hard cleanable surface while obtaining fuel savings from its foul release properties without leaching biocides or silicone oils. In some embodiments of the present disclosure, due to their improved properties (for example, mechanical strength, hardness, anti-fouling/foul-releasing properties, etc.), the cured epoxy-based coatings described herein may provide a coating that can be cleaned by most hull grooming methods and water jet pressures. In some embodiments, the benefits of epoxy-based coatings of the present disclosure are in part due to the use of graphene as a nano-scale armouring additive. As described above, graphene is known for its high mechanical strength, ultra-low friction, and incredible toughness.

In one or more embodiments of the present disclosure, the cured epoxy-based coatings described herein do not comprise, or are free of a reaction product formed from epoxy-functional elastomeric monomers, pre-polymers, or resins. In one or more embodiments, the cured epoxy-based coatings described herein do not comprise, or are free of a reaction product formed from epoxy-functional elastomeric monomers, pre-polymers, or resins that comprise, or consist essentially of butenes, polybutenes, butadienes, polybutadienes, nitrites acrylonitiriles, polysulfides, urethanes, urethane-modified resins (for example, urethane-modified epoxy resins), or co-polymers thereof, or combinations thereof.

In one or more aspects of the present disclosure, there is a composition for a coating, comprising: epoxy-functional monomers; a diluent; and a sufficient amount of an amphiphilicity-modifying additive to provide a coating formed from the composition having a wet coefficient of friction of ≤0.4, ≤0.3, or ≤0.2 when measured using an ASM 925 COF meter (American Slipmeter) following ASTM D2047. In one or more embodiments, the sufficient amount of the amphiphilicity-modifying additive provides a coating formed from the composition having a wet coefficient of friction when measured using an ASM 925 COF meter following ASTM D2047 of about 0.05 to about 0.4; or 0.05 to about 0.3; or about 0.05 to about 0.2; or about 0.05 to about 0.15; or about 0.06 to about 0.11; or about 0.08 to about 0.12, or at any range between about 0.05 and about 0.4. In one or more embodiments, the composition further comprises a sufficient amount of a hydrophobicity-modifying additive that is reactive in an epoxide polymerization to provide a coating formed from the composition having a contact angle of at least 90° when measured with an Ossila Goniometer following ASTM D7334-08(2013). In one or more embodiments, the sufficient amount of the hydrophobicity-modifying additive provides a coating formed from the composition having a contact angle of about 90° to about 130°, or about 90° to about 120°, about 95° to about 120°, about 100° to about 120°, or about 100° to about 115°, or at any range between about 90° and about 130°. In one or more embodiments, the composition further comprises a sufficient amount of a wear-inhibiting additive to provide a coating formed from the composition having improved corrosion resistance of at least 1000 hours when measured by salt fog resistance, an increased mechanical strength with a D-shore hardness of at least 30D, or at least 40D, or a bending strength of at least 10 mm when measured by a cylindrical bed test. In one or more embodiments, the sufficient amount of the wear-inhibiting additive provides a coating formed from the composition having improved corrosion resistance of about 1500 hours to about 8500 hours, or about 4000 hours to about 7000 hours when measured by salt fog resistance; or an increased mechanical strength with a D-shore hardness of about 65D to about 90D, or about 65D to about 85D; or about 70D to about 80D, or at any D-shore hardness between about 30D and about 90D. In one or more embodiments, the composition further comprises at least one dispersant for dispersing the wear-inhibiting additive in the composition; at least one defoamer; and/or at least one rheological additive. In one or more embodiments, the composition further comprises a hardener, the hardener being reactive in curing the composition to form a coating. In one or more embodiments, the hardener further comprises a curing catalyst. In one or more embodiments, the composition is a solvent-borne composition.

In one or more aspects of the present disclosure, there is an additives composition for use in forming a coating, the composition comprising a sufficient amount of an amphiphilicity-modifying additive to provide a coating formed from the composition having a wet coefficient of friction of ≤0.4 or ≤0.2 when measured using an ASM 925 COF meter following ASTM D2047; and a sufficient amount of a hydrophobicity-modifying additive that is reactive in an epoxide polymerization for forming a coating having a contact angle of at least 90° when measured with an Ossila Goniometer following ASTM D7334-08(2013), and/or a sufficient amount of a wear-inhibiting additive for forming a coating having improved corrosion resistance of at least 1000 hours when measured by salt fog resistance, an increased mechanical strength with a D-shore hardness of at least 30D, or at least 40D, or a bending strength of at least 10 mm when measured by a cylindrical bed test. In one or more embodiments, the additives composition further comprises at least one dispersant for dispersing the wear-inhibiting additive in the composition; at least one defoamer; and/or at least one rheological additive. In one or more aspects of the present disclosure, there is a kit comprising the additives composition and instructions for adding said additives to a composition for a coating. In one or more embodiments, the additives are added to one or more of the compositions for a coating as described herein.

In one or more aspects of the present disclosure, there is a method of forming a composition for a coating, comprising: mixing an amphiphilicity-modifying additive into a first mixture comprising epoxy-functional monomers and a diluent; and forming the composition for a coating. In one or more embodiments, the method further comprises mixing a wear-inhibiting additive and a dispersant into the first mixture. In one or more embodiments, the method further comprises mixing an hydrophobicity-modifying additive into the first mixture. In one or more embodiments, the method further comprises mixing a rheological additive into the first mixture. In one or more embodiments, the method further comprises mixing a defoamer additive into the first mixture.

In any one or more of the foregoing aspects and corresponding embodiments, the epoxy-functional monomers comprise bisphenol diglycidyl ethers; epoxy-functional epoxide-siloxane monomers; a reaction product of epichlorohydrin and one or more of hydroxyl-functional aromatics, alcohols, thiols, acids, acid anhydrides, cycloaliphatics and aliphatics, polyfunctional amines, and amine functional aromatics; a reaction product of the oxidation of unsaturated cycloaliphatics; or a combination thereof. In any one or more of the foregoing aspects and corresponding embodiments, the epoxy-functional monomers comprise bisphenol diglycidyl ethers; epoxy-functional epoxide-siloxane monomers, or a combination thereof. In some embodiments, the bisphenol diglycidyl ethers are derived from bisphenol A, bisphenol F, bisphenol S, or a combination thereof. In some embodiments, the epoxy-functional monomers comprise an epoxy-functional epoxide-siloxane monomer; for example, wherein the epoxy-functional epoxide-siloxane monomer comprises an epoxide backbone or polyether backbone comprising siloxane or polysiloxane side-chains. In some embodiments, the siloxane or polysiloxane side-chains are linear, branched, or crosslinked. In some embodiments, at least one of the siloxane or polysiloxane side-chain is a cross-linked silicone resin. In some embodiments, the epoxy-functional epoxide-siloxane monomer comprises a reaction product of isocyanate and/or polyurethane oligomers, silane oligomers, and epoxy oligomers. In some embodiments, the epoxy-functional epoxide-siloxane monomer comprises an epoxy-functional epoxide-siloxane pre-polymer. In some embodiments, the epoxy-functional epoxide-siloxane monomer comprises 3-ethylcyclohexylepoxy copolymer modified with dimethylsiloxane side-chains, epoxy bisphenol A (2,2-Bis(4′-glycidyloxyphenyl)propane) modified with the poly-dimethylsiloxane side-chains, a siloxane modified hybrid epoxy resin, a siliconeepoxide resin, an epoxy-functional epoxide-backbone functionalized with a crosslinked silicone resin comprising terminal alkoxy groups, or a combination thereof; and/or comprises Silikopon® ED, Silikopon® EF, EPOSIL Resin 5550®, or a combination thereof.

In any one or more of the foregoing aspects and corresponding embodiments, the diluent comprises a reactive diluent that is reactive in an epoxide polymerization, a non-reactive diluent, or a combination thereof. In some embodiments, the reactive diluent comprises poly[(phenyl glycidyl ether)-co-formaldehyde], alkyl (C12-C14) glycidyl ether, phenyl glycidyl ether, butyl glycidyl ether, 2-ethylhexyl glycidyl ether, o-cresol glycidyl ether, cycloaliphatic glycidyl ether, dipropylene glycol n-propyl ether, dipropylene glycol dimethyl ether, or a combination thereof. In some embodiments, reactive diluent comprises the hydrophobicity-modifying additive. In some embodiments, the diluent is reactive as a curing catalyst. In some embodiments, the non-reactive diluent comprises xylene, methyl acetate, methyl ethyl ketone, nonyl phenol, cyclohexanedimethanol, n-butyl alcohol, benzyl alcohol, isopropyl alcohol, propylene glycol, phenol, or a combination thereof.

In any one or more of the foregoing aspects and corresponding embodiments, the hydrophobicity-modifying additive comprises at least one Si-based additive, at least one fluoro-based additive, at least one maleimide-based additive, or a combination thereof. In some embodiments, the hydrophobicity-modifying additive comprises a bis-maleimide oligomer, an epoxy-functional silane, an epoxy-functional polydialkylsiloxane, or a combination thereof. In some embodiments, the bis-maleimide oligomer comprises BMI 689, BMI 737, BMI 1100, BMI 1400, BMI 1500, BMI 1700, or a combination thereof; for example, in a range of about 10 wt % to about 20 wt %. In some embodiments, the epoxy-functional silane comprises glycidoxypropyltrimethoxysilane; for example, a range of about 0 wt % to about 6 wt %, or in a range of about 1 wt % to about 2 wt %. In some embodiments, the epoxy-functional polydialkylsiloxane comprises epoxy-functional polydimethylsiloxane; for example, in a range of about 0.05 wt % to about 10 wt %, or in a range of about 0.5 wt % to about 8 wt %. In some embodiments, the at least one fluoro-based additive comprises poly(3,3,3-trifluoropropylmethylsiloxane), a fluoroalkylated acrylate oligomer (for example, Sartomer® CN4002), or a combination thereof; for example, in a range of about 0.05 wt % to about 5 wt %, or about 0.05 wt % to about 3 wt. In any one or more of the foregoing aspects and corresponding embodiments, the sufficient amount of the hydrophobicity-modifying additive provides a coating formed from the composition having a contact angle of about 90° to about 130°, or about 90° to about 120°, or about 950 to about 120°, or about 100° to about 120°, or about 100° to about 115°, or at any range between about 90° and about 130°.

In any one or more of the foregoing aspects and corresponding embodiments, the wear-inhibiting additive comprises unmodified graphene nanoplatelets, unmodified graphite flakes, carbon black, fullerene, titanium dioxide, aluminum oxide, Ca magnesium silicate, zinc oxide, or a combination thereof. In some embodiments, the unmodified graphene nanoplatelets have a flake size of at least 3 μm; or about 3 μm to about 50 μm; or about 5 μm to about 10 μm. In some embodiments, the unmodified graphene nanoplatelets are present in a range of about 0.05 wt % to about 5 wt %; or about 0.3 wt %. In some embodiments, the unmodified graphite flakes have a flake size of at least 3 μm; or about 3 μm to about 50 μm; or about 10 μm to about 20 μm. In some embodiments, the unmodified graphite flakes are present in a range of about 0.1 wt % to about 10 wt %; or about 5 wt %. In some embodiments, the titanium dioxide, aluminum oxide, or Ca magnesium silicate, or combination thereof are present in a range of about 5 wt % to about 30 wt %; or about 10 wt % to about 25 wt %; or about 5 wt % to about 10 wt %. In any one or more of the foregoing aspects and embodiments, the sufficient amount of the wear-inhibiting additive provides a coating formed from the composition having improved corrosion resistance of about 1500 hours to about 8500 hours, or about 4000 hours to about 7000 hours when measured by salt fog resistance; or an increased mechanical strength with a D-shore hardness of about 65D to about 90D, or about 65D to about 85D; or about 70D to about 80D, or at any D-shore hardness between about 30D and about 90D.

In any one or more of the foregoing aspects and corresponding embodiments, the amphiphilicity-modifying additive comprises a polyether, a polysiloxane, a polyelectrolyte, a polyatomic alcohol, or a combination thereof. In some embodiments, the polyether comprises a polyalkylene glycol; for example, in a range of about 0.5 wt % to about 10 wt %, or about 1 wt % to about 5 wt %. In some embodiments, the polyalkylene glycol comprises polyethylene glycol, polyethylene glycol 400, LIPOXOL® 400, or a combination thereof. In some embodiments, the polysiloxane comprises a hydroxyl-functionalized polysiloxane, a hydroxyalkyl-functionalized polysiloxane, a fluorohydroxyalkyl-functionalized polysiloxane, or a combination thereof; for example, in a range of about 1 wt % to about 20 wt %, or about 5 wt % to about 15 wt %. In some embodiments, the polysiloxane comprises Silmer® OHT Di-10, Silmer® OHT Di-50, Silmer® OHT Di-100, Silmer® OHFB10, or a combination thereof. In some embodiments, the polyelectrolyte comprises an ammonium-functionalized polysiloxane, such as a dialkyl quaternary ammonium modified-polysiloxane, for example in a range of about 0.5 wt % to about 10 wt %, or about 1 wt % to about 5 wt %. In some embodiments, the polyelectrolyte comprises Silquat®3180. In some embodiments, the polyatomic alcohol comprises glycerol, for example, in a range of about 0.5 wt % to about 10 wt %, or about 1 wt % to about 5 wt %. In any one or more of the foregoing aspects and embodiments, the sufficient amount of the amphiphilicity-modifying additive provides a coating formed from the composition having a wet coefficient of friction when measured using an ASM 925 COF meter following ASTM D2047 of about 0.05 to about 0.2; or about 0.05 to about 0.15; or about 0.06 to about 0.11; or about 0.08 to about 0.12.

In any one or more of the foregoing aspects and corresponding embodiments, the at least one dispersant is a polymeric dispersant. In some embodiments, the polymeric dispersant is Additol VXW 6208, Soldplus D610, K-Sperse A504, or a combination thereof; for example, in a range of about 0.1 wt % to about 5 wt %. In any one or more of the foregoing aspects and embodiments, the defoamer comprises a silicone-modified defoamer. In some embodiments, the silicone-modified defoamer comprises Additol VXW 6210N, BYK-A 530, Tego Airex 900® or a combination thereof. In some embodiments, the silicone-modified defoamer comprises Additol VXW 6210N; for example, in a range of about 0.5 wt % to about 6 wt %. In some embodiments, the silicone-modified defoamer comprises Tego Airex 900®; for example, in a range of about 0.05 wt % to about 2 wt %. In any one or more of the foregoing aspects and corresponding embodiments, the at least one rheological additive comprises a fumed silica, a castor oil derivative, a clay, or a combination thereof. In some embodiments, the at least one rheological additive comprises a fumed silica, a castor oil derivative; bentonite, montmorillonite, a modified montmorillonite clay; or a combination thereof; for example, in a range of about 0.01 wt % to about 3 wt %. In some examples, the castor oil derivative is Thixatrol ST® and the modified montmorillonite clay is Claytone HY®.

Any one or more of the foregoing aspects and corresponding embodiments further comprises a hardener, the hardener being reactive in curing the composition to form a coating. In some embodiments, the hardener comprises an amine hardener, an amide hardener, or a combination thereof. In some embodiments, the hardener comprises an silamine hardener, such as aminopropyltriethoxysilane (Andisil 1100), bis(3-triethoxysilylpropyl)amine (Dynasylan 1146), or N-2-aminoethyl-3-aminopropyltrimethoxysilane (Dynasylan DAMO), or a combination thereof. In some embodiments, the hardener comprises a low-temperature hardener, such as phenalkamine. In some embodiments, the hardener further comprises a curing catalyst, such as 2,4,6-tris[(dimethyllamino)methyl]phenol, benzyl dimethylamine (BDMA), imidazole, N,N-di-(2-hydroxyethyl)aniline, 2,4,6-tris[(dimethyllamino)methyl]phenol, triethanolamine, or a combination thereof. In some embodiments, the curing catalyst comprises a low-temperature curing catalyst, such as 2,4,6-tris[(dimethyllamino)methyl]phenol.

In one or more of the foregoing aspects and corresponding embodiments, the composition for a coating may be used for forming a coating on a substrate. In some embodiments, the substrate is for use in a wet environment. In some embodiments, the substrate is a marine vessel (for example, a boat, or a ship), or marine equipment.

In one or more of the foregoing aspects and corresponding embodiments, the composition for a coating is a solvent-borne composition. In one or more of the foregoing aspects and embodiments, the composition is free of elastomeric monomers, pre-polymers, or resins; and/or epoxy-functional elastomeric monomers, pre-polymers, or resins. In one or more of the foregoing aspects and corresponding embodiments, the composition is free of elastomeric monomers, pre-polymers, or resins, and/or epoxy-functional elastomeric monomers, pre-polymers, or resins that comprise, or consist essentially of butenes, polybutenes, butadienes, polybutadienes, nitrites acrylonitiriles, polysulfides, urethanes, urethane-modified resins (for example, urethane-modified epoxy resins), or combinations thereof.

In one or more aspects of the present disclosure, there is a composition for a coating comprising, consisting essentially of, or consisting of: epoxy-functional monomers; a diluent; a sufficient amount of a hydrophobicity-modifying additive that is reactive in an epoxide polymerization to provide a coating formed from the composition having a contact angle of at least 90° when measured with an Ossila Goniometer following ASTM D7334-08(2013); a sufficient amount of a wear-inhibiting additive to provide a coating formed from the composition having improved corrosion resistance of at least 1000 hours when measured by salt fog resistance, an increased mechanical strength with a D-shore hardness of at least 30D or at least 40D, or a bending strength of at least 10 mm when measured by a cylindrical bed test; at least one dispersant for dispersing the wear-inhibiting additive in the composition; and at least one defoamer. In some embodiments, the composition further comprises, consists essentially of, or consists of at least one rheological additive. In one or more embodiments, the composition further comprises a hardener, the hardener being reactive in curing the composition to form a coating. In one or more embodiments, the hardener further comprises a curing catalyst.

In one or more aspects of the present disclosure, there is a composition for a coating comprising, consisting essentially of, or consisting of: epoxy-functional monomers; a diluent; a sufficient amount of an amphiphilicity-modifying additive to provide a coating formed from the composition having a wet coefficient of friction of ≤0.4 or ≤0.2 when measured using an ASM 925 COF meter (American Slipmeter) following ASTM D2047; a sufficient amount of a hydrophobicity-modifying additive that is reactive in an epoxide polymerization to provide a coating formed from the composition having a contact angle of at least 90° when measured with an Ossila Goniometer following ASTM D7334-08(2013); a sufficient amount of a wear-inhibiting additive to provide a coating formed from the composition having improved corrosion resistance of at least 1000 hours when measured by salt fog resistance, an increased mechanical strength with a D-shore hardness of at least 30D or at least 40D, or a bending strength of at least 10 mm when measured by a cylindrical bed test; at least one dispersant for dispersing the wear-inhibiting additive in the composition; and at least one defoamer; and at least one rheological additive. In one or more embodiments, the composition further comprises a hardener, the hardener being reactive in curing the composition to form a coating. In one or more embodiments, the hardener further comprises a curing catalyst.

To gain a better understanding of the invention described herein, the following examples are set forth. It should be understood, that these examples are for illustrative purposes only. Therefore, they should not limit the scope of this invention in any way.

### Examples

### Example 1—Compositions for a Coating (Compositions, Sometimes Referred to as Formulations) and Measured Coating Properties

Epoxy-Functional Monomers Tested:
1. Epoxy Bisphenol A (2,2-Bis(4′-glycidyloxyphenyl)propane)
2. Propane, 2,2-bis[p-(2,3-epoxypropoxy)phenyl]-, polymers (a pre-polymer)
3. Silikopon ED by Evonik GmbH

Reactive Diluents Tested:
1. Formaldehyde glycidyl ether (aka poly[(phenyl glycidyl ether)-co-formaldehyde], phenol-formaldehyde polymer glycidyl ether)
2. Alkyl Glycidyl Ether
3. Phenol Glycidyl Ether
4. Butyl Glycidyl Ether
5. 2-ethylhexyl Glycidyl Ether
6. O-cresol glycidyl ether
7. Cycloaliphatic Glycidyl Ether

Non-Reactive Diluents Tested:
1. Phenol Alcohol
2. Xylene
3. Nonyl phenol
4. Cyclohexane dimethanol
5. N butyl Alcohol
6. Benzil Alcohol
7. Phenol Alcohol
8. Methyl Acetate
9. Propylene glycol

Hardeners Tested:
1. Polyamine
2. Polyamide
3. Triethylenetetramine with phenol and formaldehyde/polyethylenepolyamines
4. Phenalkamine
5. Triethylenetetramine/Polyoxypropylenediamine
6. Polyether Amine
7. Phenalkamine+Polyamide

Performance Additives Tested:

| Performance Additives | Amount tested | |
|---|---|---|
| Graphite Flakes | 0.1-10 | wt % |
| Graphene nanoplatelets | 0.05-5 | wt % |
| Modified acrylic copolymer in water-based solution | 0-5 | wt % |
| (ADDITOL VXW 6208) | | |
| Silicone glycol modified liquid hydrocarbons (ADDITOL | 0-5 | wt % |
| VXW 6210N) | | |
| Epoxy-functional Polydimethylsiloxane (BYK-Silclean | 0.05-10 | wt % |
| 3701) | | |
| Canola oil | 0-10 | wt % |
| Glycidoxypropyltrimethoxysilane (Epoxy functional | 0.05-6 | wt % |
| silane) (Andisil 187 Silane) | | |
| Polyethylene glycol (LIPOXOL 400, Sasol), Mw 400 | 1.0-5.0 | wt % |
| g/mol | | |
| Fluoroalkylated acrylate oligomer (Sartomer CN4002) | 0.05-3 | wt % |
| Hydroxyalkyl-modified polydimethylsiloxane oligomer | 3-12% | |
| (Silmer OFT Di-50) | | |
| Fluorohydroxylalkylated dimethyl siloxane oligomer | 0.05-6 | wt % |
| (Silmer OHFB10) | | |
| Quaternary ammonium-modified dimethyl siloxane | 0.05-5 | wt % |
| oligomer (Silquat 3180) | | |
| Organo-modified siloxane containing fumed silica (Tego | 0.05-2.0 | wt % |
| Airex 900) | | |
| Organo-modified derivative of castor oil (Thixatrol ST) | 0.05-1.0 | wt % |

| | |
|---|---|
| Modified montmorillonite clay (Claytone HY ®) | 0.5-3% |
| Bentonite clay | 0.5-3% |

“Base Line” Formulations Tested:

| # | Epoxy-functional Monomers | Diluent | Hardener |
|---|---|---|---|
| 1 | Propane, 2,2-bis[p-(2,3- | Benzyl alcohol/ | Triethylenetetramine/ |
| | epoxypropoxy)phenyl]-, pre- | Formaldehyde | Polyoxypropylenediamine |
| | polymers | glycidil ether | |
| 2 | Propane, 2,2-bis[p-(2,3- | Benzyl alcohol/ | Triethylenetetramine with |
| | epoxypropoxy)phenyl]-, pre- | Formaldehyde | phenol and formaldehyde/ |
| | polymers | glycidil ether | Polyethylenepolyamines |
| 3 | Propane, 2,2-bis[p-(2,3- | Alkyl Glycidyl Ether | Phenalkamine |
| | epoxypropoxy)phenyl]-, pre- | | |
| | polymers | | |
| 4 | Propane, 2,2-bis[p-(2,3- | Alkyl Glycidyl Ether | Polyamine |
| | epoxypropoxy)phenyl]-, pre- | | |
| | polymers | | |
| 5 | Propane, 2,2-bis[p-(2,3- | Alkyl Glycidyl Ether | Phenalkamine/Polyamine |
| | epoxypropoxy)phenyl]-, pre- | | |
| | polymers | | |
| 200-Si | Silikopon ED | Methyl Acetate, | Aminopropyltriethoxysilane |
| | | Xylene | |

“Base line” Formulation #1 tested with Graphene nanoplatelets (GNP) or Graphite flakes; and “Base line” Formulation #200-Si tested with Titanium Dioxide (wear-in hi biting additives)

| # | Wear-inhibiting additive | Amount (wt %) |
|---|---|---|
| 6 | Graphene nanoplatelets | 0.1 |
| 7 | Graphene nanoplatelets | 0.2 |
| 8 | Graphene nanoplatelets | 0.3 |
| 9 | Graphene nanoplatelets | 0.4 |
| 10 | Graphene nanoplatelets | 0.5 |
| 11 | Graphene nanoplatelets | 0.6 |
| 12 | Graphene nanoplatelets | 0.7 |
| 13 | Graphene nanoplatelets | 0.8 |
| 14 | Graphene nanoplatelets | 1 |
| 15 | Graphene nanoplatelets | 4 |
| 16 | Graphene nanoplatelets | 5 |
| 17 | Graphite Flakes | 0.5 |
| 18 | Graphite Flakes | 1.16 |
| 19 | Graphite Flakes | 3.08 |
| 20 | Graphite Flakes | 5.08 |
| 21 | Graphite Flakes | 8.128 |
| 22 | Graphite Flakes | 10.16 |
| 201-Si | Titanium Dioxide | 10 |
| 202-Si | Titanium Dioxide | 17 |
| 203-Si | Titanium Dioxide | 25 |

“Base line” Formulation #1 tested with Performance additives (23 to 50; 100-BMI to 114-BMI); “Base line” Formulation #3 tested with Performance additives (51); and Base line” Formulation #200-Si tested with Performance additives (204-Si 210-Si)

| | | Amount |
|---|---|---|
| # | Performance additives | (wt %) |
| 23 | 1. Graphene nanoplatelets | 1) 0.3 |
| | 2. Graphite Flakes | 2) 5.08 |
| | 3. Additol VXW 6208 | 3) 1 |
| 24 | 1. Graphene nanoplatelets | 1) 0.3 |
| | 2. Graphite Flakes | 2) 5.08 |
| | 3. Additol VXW 6208 | 3) 2 |
| 25 | 1. Graphene nanoplatelets | 1) 0.3 |
| | 2. Graphite Flakes | 2) 5.08 |
| | 3. Additol VXW 6208 | 3) 3 |
| 26 | 1. Graphene nanoplatelets | 1) 0.3 |
| | 2. Graphite Flakes | 2) 5.08 |
| | 3. Additol VXW 6208 | 3) 4 |
| 27 | 1. Graphene nanoplatelets | 1) 0.3 |
| | 2. Graphite Flakes | 2) 5.08 |
| | 3. Additol VXW 6208 | 3. 5 |
| 28 | 1. Graphene nanoplatelets | 1. 0.3 |
| | 2. Graphite Flakes | 2. 5.08 |
| | 3. ADDITOL VXW 6210N | 3) 1 |
| 29 | 1. Graphene nanoplatelets | 1) 0.3 |
| | 2. Graphite Flakes | 2) 5.08 |
| | 3. ADDITOL VXW 6210N | 3) 2 |
| 30 | 1. Graphene nanoplatelets | 1) 0.3 |
| | 2. Graphite Flakes | 2) 5.08 |
| | 3. ADDITOL VXW 6210N | 3) 3 |
| 31 | 1. Graphene nanoplatelets | 1) 0.3 |
| | 2. Graphite Flakes | 2) 5.08 |
| | 3. ADDITOL VXW 6210N | 3) 4 |
| 32 | 1. Graphene nanoplatelets | 1) 0.3 |
| | 2. Graphite Flakes | 2) 5.08 |
| | 3. ADDITOL VXW 6210N | 3) 5 |
| 33 | 1. Graphene nanoplatelets | 1) 0.3 |
| | 2. Graphite Flakes | 2) 5.08 |
| | 3. Additol VXW 6208 | 3) 2.1 |
| | 4. ADDITOL VXW 6210N | 4) 5.4 |
| 34 | 1. Graphene nanoplatelets | 1) 0.3 |
| | 2. Graphite Flakes | 2) 5.08 |
| | 3. Additol VXW 6208 | 3) 2.1 |
| | 4. ADDITOL VXW 6210N | 4) 5.4 |
| | 5. Canola oil | 5) 1 |
| 35 | 1. Graphene nanoplatelets | 1) 0.3 |
| | 2. Graphite Flakes | 2) 5.08 |
| | 3. Additol VXW 6208 | 3) 2.1 |
| | 4. ADDITOL VXW 6210N | 4) 5.4 |
| | 5. Canola oil | 5) 3 |
| 36 | 1. Graphene nanoplatelets | 1) 0.3 |
| | 2. Graphite Flakes | 2) 5.08 |
| | 3. Additol VXW 6208 | 3) 2.1 |
| | 4. ADDITOL VXW 6210N | 4) 5.4 |
| | 5. Canola oil | 5) 5 |
| 37 | 1. Graphene nanoplatelets | 1) 0.3 |
| | 2. Graphite Flakes | 2) 5.08 |
| | 3. Additol VXW 6208 | 3) 2.1 |
| | 4. ADDITOL VXW 6210N | 4) 5.4 |
| | 5. Canola oil | 5) 7 |
| 38 | 1. Graphene nanoplatelets | 1) 0.3 |
| | 2. Graphite Flakes | 2) 5.08 |
| | 3. Additol VXW 6208 | 3) 2.1 |
| | 4. ADDITOL VXW 6210N | 4) 5.4 |
| | 5. Canola oil | 5) 9 |
| 39 | 1. Graphene nanoplatelets | 1) 0.3 |
| | 2. Graphite Flakes | 2) 5.08 |
| | 3. Additol VXW 6208 | 3) 2.1 |
| | 4. ADDITOL VXW 6210N | 4) 5.4 |
| | 5. Epoxy-functional Polydimethylsiloxane (BYK-Silclean 3701) | 5) 0.5 |
| 40 | 1. Graphene nanoplatelets | 1) 0.3 |
| | 2. Graphite Flakes | 2) 5.08 |
| | 3. Additol VXW 6208 | 3) 2.1 |
| | 4. ADDITOL VXW 6210N | 4) 5.4 |
| | 5. Epoxy-functional Polydimethylsiloxane (BYK-Silclean 3701) | 5) 1 |
| 41 | 1. Graphene nanoplatelets | 1) 0.3 |
| | 2. Graphite Flakes | 2) 5.08 |
| | 3. Additol VXW 6208 | 3) 2.1 |
| | 4. ADDITOL VXW 6210N | 4) 5.4 |
| | 5. Epoxy-functional Polydimethylsiloxane (BYK-Silclean 3701) | 5) 2 |
| 42 | 1. Graphene nanoplatelets | 1) 0.3 |
| | 2. Graphite Flakes | 2) 5.08 |
| | 3. Additol VXW 6208 | 3) 2.1 |
| | 4. ADDITOL VXW 6210N | 4) 5.4 |
| | 5. Epoxy-functional Polydimethylsiloxane (BYK-Silclean 3701) | 5) 3 |
| 43 | 1. Graphene nanoplatelets | 1) 0.3 |
| | 2. Graphite Flakes | 2) 5.08 |
| | 3. Additol VXW 6208 | 3) 2.1 |
| | 4. ADDITOL VXW 6210N | 4) 5.4 |
| | 5. Epoxy-functional Polydimethylsiloxane (BYK-Silclean 3701) | 5) 4 |
| 44 | 1. Graphene nanoplatelets | 1) 0.3 |
| | 2. Graphite Flakes | 2) 5.08 |
| | 3. Additol VXW 6208 | 3) 2.1 |
| | 4. ADDITOL VXW 6210N | 4) 5.4 |
| | 5. Epoxy-functional Polydimethylsiloxane (BYK-Silclean 3701) | 5) 5 |
| 45 | 1. Graphene nanoplatelets | 1) 0.3 |
| | 2. Graphite Flakes | 2) 5.08 |
| | 3. Additol VXW 6208 | 3) 2.1 |
| | 4. ADDITOL VXW 6210N | 4) 5.4 |
| | 5. Epoxy-functional Polydimethylsiloxane (BYK-Silclean 3701) | 5) 6 |
| 46 | 1. Graphene nanoplatelets | 1) 0.3 |
| | 2. Graphite Flakes | 2) 5.08 |
| | 3. Additol VXW 6208 | 3) 2.1 |
| | 4. ADDITOL VXW 6210N | 4) 5.4 |
| | 5. Epoxy-functional Polydimethylsiloxane (BYK-Silclean 3701) | 5) 5 |
| | 6. Glycidoxypropyltrimethoxysilane (Epoxy functional silane) | 6)1 |
| 47 | 1. Graphene nanoplatelets | 1) 0.3 |
| | 2. Graphite Flakes | 2) 5.08 |
| | 3. Additol VXW 6208 | 3) 2.1 |
| | 4. ADDITOL VXW 6210N | 4) 5.4 |
| | 5. Epoxy-functional Polydimethylsiloxane (BYK-Silclean 3701) | 5) 5 |
| | 6. Glycidoxypropyltrimethoxysilane (Epoxy functional silane) | 6)1.49 |
| 48 | 1. Graphene nanoplatelets | 1) 0.3 |
| | 2. Graphite Flakes | 2) 5.08 |
| | 3. Additol VXW 6208 | 3) 2.1 |
| | 4. ADDITOL VXW 6210N | 4) 5.4 |
| | 5. Epoxy-functional Polydimethylsiloxane (BYK-Silclean 3701) | 5) 5 |
| | 6. Glycidoxypropyltrimethoxysilane (Epoxy functional silane) | 6)2 |
| 49 | 1. Graphene nanoplatelets | 1) 0.3 |
| | 2. Graphite Flakes | 2) 5.08 |
| | 3. Additol VXW 6208 | 3) 2.1 |
| | 4. ADDITOL VXW 6210N | 4) 5.4 |
| | 5. Epoxy-functional Polydimethylsiloxane (BYK-Silclean 3701) | 5) 7 |
| | 6. Glycidoxypropyltrimethoxysilane (Epoxy functional silane) | 6)1.49 |
| 50 | 1. Graphene nanoplatelets | 1) 0.3 |
| | 2. Graphite Flakes | 2) 5.08 |
| | 3. Additol VXW 6208 | 3) 2.1 |
| | 4. ADDITOL VXW 6210N | 4) 5.4 |
| | 5. Epoxy-functional Polydimethylsiloxane (BYK-Silclean 3701) | 5)8 |
| | 6. Glycidoxypropyltrimethoxysilane (Epoxy functional silane) | 6)1.49 |
| 51 | 1. Graphene nanoplatelets | 1) 0.3 |
| | 2. Graphite Flakes | 2) 5.08 |
| | 3. Additol VXW 6208 | 3) 2.1 |
| | 4. ADDITOL VXW 6210N | 4) 5.4 |
| | 5. Epoxy-functional Polydimethylsiloxane (BYK-Silclean 3701) | 5)5 |
| | 6. Glycidoxypropyltrimethoxysilane (Epoxy functional silane) | 6)1.49 |
| 100 - | 1. Graphene nanoplatelets | 1) 0.3 |
| BMI | 2. Graphite Flakes | 2) 5.08 |
| | 3. Additol VXW 6208 | 3) 2.1 |
| | 4. ADDITOL VXW 6210N | 4) 5.4 |
| | 5. Epoxy-functional Polydimethylsiloxane (BYK-Silclean | 5)5 |
| | 3701) | 6)1.49 |
| | 6. Glycidoxypropyltrimethoxysilane (Epoxy functional | 7) 10 |
| | silane) | |
| | 7. BMI 689 | |
| 101 - | 1. Graphene nanoplatelets | 1) 0.3 |
| BMI | 2. Graphite Flakes | 2) 5.08 |
| | 3. Additol VXW 6208 | 3) 2.1 |
| | 4. ADDITOL VXW 6210N | 4) 5.4 |
| | 5. Epoxy-functional Polydimethylsiloxane (BYK-Silclean | 5)5 |
| | 3701) | 6)1.49 |
| | 6. Glycidoxypropyltrimethoxysilane (Epoxy functional | 7) 15 |
| | silane) | |
| | 7. BMI 689 | |
| 102 - | 1. Graphene nanoplatelets | 1) 0.3 |
| BMI | 2. Graphite Flakes | 2) 5.08 |
| | 3. Additol VXW 6208 | 3) 2.1 |
| | 4. ADDITOL VXW 6210N | 4) 5.4 |
| | 5. Epoxy-functional Polydimethylsiloxane (BYK- | 5)5 |
| | Silclean 3701) | 6)1.49 |
| | 6. Glycidoxypropyltrimethoxysilane (Epoxy functional | 7) 20 |
| | silane) | |
| | 7. BMI 689 | |
| 103 - | 1. Graphene nanoplatelets | 1) 0.3 |
| BMI | 2. Graphite Flakes | 2) 5.08 |
| | 3. Additol VXW 6208 | 3) 2.1 |
| | 4. ADDITOL VXW 6210N | 4) 5.4 |
| | 5. Epoxy-functional Polydimethylsiloxane (BYK-Silclean | 5)5 |
| | 3701) | 6)1.49 |
| | 6. Glycidoxypropyltrimethoxysilane (Epoxy functional | 7) 10 |
| | silane) | |
| | 7. BMI 737 | |
| 104 - | 1. Graphene nanoplatelets | 1) 0.3 |
| BMI | 2. Graphite Flakes | 2) 5.08 |
| | 3. Additol VXW 6208 | 3) 2.1 |
| | 4. ADDITOL VXW 6210N | 4) 5.4 |
| | 5. Epoxy-functional Polydimethylsiloxane (BYK- | 5)5 |
| | Silclean 3701) | 6)1.49 |
| | 6. Glycidoxypropyltrimethoxysilane (Epoxy functional | 7) 15 |
| | silane) | |
| | 7. BMI 737 | |
| 105 - | 1. Graphene nanoplatelets | 1) 0.3 |
| BMI | 2. Graphite Flakes | 2) 5.08 |
| | 3. Additol VXW 6208 | 3) 2.1 |
| | 4. ADDITOL VXW 6210N | 4) 5.4 |
| | 5. Epoxy-functional Polydimethylsiloxane (BYK- | 5)5 |
| | Silclean 3701) | 6)1.49 |
| | 6. Glycidoxypropyltrimethoxysilane (Epoxy functional | 7) 20 |
| | silane) | |
| | 7. BMI 737 | |
| 106 - | 1. Graphene nanoplatelets | 1) 0.3 |
| BMI | 2. Graphite Flakes | 2) 5.08 |
| | 3. Additol VXW 6208 | 3) 2.1 |
| | 4. ADDITOL VXW 6210N | 4) 5.4 |
| | 5. Epoxy-functional Polydimethylsiloxane (BYK-Silclean | 5)5 |
| | 3701) | 6)1.49 |
| | 6. Glycidoxypropyltrimethoxysilane (Epoxy functional | 7) 10 |
| | silane) | |
| | 7. BMI 1100 | |
| 107 - | 1. Graphene nanoplatelets | 1) 0.3 |
| BMI | 2. Graphite Flakes | 2) 5.08 |
| | 3. Additol VXW 6208 | 3) 2.1 |
| | 4. ADDITOL VXW 6210N | 4) 5.4 |
| | 5. Epoxy-functional Polydimethylsiloxane (BYK-Silclean | 5)5 |
| | 3701) | 6)1.49 |
| | 6. Glycidoxypropyltrimethoxysilane (Epoxy functional | 7) 15 |
| | silane) | |
| | 7. BMI 1100 | |
| 108 - | 1. Graphene nanoplatelets | 1) 0.3 |
| BMI | 2. Graphite Flakes | 2) 5.08 |
| | 3. Additol VXW 6208 | 3) 2.1 |
| | 4. ADDITOL VXW 6210N | 4) 5.4 |
| | 5. Epoxy-functional Polydimethylsiloxane (BYK- | 5)5 |
| | Silclean 3701) | 6)1.49 |
| | 6. Glycidoxypropyltrimethoxysilane (Epoxy functional | 7) 20 |
| | silane) | |
| | 7. BMI 1100 | |
| 109 - | 1. Graphene nanoplatelets | 1) 0.3 |
| BMI | 2. Graphite Flakes | 2) 5.08 |
| | 3. Additol VXW 6208 | 3) 2.1 |
| | 4. ADDITOL VXW 6210N | 4) 5.4 |
| | 5. Epoxy-functional Polydimethylsiloxane (BYK-Silclean 3701) | 5)5 |
| | 6. Glycidoxypropyltrimethoxysilane (Epoxy functional silane) | 6)1.49 |
| | 7. BMI 1400 | 7) 10 |
| 110 - | 1. Graphene nanoplatelets | 1) 0.3 |
| BMI | 2. Graphite Flakes | 2) 5.08 |
| | 3. Additol VXW 6208 | 3) 2.1 |
| | 4. ADDITOL VXW 6210N | 4) 5.4 |
| | 5. Epoxy-functional Polydimethylsiloxane (BYK-Silclean | 5)5 |
| | 3701) | 6)1.49 |
| | 6. Glycidoxypropyltrimethoxysilane (Epoxy functional | 7) 15 |
| | silane) | |
| | 7. BMI 1400 | |
| 111 - | 1. Graphene nanoplatelets | 1) 0.3 |
| BMI | 2. Graphite Flakes | 2) 5.08 |
| | 3. Additol VXW 6208 | 3) 2.1 |
| | 4. ADDITOL VXW 6210N | 4) 5.4 |
| | 5. Epoxy-functional Polydimethylsiloxane (BYK- | 5)5 |
| | Silclean 3701) | 6)1.49 |
| | 6. Glycidoxypropyltrimethoxysilane (Epoxy functional | 7) 20 |
| | silane) | |
| | 7. BMI 1400 | |
| 112 - | 1. Graphene nanoplatelets | 1) 0.3 |
| BMI | 2. Graphite Flakes | 2) 5.08 |
| | 3. Additol VXW 6208 | 3) 2.1 |
| | 4. ADDITOL VXW 6210N | 4) 5.4 |
| | 5. Epoxy-functional Polydimethylsiloxane (BYK-Silclean | 5)5 |
| | 3701) | 6)1.49 |
| | 6. Glycidoxypropyltrimethoxysilane (Epoxy functional | 7) 10 |
| | silane) | |
| | 7. BMI 1500 | |
| 113 - | 1. Graphene nanoplatelets | 1) 0.3 |
| BMI | 2. Graphite Flakes | 2) 5.08 |
| | 3. Additol VXW 6208 | 3) 2.1 |
| | 4. ADDITOL VXW 6210N | 4) 5.4 |
| | 5. Epoxy-functional Polydimethylsiloxane (BYK-Silclean | 5)5 |
| | 3701) | 6)1.49 |
| | 6. Glycidoxypropyltrimethoxysilane (Epoxy functional | 7) 15 |
| | silane) | |
| | 7. BMI 1500 | |
| 114 - | 1. Graphene nanoplatelets | 1) 0.3 |
| BMI | 2. Graphite Flakes | 2) 5.08 |
| | 3. Additol VXW 6208 | 3) 2.1 |
| | 4. ADDITOL VXW 6210N | 4) 5.4 |
| | 5. Epoxy-functional Polydimethylsiloxane (BYK- | 5)5 |
| | Silclean 3701) | 6)1.49 |
| | 6. Glycidoxypropyltrimethoxysilane (Epoxy functional | 7) 20 |
| | silane) | |
| | 7. BMI 1500 | |
| 204-Si | 1. Titanium Dioxide | 1) 25.0 |
| | 2. Organo-modified siloxane containing fumed silica | 2) 1.1 |
| | 3. Epoxy-functional polydimethylsiloxane (BYK-Silclean 3701) | 3) 2.5 |
| | 4. Organo-modified derivative of castor oil | 4) 0.55 |
| 205-Si | 1. Titanium Dioxide | 1) 25.0 |
| | 2. Organo-modified siloxane containing fumed silica | 2) 1.1 |
| | 3. Epoxy-functional polydimethylsiloxane (BYK-Silclean 3701) | 3) 2.5 |
| | 4. Organo-modified derivative of castor oil | 4) 0.55 |
| | 5. Hydroxyalkyl-modified polydimethylsiloxane | 5)12.5 |
| | oligomer | |
| 206-Si | 1. Titanium Dioxide | 1) 25.0 |
| | 2. Organo-modified siloxane containing fumed silica | 2) 1.1 |
| | 3. Epoxy-functional polydimethylsiloxane (BYK-Silclean 3701) | 3) 2.5 |
| | 4. Organo-modified derivative of castor oil | 4) 0.55 |
| | 5. Hydroxyalkyl-modified polydimethylsiloxane | 5) 8 |
| | oligomer | |
| 207-Si | 1. Titanium Dioxide | 1) 25.0 |
| | 2. Organo-modified siloxane containing fumed silica | 2) 1.1 |
| | 3. Epoxy-functional polydimethylsiloxane (BYK-Silclean 3701) | 3) 2.5 |
| | 4. Organo-modified derivative of castor oil | 4) 0.55 |
| | 5. Hydroxyalkyl-modified polydimethylsiloxane oligomer | 5) 4.5 |
| | 6. Fluorohydroxylalkylated dimethyl siloxane oligomer | 6) 4.1 |
| 208-Si | 1. Titanium Dioxide | 1) 25.0 |
| | 2. Organo-modified siloxane containing fumed silica | 2) 1.1 |
| | 3. Epoxy-functional polydimethylsiloxane (BYK-Silclean 3701) | 3) 2.5 |
| | 4. Organo-modified derivative of castor oil | 4) 0.55 |
| | 5. Hydroxyalkyl-modified polydimethylsiloxane oligomer | 5) 12.5 |
| | 6. Fluorohydroxylalkylated dimethyl siloxane oligomer | 6) 4.1 |
| 209-Si | 1. Titanium Dioxide | 1) 25.0 |
| | 2. Organo-modified siloxane containing fumed silica | 2) 1.1 |
| | 3. Epoxy-functional polydimethylsiloxane(BYK-Silclean 3701) | 3) 2.5 |
| | 4. Organo-modified derivative of castor oil | 4) 0.55 |
| | 5. Hydroxyalkyl-modified polydimethylsiloxane oligomer | 5) 12.5 |
| | 6. Fluorohydroxylalkylated dimethyl siloxane oligomer | 6) 4.1 |
| | 7. Quaternary ammonium-modified dimethyl siloxane | 7) 1.9 |
| | oligomer | |
| 210-Si | 1. Titanium Dioxide | 1) 25.0 |
| | 2. Organo-modified siloxane containing fumed silica | 2) 1.1 |
| | 3. Epoxy-functional polydimethylsiloxane (BYK-Silclean 3701) | 3) 2.5 |
| | 4. Organo-modified derivative of castor oil | 4) 0.55 |
| | 5. Graphene nanoplatelets | 5) 1.1 |
| | 6. Graphite Flakes | 6) 4.9 |

Properties of Formulations #1 to 51, 100-BMI to 114-BMI, 204-Si to 205-Si and 209-Si to 210-Si where (A) is Foul release performance (ASTM D5479-94(2013)), (B) is GNP/Graphite dispersion (Microscope (20×zoom—3 images—Area 1 mm²)), (C) is Bubbles on surface (Microscope (20×zoom—3 images —Area 1 mm²)), (0) Contact angle (ASTM 07334-08), (F) is Water resistance (ASTM 0870-15), (G) is Hardness (0 shore hardness; ASTM 0-2240), (H) is Flexibility (cylindrical bending test ASTM D522), (1) is Adhesion (Mpa; ASTM D 4541), and (J) is Corrosion performance (salt fog hours; B117-19), (K) is Wet friction coefficient (ASTM D2047).

| # | (A) | (B) | (C) | (D) | (F) | (G) | (H) | (I) | (J) | (K) |
|---|---|---|---|---|---|---|---|---|---|---|
| 1 | (1) | (1) | (1) | 45 | (1) | 58 | (1) | 10 | 500 | 0.73 |
| 2 | (1) | (1) | (1) | 65 | (1) | 63 | (1) | 10 | 650 | |
| 3 | (1) | (1) | (1) | 80 | (3) | 72 | (2) | 10 | 650 | |
| 4 | (1) | (1) | (1) | 80 | (3) | 54 | (3) | 10 | 650 | |
| 5 | (1) | (1) | (1) | 75 | (3) | 70 | (2) | 10 | 700 | |
| 6 | (1) | (1) | (1) | 43 | (3) | 60 | (1) | 10 | 700 | |
| 200-Si | (5) | (3) | (3) | 105 | (2) | 52 | (2) | 8 | 1000 | 0.2 |
| 7 | (1) | (1) | (1) | 45 | (3) | 61 | (1) | 10 | 750 | |
| 8 | (1) | (1) | (1) | 55 | (3) | 64 | (2) | 10 | 900 | |
| 9 | (1) | (1) | (1) | 56 | (3) | 65 | (2) | 10 | 950 | |
| 10 | (1) | (1) | (1) | 61 | (3) | 71 | (3) | 10 | 2500 | |
| 11 | (1) | (1) | (1) | 56 | (3) | 72 | (3) | 10 | 1200 | |
| 12 | (1) | (1) | (1) | 59 | (3) | 74 | (3) | 10 | 1300 | |
| 13 | (1) | (1) | (1) | 53 | (3) | 75 | (3) | 10 | 2000 | |
| 14 | (1) | (1) | (1) | 50 | (3) | 70 | (3) | 10 | 2020 | |
| 15 | (1) | (1) | (1) | 50 | (3) | 72 | (3) | 10 | 2300 | |
| 16 | (1) | (1) | (1) | 51 | (3) | 72 | (3) | 10 | 2300 | |
| 17 | (1) | (1) | (1) | 52 | (3) | 71 | (3) | 10 | 600 | |
| 18 | (1) | (1) | (1) | 52 | (3) | 70 | (3) | 10 | 700 | |
| 19 | (1) | (1) | (1) | 53 | (3) | 70 | (2) | 10 | 900 | |
| 20 | (1) | (1) | (1) | 56 | (3) | 71 | (2) | 10 | 1300 | |
| 21 | (1) | (1) | (1) | 53 | (3) | 71 | (2) | 10 | 1200 | |
| 22 | (1) | (1) | (1) | 53 | (3) | 71 | (2) | 10 | 1200 | |
| 23 | | (1) | (1) | | | | | | | |
| 24 | | (2) | (1) | | | | | | | |
| 25 | | (3) | (1) | | | | | | | |
| 26 | | (3) | (1) | | | | | | | |
| 27 | | (3) | (1) | | | | | | | |
| 28 | | (1) | (1) | | | | | | | |
| 29 | | (1) | (2) | | | | | | | |
| 30 | | (1) | (3) | | | | | | | |
| 31 | | (1) | (3) | | | | | | | |
| 32 | | (1) | (3) | | | | | | | |
| 33 | | (3) | (3) | 53 | (3) | 70 | (2) | 10 | 3500 | |
| 34 | | (3) | (3) | 65 | | | | | | |
| 35 | | (3) | (3) | 75 | | | | | | |
| 36 | (2) | (3) | (3) | 89 | | | | | | |
| 37 | | (3) | (3) | 80 | | | | | | |
| 38 | | (3) | (3) | 78 | | | | | | |
| 39 | | (3) | (3) | 90 | | | | | | |
| 40 | | (3) | (3) | 92 | | | | | | |
| 41 | | (3) | (3) | 93.2 | | | | | | |
| 42 | | (3) | (3) | 93.6 | | | | | | |
| 43 | | (3) | (3) | 94 | | | | | | 0.73 |
| 44 | (3) | (3) | (3) | 95 | | | | | | |
| 45 | | (3) | (3) | 91 | | | | 10 | | |
| 46 | | (3) | (3) | 98 | | | | 15 | | 0.73 |
| 47 | (4) | (3) | (3) | 100.43 | | | | 18 | | |
| 48 | (4) | (3) | (3) | 98.25 | | | | 20 | | |
| 49 | (4) | (3) | (3) | 101 | | | | 25 | | |
| 50 | (4) | (3) | (3) | 102.18 | | | | 21 | | |
| 51 | (5) | (3) | (3) | 110 | (2) | 74 | (3) | 25 | 6000 | |
| 100- | (1) | (3) | (3) | 85 | (3) | 71 | (3) | 10 | 2500 | |
| BMI | | | | | | | | | | |
| 101- | (1) | (3) | (3) | 85 | (3) | 72 | (3) | 10 | 1200 | |
| BMI | | | | | | | | | | |
| 102- | (1) | (3) | (3) | 86 | (3) | 74 | (3) | 10 | 1300 | |
| BMI | | | | | | | | | | |
| 103- | (1) | (3) | (3) | 88 | (3) | 75 | (3) | 10 | 2000 | |
| BMI | | | | | | | | | | |
| 104- | (1) | (3) | (3) | 88 | (3) | 70 | (3) | 10 | 2020 | |
| BMI | | | | | | | | | | |
| 105- | (1) | (3) | (3) | 89 | (3) | 72 | (3) | 10 | 2300 | |
| BMI | | | | | | | | | | |
| 106- | (4) | (3) | (3) | 93 | (3) | 75 | (3) | 10 | 2000 | |
| BMI | | | | | | | | | | |
| 107- | (4) | (3) | (3) | 94 | (3) | 76 | (3) | 10 | 2000 | |
| BMI | | | | | | | | | | |
| 108- | (4) | (3) | (3) | 95 | (3) | 77 | (3) | 10 | 2000 | |
| BMI | | | | | | | | | | |
| 109- | (5) | (3) | (3) | 105 | (3) | 73 | (3) | 10 | 2000 | |
| BMI | | | | | | | | | | |
| 110- | (5) | (3) | (3) | 106 | (3) | 65 | (3) | 15 | 2000 | |
| BMI | | | | | | | | | | |
| 111- | (5) | (3) | (3) | 103 | (3) | 66 | (3) | 18 | 2000 | |
| BMI | | | | | | | | | | |
| 112- | (4) | (3) | (3) | 98.25 | (3) | 67 | (3) | 20 | 2000 | |
| BMI | | | | | | | | | | |
| 113- | (4) | (3) | (3) | 101 | (3) | 78 | (3) | 25 | 2000 | |
| BMI | | | | | | | | | | |
| 114- | (4) | (3) | (3) | 101 | (3) | 70 | (3) | 21 | 2000 | |
| BMI | | | | | | | | | | |
| 204-Si | (5) | (3) | (1) | 101 | (3) | 55 | (2) | 5 | 600* | 0.2 |
| 205-Si | (5) | (3) | (1) | 101 | (3) | 52 | (2) | 5 | 600* | 0.17 |
| 209-Si | (5) | (3) | (1) | 102 | (3) | 53 | (2) | 5 | 600* | 0.077 |
| 210-Si | (5) | (3) | (1) | 90 | (3) | 58 | (2) | 5 | 600* | 0.121 |

*Results from ongoing corrosion performance tests

Legend of Results

Property (A)—(1), (2), (3), (4), (5). Meaning: (1) All fouling growths and its permanently adhered. (2) All fouling growths and can be cleaned with a hand tool (plastic scraper). (3) Fouling growth and can be cleaned by a plastic scraper (15 knots or more remove the fouling). (4) Fouling growth and is easier to remove (5 knots, speed of a boat). (5)—Fouling growth and falls off by itself.

Property (B)—(1) >2 graphene/graphite flakes agglomerated. (2) Between 1-2 graphene/graphite flakes agglomerated. (3) All graphene/graphite flakes well dispersed per microstructure at 20× magnification—surface area of 250 um².

Property (C)—(1) >2 bubbles. (2) Between 1-2 bubbles. (3) <1 bubble per surface area of 250 um² (20× magnification).

Property (D) —Angle 90, Neutral. 90 to >100, Hydrophobic. <90, Hydrophilic.

Property (F)—(1) Makes water finger print over time, loss of color. (2) No water finger print in short times (24 hours exposition), finger print >24 hours and loss of color over time. (3) Does not make water fingerprint over time, no loss of color.

Property (G)—Soft, 0-10. Medium hard, 10 to <30. Hard, 30 to <60. Extra hard, 60 to 100.

Property (H)—(1) Bend to 10 mm without cracks. (2) Bend between 10-8 mm without cracks. (3) Bend from <8 mm (cylindrical bend test).

Property (I)—Lower adhesion <5 MPA. Good/better adhesion, between 5-10 MPA. Higher adhesion >10 MPA.

Property (J)—Standard dependent on the paint system. For epoxy: 500 hours is poorer resistance; 500-1500 is considered good/better resistance (1000 hours equals to 10 years of life service); >1500 is considered higher corrosion resistance.

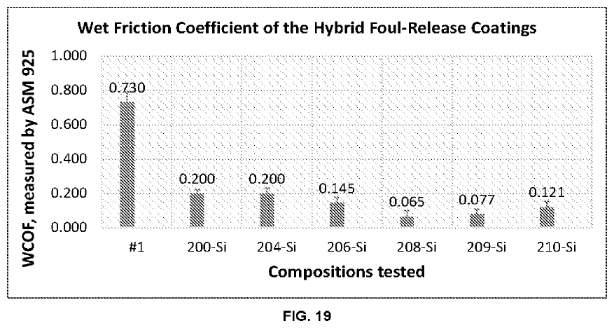

Property (K)—Also referred to as “slip”, the lower the wet friction coefficient, the less likelier the topcoat to develop the biofouling; industry standard—in a range from 0.03 to 0.08; conventional epoxy-based coatings (e.g., control coatings)—exhibit slip values between 0.20 and 0.6. Also see FIG. 19.

Surface Properties

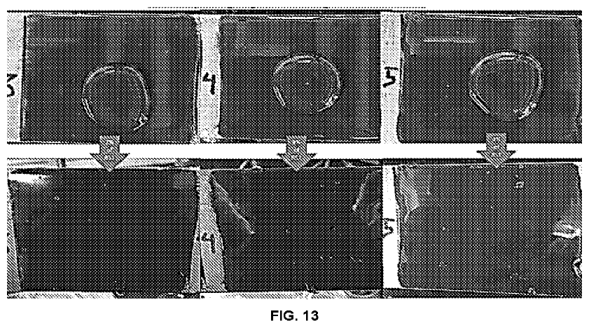

FIG. 13 shows the “hydrophobicity” of the surface. The fewer the water droplets left on the surface after being turned side-ways, the lower the surface energy (and the better the foul release properties). The shininess of the surface indicates the quality of the coating. Depicted here are the above-described compositions 41, 42, 43 (3, 4, 5, respectively). The samples are formed of a single coating layer with about 150 μm thickness, applied by brush on low carbon steel.

Formulations Exhibiting a Range of Properties

(A) Compositions based on Epoxy-functional monomer propane, 2,2-bis[p-(2,3-epoxypropoxy)phenyl]-, pre-polymers (25085-99-8), and diluents phenol-formaldehyde polymer glycidyl ether (28064-14-4; also referred to as poly[(phenyl glycidylether)-co-formaldehyde]) and benzyl alcohol (100-51-6)

| # | Hardener | Curing Catalyst | Additives | Wt. % |
|---|---|---|---|---|
| 52 | Reaction products of | | 1. Graphene | 1) 0.3 |
| | triethylenetetramine with | | nanoplatelets | 2) 5.08 |
| | phenol and formaldehyde | | 2. Graphite Flakes | 3) 2.1 |
| | (32610-77-8)/ | | 3. Additol VXW 6208 | 4) 5.4 |
| | Polyethylenepolyamines | | 4. ADDITOL VXW 6210N | 5) 5 |
| | (68131-73-7) | | 5. Epoxy-functional | 6)1.49 |
| | Polyoxypropylenediamine | | Polydimethylsiloxane | |
| | (9046-10-0)/Polymer of | | (BYK-Silclean 3701) | |
| | epichlorohydrin/ | | 6. Glycidoxypropyl- | |
| | bisphenol A and | | trimethoxysilane (Epoxy | |
| | diethylenetriamine | | functional silane) | |
| | (31326-29-1)/ | | | |
| | Tetraethylenepentamine | | | |
| | (112-57-2) | | | |
| | (WEST SYSTEM ® 205 | | | |
| | Fast Hardener) | | | |
| 53 | Fatty acids, C18- | | 1. Graphene | 1) 0.3 |
| | unsatd., dimers, polymers | | nanoplatelets | 2) 5.08 |
| | with tall oil fatty acids and | | 2. Graphite Flakes | 3) 2.1 |
| | triethylenetetramine | | 3. Additol VXW 6208 | 4) 5.4 |
| | (68082-29-1)/ | | 4. ADDITOL VXW 6210N | 5) 5 |
| | Methylenebiscyclohexanamine, | | 5. Epoxy-functional | 6)1.49 |
| | 4,4′- (1761-71)/ | | Polydimethylsiloxane | |
| | Polyoxypropylenediamine | | (BYK-Silclean 3701) | |
| | (9046-10-0)/Mixed | | 6. Glycidoxypropyl- | |
| | cycloaliphatic amines | | trimethoxysilane (Epoxy | |
| | (Formaldehyde, polymer | | functional silane) | |
| | with benzenamine, | | | |
| | hydrogenated). | | | |
| | Polyoxypropylenediamine | | | |
| | (9046-10-0)/Polymer of | | | |
| | epichlorohydrin/ | | | |
| | bisphenol A and | | | |
| | diethylenetriamine | | | |
| | (31326-29-1)/ | | | |
| | Tetraethylenepentamine | | | |
| | (112-57-2) | | | |
| | (WEST SYSTEM ® 209 | | | |
| | Extra Slow Hardener) | | | |
| 54 | Fatty acids, C18- | | 1. Graphene | 1) 0.3 |
| | unsatd., dimers, polymers | | nanoplatelets | 2) 5.08 |
| | with tall oil fatty acids and | | 2. Graphite Flakes | 3) 2.1 |
| | triethylenetetramine | | 3. Additol VXW 6208 | 4) 5.4 |
| | (68082-29-1)/ | | 4. ADDITOL VXW 6210N | 5) 5 |
| | Methylenebiscyclohexanamine, | | 5. Epoxy-functional | 6)1.49 |
| | 4,4′- (1761-71)/ | | Polydimethylsiloxane | |
| | Polyoxypropylenediamine | | (BYK-Silclean 3701) | |
| | (9046-10-0)/Mixed | | 6. Glycidoxypropyl- | |
| | cycloaliphatic amines | | trimethoxysilane (Epoxy | |
| | (Formaldehyde, polymer | | functional silane) | |
| | with benzenamine, | | | |
| | hydrogenated). | | | |
| | Reaction products of | | | |
| | triethylenetetramine with | | | |
| | phenol and formaldehyde | | | |
| | (32610-77-8)/ | | | |
| | Polyethylenepolyamines | | | |
| | (68131-73-7)) | | | |
| | (WEST SYSTEM ® 209 | | | |
| | Extra Slow Hardener) | | | |
| 55 | Reaction products of | | 1. Graphene | 1) 0.3 |
| | triethylenetetramine with | | nanoplatelets | 2) 5.08 |
| | phenol and formaldehyde | | 2. Graphite Flakes | 3) 2.1 |
| | (32610-77-8)/ | | 3. Additol VXW 6208 | 4) 5.4 |
| | Polyethylenepolyamines | | 4. ADDITOL VXW 6210N | 5) 5 |
| | (68131-73-7) | | 5. Epoxy-functional | 6)1.49 |
| | (WEST SYSTEM ® 205 | | Polydimethylsiloxane | |
| | Slow Hardener) | | (BYK-Silclean 3701) | |
| | | | 6. Glycidoxypropyl- | |
| | | | trimethoxysilane (Epoxy | |
| | | | functional silane) | |
| 56 | Polyoxypropylenediamine | | 1. Graphene | 1) 0.3 |
| | (9046-10-0)/Polymer of | | nanoplatelets | 2) 5.08 |
| | epichlorohydrin/ | | 2. Graphite Flakes | 3) 2.1 |
| | bisphenol A and | | 3. Additol VXW 6208 | 4) 5.4 |
| | diethylenetriamine | | 4. ADDITOL VXW 6210N | 5) 5 |
| | (31326-29-1)/ | | 5. Epoxy-functional | 6)1.49 |
| | Tetraethylenepentamine | | Polydimethylsiloxane | |
| | (112-57-2) | | (BYK-Silclean 3701) | |
| | (West System 206 Slow | | 6. Glycidoxypropyl- | |
| | Hardener) | | trimethoxysilane (Epoxy | |
| | | | functional silane) | |
| 57 | Fatty acids, C18- | | 1. Graphene | 1) 0.3 |
| | unsatd., dimers, polymers | | nanoplatelets | 2) 5.08 |
| | with tall oil fatty acids and | | 2. Graphite Flakes | 3) 2.1 |
| | triethylenetetramine | | 3. Additol VXW 6208 | 4) 5.4 |
| | (68082-29-1)/ | | 4. ADDITOL VXW 6210N | 5) 5 |
| | Methylenebiscyclohexan- | | 5. Epoxy-functional | 6)1.49 |
| | amine, 4,4′- (1761-71)/ | | Polydimethylsiloxane | |
| | Polyoxypropylenediamine | | (BYK-Silclean 3701) | |
| | (9046-10-0)/Mixed | | 6. Glycidoxypropyl- | |
| | cycloaliphatic amines | | trimethoxysilane (Epoxy | |
| | (Formaldehyde, polymer | | functional silane) | |
| | with benzenamine, | | | |
| | hydrogenated). | | | |
| | (West system 209 Extra | | | |
| | slow hardener) | | | |
| 58 | Fatty acids, C18-unsatd., | | 1. Graphene | 1) 0.3 |
| | dimers, polymers with tall | | nanoplatelets | 2) 5.08 |
| | oil fatty acids and | | 2. Graphite Flakes | 3) 2.1 |
| | triethylenetetramine | | 3. Additol VXW 6208 | 4) 5.4 |
| | (68082-29-1)/ | | 4. ADDITOL VXW 6210N | 5) 5 |
| | Methylenebiscyclohexanamine, | | 5. Epoxy-functional | 6)1.49 |
| | 4,4′- (1761-71)/ | | Polydimethylsiloxane | |
| | Polyoxypropylenediamine | | (BYK-Silclean 3701) | |
| | (9046-10-0)/Mixed | | 6. Glycidoxypropyl- | |
| | cycloaliphatic amines | | trimethoxysilane (Epoxy | |
| | (Formaldehyde, polymer | | functional silane) | |
| | with benzenamine, | | | |
| | hydrogenated). | | | |
| | Polyoxypropylenediamine | | | |
| | (9046-10-0)/Polymer of | | | |
| | epichlorohydrin/ | | | |
| | bisphenol A and | | | |
| | diethylenetriamine | | | |
| | (31326-29-1)/ | | | |
| | Tetraethylenepentamine | | | |
| | (112-57-2) | | | |
| | (Kukdu KMH-100) | | | |
| 59 | Fatty acids, C18-unsatd., | | 1. Graphene | 1) 0.3 |
| | dimers, polymers with tall | | nanoplatelets | 2) 5.08 |
| | oil fatty acids and | | 2. Graphite Flakes | 3) 2.1 |
| | triethylenetetramine | | 3. Additol VXW 6208 | 4) 5.4 |
| | (68082-29-1)/ | | 4. ADDITOL VXW 6210N | 5) 5 |
| | Methylenebiscyclohexanamine, | | 5. Epoxy-functional | 6)1.49 |
| | 4,4′- (1761-71)/ | | Polydimethylsiloxane | |
| | Polyoxypropylenediamine | | (BYK-Silclean 3701) | |
| | (9046-10-0)/Mixed | | 6. Glycidoxypropyl- | |
| | cycloaliphatic amines | | trimethoxysilane (Epoxy | |
| | (Formaldehyde, polymer | | functional silane) | |
| | with benzenamine, | | | |
| | hydrogenated). | | | |
| | Polyoxypropylenediamine | | | |
| | (9046-10-0)/Polymer of | | | |
| | epichlorohydrin/ | | | |
| | bisphenol A and | | | |
| | diethylenetriamine | | | |
| | (31326-29-1)/ | | | |
| | Tetraethylenepentamine | | | |
| | (112-57-2) | | | |
| | (Kukdu KMH-100) | | | |
| 60 | Cashew, nutshell liq. | | 1. Graphene | 1) 0.3 |
| | polymer with | | nanoplatelets | 2) 5.08 |
| | diethylenetriamine and | | 2. Graphite Flakes | 3) 2.1 |
| | formaldehyde (68413-29- | | 3. Additol VXW 6208 | 4) 5.4 |
| | 6)/N-(2-Aminoethyl)-1,2- | | 4. ADDITOL VXW 6210N | 5) 5 |
| | ethanediamin (111-40-0) - | | 5. Epoxy-functional | 6)1.49 |
| | Fatty acids, (C = 18)- | | Polydimethylsiloxane | |
| | unsatd., dimers, compds. | | (BYK-Silclean 3701) | |
| | with diethylenetriamine- | | 6. Glycidoxypropyl- | |
| | tall oil fatty acid reaction | | trimethoxysilane (Epoxy | |
| | products. | | functional silane) | |
| | (Phenalkamine) | | | |
| 61 | Fatty acids, C18-unsatd., | 2,4,6 - Tris | 1. Graphene | 1) 0.3 |
| | dimers, polymers with tall | [(dimethyllamino) | nanoplatelets | 2) 5.08 |
| | oil fatty acids and | methyl]phenol | 2. Graphite Flakes | 3) 2.1 |
| | triethylenetetramine | | 3. Additol VXW 6208 | 4) 5.4 |
| | (68082-29-1)/ | | 4. ADDITOL VXW 6210N | 5) 5 |
| | Methylenebiscyclohexanamine, | | 5. Epoxy-functional | 6)1.49 |
| | 4,4′- (1761-71)/ | | Polydimethylsiloxane | |
| | Polyoxypropylenediamine | | (BYK-Silclean 3701) | |
| | (9046-10-0)/Mixed | | 6. Glycidoxypropyl- | |
| | cycloaliphatic amines | | trimethoxysilane (Epoxy | |
| | (Formaldehyde, polymer | | functional silane) | |
| | with benzenamine, | | | |
| | hydrogenated). | | | |
| | Polyoxypropylenediamine | | | |
| | (9046-10-0)/Polymer of | | | |
| | epichlorohydrin/ | | | |
| | bisphenol A and | | | |
| | diethylenetriamine | | | |
| | (31326-29-1)/ | | | |
| | Tetraethylenepentamine | | | |
| | (112-57-2) | | | |
| | (Kukdu KMH-100) | | | |
| 62 | Fatty acids, C18-unsatd., | 2,4,6 - Tris | 1. Graphene | 1) 0.3 |
| | dimers, polymers with tall | [(dimethyllamino) | nanoplatelets | 2) 5.08 |
| | oil fatty acids and | methyl]phenol | 2. Graphite Flakes | 3) 2.1 |
| | triethylenetetramine | | 3. Additol VXW 6208 | 4) 5.4 |
| | (68082-29-1)/ | | 4. ADDITOL VXW 6210N | 5) 5 |
| | Methylenebiscyclohexanamine, | | 5. Epoxy-functional | 6)1.49 |
| | 4,4′- (1761-71)/ | | Polydimethylsiloxane | |
| | Polyoxypropylenediamine | | (BYK-Silclean 3701) | |
| | (9046-10-0)/Mixed | | 6. Glycidoxypropyl- | |
| | cycloaliphatic amines | | trimethoxysilane (Epoxy | |
| | (Formaldehyde, polymer | | functional silane) | |
| | with benzenamine, | | | |
| | hydrogenated). | | | |
| | Polyoxypropylenediamine | | | |
| | (9046-10-0)/Polymer of | | | |
| | epichlorohydrin/ | | | |
| | bisphenol A and | | | |
| | diethylenetriamine | | | |
| | (31326-29-1)/ | | | |
| | Tetraethylenepentamine | | | |
| | (112-57-2) | | | |
| | (Kukdu KMH-100) | | | |
| 63 | Cashew, nutshell liq. | 2,4,6 - Tris | 1. Graphene | 1) 0.3 |
| | polymer with | [(dimethyllamino) | nanoplatelets | 2) 5.08 |
| | diethylenetriamine and | methyl]phenol | 2. Graphite Flakes | 3) 2.1 |
| | formaldehyde (68413-29- | | 3. Additol VXW 6208 | 4) 5.4 |
| | 6)/N-(2-Aminoethyl)-1,2- | | 4. ADDITOL VXW 6210N | 5) 5 |
| | ethanediamin (111-40-0) - | | 5. Epoxy-functional | 6)1.49 |
| | Fatty acids, (C = 18)- | | Polydimethylsiloxane | |
| | unsatd., dimers, compds. | | (BYK-Silclean 3701) | |
| | with diethylenetriamine- | | 6. Glycidoxypropyl- | |
| | tall oil fatty acid reaction | | trimethoxysilane (Epoxy | |
| | products. | | functional silane) | |
| | (Phenalkamine) | | | |

(B) Compositions based on Epoxy-based monomer Epoxy Bisphenol A (2,2-Bis(4′-glycidyloxyphenyl)propane) (1675-54-3), and Diluents Alkyl Glycidyl Ether (68609-97-2) and Benzyl Alcohol (100-51-4)

| # | Hardener | Curing Catalyst | Additives | Wt. % |
|---|---|---|---|---|
| 64 | Reaction products of | | 1. Graphene | 1) 0.3 |
| | triethylenetetramine with | | nanoplatelets | 2) 5.08 |
| | phenol and formaldehyde | | 2. Graphite Flakes | 3) 2.1 |
| | (32610-77-8)/ | | 3. Additol VXW 6208 | 4) 5.4 |
| | Polyethylenepolyamines | | 4. ADDITOL VXW | 5) 5 |
| | (68131-73-7) | | 6210N | 6)1.49 |
| | Polyoxypropylenediamine | | 5. Epoxy-functional | |
| | (9046-10-0)/Polymer of | | Polydimethylsiloxane | |
| | epichlorohydrin/ | | (BYK-Silclean 3701) | |
| | bisphenol A and | | 6. Glycidoxypropyl- | |
| | diethylenetriamine | | trimethoxysilane (Epoxy | |
| | (31326-29-1)/ | | functional silane) | |
| | Tetraethylenepentamine | | | |
| | (112-57-2) | | | |
| | (WEST SYSTEM ® 205 | | | |
| | Fast Hardener) | | | |
| 65 | Fatty acids, C18- | | 1. Graphene | 1) 0.3 |
| | unsatd., dimers, polymers | | nanoplatelets | 2) 5.08 |
| | with tall oil fatty acids and | | 2. Graphite Flakes | 3) 2.1 |
| | triethylenetetramine | | 3. Additol VXW 6208 | 4) 5.4 |
| | (68082-29-1)/ | | 4. ADDITOL VXW | 5) 5 |
| | Methylenebiscyclohexan- | | 6210N | 6)1.49 |
| | amine, 4,4′- (1761-71)/ | | 5. Epoxy-functional | |
| | Polyoxypropylenediamine | | Polydimethylsiloxane | |
| | (9046-10-0)/Mixed | | (BYK-Silclean 3701) | |
| | cycloaliphatic amines | | 6. Glycidoxypropyl- | |
| | (Formaldehyde, polymer | | trimethoxysilane (Epoxy | |
| | with benzenamine, | | functional silane) | |
| | hydrogenated). | | | |
| | Polyoxypropylenediamine | | | |
| | (9046-10-0)/Polymer of | | | |
| | epichlorohydrin/ | | | |
| | bisphenol A and | | | |
| | diethylenetriamine | | | |
| | (31326-29-1)/ | | | |
| | Tetraethylenepentamine | | | |
| | (112-57-2) | | | |
| | (WEST SYSTEM ® 209 | | | |
| | Extra Slow Hardener) | | | |
| 66 | Fatty acids, C18- | | 1. Graphene | 1) 0.3 |
| | unsatd., dimers, polymers | | nanoplatelets | 2) 5.08 |
| | with tall oil fatty acids and | | 2. Graphite Flakes | 3) 2.1 |
| | triethylenetetramine | | 3. Additol VXW 6208 | 4) 5.4 |
| | (68082-29-1)/ | | 4. ADDITOL VXW | 5) 5 |
| | Methylenebiscyclohexan- | | 6210N | 6)1.49 |
| | amine, 4,4′- (1761-71)/ | | 5. Epoxy-functional | |
| | Polyoxypropylenediamine | | Polydimethylsiloxane | |
| | (9046-10-0)/Mixed | | (BYK-Silclean 3701) | |
| | cycloaliphatic amines | | 6. Glycidoxypropyl- | |
| | (Formaldehyde, polymer | | trimethoxysilane (Epoxy | |
| | with benzenamine, | | functional silane) | |
| | hydrogenated). | | | |
| | Reaction products of | | | |
| | triethylenetetramine with | | | |
| | phenol and formaldehyde | | | |
| | (32610-77-8)/ | | | |
| | Polyethylenepolyamines | | | |
| | (68131-73-7)) | | | |
| | (WEST SYSTEM ® 209 | | | |
| | Extra Slow Hardener) | | | |
| 67 | Reaction products of | | 1. Graphene | 1) 0.3 |
| | triethylenetetramine with | | nanoplatelets | 2) 5.08 |
| | phenol and formaldehyde | | 2. Graphite Flakes | 3) 2.1 |
| | (32610-77-8)/ | | 3. Additol VXW 6208 | 4) 5.4 |
| | Polyethylenepolyamines | | 4. ADDITOL VXW | 5) 5 |
| | (68131-73-7) | | 6210N | 6)1.49 |
| | (WEST SYSTEM ® 205 | | 5. Epoxy-functional | |
| | Slow Hardener) | | Polydimethylsiloxane | |
| | | | (BYK-Silclean 3701) | |
| | | | 6. Glycidoxypropyl- | |
| | | | trimethoxysilane (Epoxy | |
| | | | functional silane) | |
| 68 | Polyoxypropylenediamine | | 1. Graphene | 1) 0.3 |
| | (9046-10-0)/Polymer of | | nanoplatelets | 2) 5.08 |
| | epichlorohydrin/ | | 2. Graphite Flakes | 3) 2.1 |
| | bisphenol A and | | 3. Additol VXW 6208 | 4) 5.4 |
| | diethylenetriamine | | 4. ADDITOL VXW | 5) 5 |
| | (31326-29-1)/ | | 6210N | 6)1.49 |
| | Tetraethylenepentamine | | 5. Epoxy-functional | |
| | (112-57-2) | | Polydimethylsiloxane | |
| | (West System 206 Slow | | (BYK-Silclean 3701) | |
| | Hardener) | | 6. Glycidoxypropyl- | |
| | | | trimethoxysilane (Epoxy | |
| | | | functional silane) | |
| 69 | Fatty acids, C18- | | 1. Graphene | 1) 0.3 |
| | unsatd., dimers, polymers | | nanoplatelets | 2) 5.08 |
| | with tall oil fatty acids and | | 2. Graphite Flakes | 3) 2.1 |
| | triethylenetetramine | | 3. Additol VXW 6208 | 4) 5.4 |
| | (68082-29-1)/ | | 4. ADDITOL VXW | 5) 5 |
| | Methylenebiscyclohexan- | | 6210N | 6)1.49 |
| | amine, 4,4′- (1761-71)/ | | 5. Epoxy-functional | |
| | Polyoxypropylenediamine | | Polydimethylsiloxane | |
| | (9046-10-0)/Mixed | | (BYK-Silclean 3701) | |
| | cycloaliphatic amines | | 6. Glycidoxypropyl- | |
| | (Formaldehyde, polymer | | trimethoxysilane (Epoxy | |
| | with benzenamine, | | functional silane) | |
| | hydrogenated). | | | |
| | (West system 209 Extra | | | |
| | slow hardener) | | | |
| 70 | Fatty acids, C18-unsatd., | | 1. Graphene | 1) 0.3 |
| | dimers, polymers with tall | | nanoplatelets | 2) 5.08 |
| | oil fatty acids and | | 2. Graphite Flakes | 3) 2.1 |
| | triethylenetetramine | | 3. Additol VXW 6208 | 4) 5.4 |
| | (68082-29-1)/ | | 4. ADDITOL VXW | 5) 5 |
| | Methylenebiscyclohexanamine, | | 6210N | 6)1.49 |
| | 4,4′- (1761-71)/ | | 5. Epoxy-functional | |
| | Polyoxypropylenediamine | | Polydimethylsiloxane | |
| | (9046-10-0)/Mixed | | (BYK-Silclean 3701) | |
| | cycloaliphatic amines | | 6. Glycidoxypropyl- | |
| | (Formaldehyde, polymer | | trimethoxysilane (Epoxy | |
| | with benzenamine, | | functional silane) | |
| | hydrogenated). | | | |
| | Polyoxypropylenediamine | | | |
| | (9046-10-0)/Polymer of | | | |
| | epichlorohydrin/ | | | |
| | bisphenol A and | | | |
| | diethylenetriamine | | | |
| | (31326-29-1)/ | | | |
| | Tetraethylenepentamine | | | |
| | (112-57-2) | | | |
| | (Kukdu KMH-100) | | | |
| 71 | Fatty acids, C18-unsatd., | | 1. Graphene | 1) 0.3 |
| | dimers, polymers with tall | | nanoplatelets | 2) 5.08 |
| | oil fatty acids and | | 2. Graphite Flakes | 3) 2.1 |
| | triethylenetetramine | | 3. Additol VXW 6208 | 4) 5.4 |
| | (68082-29-1)/ | | 4. ADDITOL VXW | 5) 5 |
| | Methylenebiscyclohexanamine, | | 6210N | 6)1.49 |
| | 4,4′- (1761-71)/ | | 5. Epoxy-functional | |
| | Polyoxypropylenediamine | | Polydimethylsiloxane | |
| | (9046-10-0)/Mixed | | (BYK-Silclean 3701) | |
| | cycloaliphatic amines | | 6. Glycidoxypropyl- | |
| | (Formaldehyde, polymer | | trimethoxysilane (Epoxy | |
| | with benzenamine, | | functional silane) | |
| | hydrogenated). | | | |
| | Polyoxypropylenediamine | | | |
| | (9046-10-0)/Polymer of | | | |
| | epichlorohydrin/ | | | |
| | bisphenol A and | | | |
| | diethylenetriamine | | | |
| | (31326-29-1)/ | | | |
| | Tetraethylenepentamine | | | |
| | (112-57-2) | | | |
| | (Kukdu KMH-100) | | | |
| 72 | Cashew, nutshell liq. | | 1. Graphene | 1) 0.3 |
| | polymer with | | nanoplatelets | 2) 5.08 |
| | diethylenetriamine and | | 2. Graphite Flakes | 3) 2.1 |
| | formaldehyde (68413-29- | | 3. Additol VXW 6208 | 4) 5.4 |
| | 6)/N-(2-Aminoethyl)-1,2- | | 4. ADDITOL VXW | 5) 5 |
| | ethanediamin (111-40-0) - | | 6210N | 6)1.49 |
| | Fatty acids, (C = 18)- | | 5. Epoxy-functional | |
| | unsatd., dimers, compds. | | Polydimethylsiloxane | |
| | with diethylenetriamine- | | (BYK-Silclean 3701) | |
| | tall oil fatty acid reaction | | 6. Glycidoxypropyl- | |
| | products. | | trimethoxysilane (Epoxy | |
| | (Phenalkamine) | | functional silane) | |
| 73 | Fatty acids, C18-unsatd., | 2,4,6 - Tris | 1. Graphene | 1) 0.3 |
| | dimers, polymers with tall | [(dimethyllamino) | nanoplatelets | 2) 5.08 |
| | oil fatty acids and | methyl]phenol | 2. Graphite Flakes | 3) 2.1 |
| | triethylenetetramine | | 3. Additol VXW 6208 | 4) 5.4 |
| | (68082-29-1)/ | | 4. ADDITOL VXW | 5) 5 |
| | Methylenebiscyclohexanamine, | | 6210N | 6)1.49 |
| | 4,4′- (1761-71)/ | | 5. Epoxy-functional | |
| | Polyoxypropylenediamine | | Polydimethylsiloxane | |
| | (9046-10-0)/Mixed | | (BYK-Silclean 3701) | |
| | cycloaliphatic amines | | 6. Glycidoxypropyl- | |
| | (Formaldehyde, polymer | | trimethoxysilane (Epoxy | |
| | with benzenamine, | | functional silane) | |
| | hydrogenated). | | | |
| | Polyoxypropylenediamine | | | |
| | (9046-10-0)/Polymer of | | | |
| | epichlorohydrin/ | | | |
| | bisphenol A and | | | |
| | diethylenetriamine | | | |
| | (31326-29-1)/ | | | |
| | Tetraethylenepentamine | | | |
| | (112-57-2) | | | |
| | (Kukdu KMH-100) | | | |
| 74 | Fatty acids, C18-unsatd., | 2,4,6 - Tris | 1. Graphene | 1) 0.3 |
| | dimers, polymers with tall | [(dimethyllamino) | nanoplatelets | 2) 5.08 |
| | oil fatty acids and | methyl]phenol | 2. Graphite Flakes | 3) 2.1 |
| | triethylenetetramine | | 3. Additol VXW 6208 | 4) 5.4 |
| | (68082-29-1)/ | | 4. ADDITOL VXW | 5) 5 |
| | Methylenebiscyclohexanamine, | | 6210N | 6)1.49 |
| | 4,4′- (1761-71)/ | | 5. Epoxy-functional | |
| | Polyoxypropylenediamine | | Polydimethylsiloxane | |
| | (9046-10-0)/Mixed | | (BYK-Silclean 3701) | |
| | cycloaliphatic amines | | 6. Glycidoxypropyl- | |
| | (Formaldehyde, polymer | | trimethoxysilane (Epoxy | |
| | with benzenamine, | | functional silane) | |
| | hydrogenated). | | | |
| | Polyoxypropylenediamine | | | |
| | (9046-10-0)/Polymer of | | | |
| | epichlorohydrin/ | | | |
| | bisphenol A and | | | |
| | diethylenetriamine | | | |
| | (31326-29-1)/ | | | |
| | Tetraethylenepentamine | | | |
| | (112-57-2) | | | |
| | (Kukdu KMH-100) | | | |
| 75 | Cashew, nutshell liq. | 2,4,6 - Tris | 1. Graphene | 1) 0.3 |
| | polymer with | [(dimethyllamino) | nanoplatelets | 2) 5.08 |
| | diethylenetriamine and | methyl]phenol | 2. Graphite Flakes | 3) 2.1 |
| | formaldehyde (68413-29- | | 3. Additol VXW 6208 | 4) 5.4 |
| | 6)/N-(2-Aminoethyl)-1,2- | | 4. ADDITOL VXW | 5) 5 |
| | ethanediamin (111-40-0) - | | 6210N | 6)1.49 |
| | Fatty acids, (C = 18)- | | 5. Epoxy-functional | |
| | unsatd., dimers, compds. | | Polydimethylsiloxane | |
| | with diethylenetriamine- | | (BYK-Silclean 3701) | |
| | tall oil fatty acid reaction | | 6. Glycidoxypropyl- | |
| | products. | | trimethoxysilane (Epoxy | |
| | (Phenalkamine) | | functional silane) | |

(C) Compositions based on Silikopon ED (by Evonik GmbH); and Diluents M-ethyl Acetate and Xylene.

| | | | | |
|---|---|---|---|---|
| | | Curing | | |
| # | Hardener | Catalyst | Additives | Wt. % |

| | | | |
|---|---|---|---|
| 200-Si | Aminopropyl- | 1. (Silikopon ED, by Evonik GmbH) | 1) 64% |
| | triethoxysilane | | |
| | (Andisil ® 1100 | | |
| | Silane or | | |
| | Dynasylan ® | | |
| | AMEO) | | |
| 206-Si | Aminopropyl- | 1. Titanium Dioxide | 1) 25.0 |
| | triethoxysilane | 2. Organo-modified siloxane | 2) 1.1 |
| | (Andisil ® 1100 | containing fumed silica | 3) 2.5 |
| | Silane or | 3. Epoxy-functional | 4) 0.55 |
| | Dynasylan ® | polydimethylsiloxane (BYK-Silclean | 5) 8 |
| | AMEO) | 3701) | |
| | | 4. Organo-modified derivative of | |
| | | castor oil | |
| | | 5. Hydroxyalkyl-modified | |
| | | polydimethylsiloxane oligomer | |
| 207-Si | Aminopropyl- | 1. Titanium Dioxide | 1) 25.0 |
| | triethoxysilane | 2. Organo-modified siloxane | 2) 1.1 |
| | (Andisil ® 1100 | containing fumed silica | 3) 2.5 |
| | Silane or | 3. Epoxy-functional | 4) 0.55 |
| | Dynasylan ® | polydimethylsiloxane (BYK-Silclean | 5) 12.5 |
| | AMEO) | 3701) | 6) 4.1 |
| | | 4. Organo-modified derivative of | |
| | | castor oil | |
| | | 5. Hydroxyalkyl-modified | |
| | | polydimethylsiloxane oligomer | |
| | | 6. Fluorohydroxylalkylated dimethyl | |
| | | siloxane oligomer | |
| 208-Si | Aminopropyl- | 1. Titanium Dioxide | 1) 25.0 |
| | triethoxysilane | 2. Organo-modified siloxane | 2) 1.1 |
| | (Andisil ® 1100 | containing fumed silica | 3) 1.5 |
| | Silane or | 3. Epoxy-functional | 4) 0.55 |
| | Dynasylan ® | polydimethylsiloxane (BYK-Silclean | 5) 12.5 |
| | AMEO) | 3701) | 6) 4.1 |
| | | 4. Organo-modified derivative of | |
| | | castor oil | |
| | | 5. Hydroxyalkyl-modified | |
| | | polydimethylsiloxane oligomer | |
| | | 6. Fluorohydroxylalkylated dimethyl | |
| | | siloxane oligomer | |

Properties of Formulations #62 to 75, 200-Si, 206-Si to 208-Si where (A) is Foul release performance (ASTM D5479-94(2013)), (B) is GNP/Graphite dispersion (Microscope (20×zoom—3 images—Area 1 mm²)), (C) is Bubbles on surface (Microscope (20×zoom—3 images—Area 1 mm²)), (0) Contact angle (ASTM 07334-08), (F) is Water resistance (ASTM 0870-15), (G) is Hardness (0 shore hardness, ASTM 0-2240), (H) is Flexibility (cylindrical bending test ASTM 0522), (0) is Adhesion (Mpa, ASTM D 4641), and (J) is Corrosion performance (salt fog hours; Bill—19); (K) is Wet friction coefficient (ASTM 02047).

| # | (A) | (B) | (C) | (D) | (F) | (G) | (H) | (I) | (J) | (K) |
|---|---|---|---|---|---|---|---|---|---|---|
| 200-Si | (5) | (3) | (3) | 105 | (2) | 52 | (2) | 8 | 1000 | 0.2 |
| 52 | (5) | (3) | (3) | 102 | (2) | 74 | (2) | 25 | 6000 | |
| 53 | (5) | (3) | (3) | 102 | (2) | 74 | (2) | 25 | 6000 | |
| 54 | (5) | (3) | (3) | 102 | (2) | 74 | (2) | 25 | 6000 | |
| 55 | (5) | (3) | (3) | 102 | (2) | 74 | (2) | 25 | 6000 | |
| 56 | (5) | (3) | (3) | 102 | (2) | 74 | (2) | 25 | 6000 | |
| 57 | (5) | (3) | (3) | 102 | (2) | 74 | (2) | 25 | 6000 | |
| 58 | (5) | (3) | (3) | 110 | (2) | 74 | (2) | 25 | 6000 | |
| 59 | (5) | (3) | (3) | 102 | (2) | 74 | (2) | 25 | 6000 | |
| 60 | (5) | (3) | (3) | 102 | (2) | 74 | (2) | 25 | 6000 | |
| 61 | (5) | (3) | (3) | 102 | (2) | 74 | (2) | 25 | 6000 | |
| 62 | (5) | (3) | (3) | 102 | (2) | 74 | (2) | 25 | 6000 | |
| 63 | (5) | (3) | (3) | 108 | (2) | 74 | (2) | 25 | 6000 | |
| 64 | (5) | (3) | (3) | 102 | (2) | 74 | (2) | 25 | 6000 | |
| 65 | (5) | (3) | (3) | 102 | (2) | 74 | (2) | 25 | 6000 | |
| 66 | (5) | (3) | (3) | 102 | (2) | 74 | (2) | 25 | 6000 | |
| 67 | (5) | (3) | (3) | 102 | (2) | 74 | (2) | 25 | 6000 | |
| 68 | (5) | (3) | (3) | 102 | (2) | 74 | (2) | 25 | 6000 | |
| 69 | (5) | (3) | (3) | 102 | (2) | 74 | (2) | 25 | 6000 | |
| 70 | (5) | (3) | (3) | 110 | (2) | 74 | (2) | 25 | 6000 | |
| 71 | (5) | (3) | (3) | 102 | (2) | 74 | (2) | 25 | 6000 | |
| 206-Si | (5) | (3) | (3) | 106 | (2) | 50 | (2) | 7 | 1000 | 0.145 |
| 207-Si | (5) | (3) | (3) | 105 | (2) | 48 | (2) | 8 | 1000 | |
| 208-Si | (5) | (3) | (3) | 108 | (2) | 50 | (2) | 9 | 1000 | 0.065 |
| 72 | (5) | (3) | (3) | 102 | (2) | 74 | (2) | 25 | 6000 | |
| 73 | (5) | (3) | (3) | 102 | (2) | 74 | (2) | 25 | 6000 | |
| 74 | (5) | (3) | (3) | 102 | (2) | 74 | (2) | 25 | 6000 | |
| 75 | (5) | (3) | (3) | 108 | (2) | 74 | (2) | 25 | 6000 | |

Legend of Results

Property (A)—(1), (2), (3), (4), (5). Meaning: (1) All fouling growths and its permanently adhered. (2) All fouling growths and can be cleaned with a hand tool (plastic scraper). (3) Fouling growth and can be cleaned by a plastic scraper (15 knots or more remove the fouling). (4) Fouling growth and is easier to remove (5 knots, speed of a boat). (5)—Fouling growth and falls off by itself.

Property (B)—(1) >2 graphene/graphite flakes agglomerated. (2) Between 1-2 graphene/graphite flakes agglomerated. (3) All graphene/graphite flakes well dispersed per microstructure at 20× magnification—surface area of 250 um².

Property (C)—(1) >2 bubbles. (2) Between 1-2 bubbles. (3) <1 bubble per surface area of 250 um² (20× magnification).

Property (D) —Angle 90, Neutral. 90 to ≥100, Hydrophobic. <90, Hydrophilic.

Property (F)—(1) Makes water finger print over time, loss of color. (2) No water finger print in short times (24 hours exposition), finger print >24 hours and loss of color over time. (3) Does not make water fingerprint over time, no loss of color.

Property (G)—Soft, 0-10. Medium hard, 10 to <30. Hard, 30 to <60. Extra hard—60 to 100.

Property (H)—(1) Bend to 10 mm without cracks. (2) Bend between 10-8 mm without cracks. (3) Bend from <8 mm (cylindrical bend test).

Property (I)—Lower adhesion <5 MPA. Good/better adhesion, between 5-10 MPA. Higher adhesion >10 MPA.

Property (J)—Standard dependent on the paint system. For epoxy: 500 hours is poorer resistance; 500-1500 is considered good/better resistance (1000 hours equals to 10 years of life service); >1500 is considered higher corrosion resistance.

Property (K)—Also referred to as “slip”, the lower the wet friction coefficient, the less likelier the topcoat to develop the biofouling; industry standard—in a range from 0.03 to 0.08; conventional epoxy-based coatings (e.g., control coatings)—exhibit slip values between 0.20 and 0.6. Also see FIG. 19.

Compositions #300 to 301

Comparison of compositions #300 (comprising mix of epoxy-functional monomers, including the epoxy-functional epoxide-siloxane monomers; and amphiphilicity-modifying additives) and #301 (not including epoxy-functional epoxide-siloxane monomers). Properties of final cured epoxy-based coatings suggested composition #300 (comprising mix of epoxy-functional monomers, including the epoxy-functional epoxide-siloxane monomers; and amphiphilicity-modifying additives) provided improved properties relative to composition #301.

Composition #300

| | Component | %, wt | %, vol |
|---|---|---|---|
| # Part A | | | |
| 1A | Alkyl Glycidyl Ether | 6% | 7.67% |
| 2A | Propane, 2,2-bis[p-(2,3-epoxypropoxy)phenyl]-, | 18% | 19.47% |
| | pre-polymers | | |
| 3A | Additol VXW 6208 | 2% | 2.10% |
| 4A | Glycidoxypropyltrimethoxysilane (Epoxy | 1% | 1.46% |
| | functional silane) | | |
| 5A | Graphene nanoplatelets | 0% | 0.32% |
| 6A | Graphite Flakes | 5% | 2.87% |
| 7A | Fumed silica (Rheology modifying additive) | 0% | 0.16% |
| 8A | Rheology modifying additive - Bentonite clay | 3% | 1.91% |
| 9A | Ca Magnesium Silicate (talc, filler) | 8% | 3.36% |
| 10A | Polydimethylsiloxane (BYK-Silclean 3701) | 5% | 6.23% |
| 11A | ADDITOL VXW 6210N | 1% | 0.78% |
| 12A | Butyl Glycidyl Ether | 2% | 2.40% |
| 13A | Benzyl alcohol | 4% | 4.52% |
| 14A | (Silikopon EF by Evonik GmbH) | 39% | 40.89% |
| 15A | Hydroxyalkyl-modified polydimethylsiloxane | 5% | 6.01% |
| | oligomer (Silmer OHT Di-50) | | |
| # Part B | | | |
| 1B | Phenalkamine | 66.86% | 64.48% |
| 2B | 2,4,6-tris[(dimethyllamino)methyl]phenol | 0.82% | 0.80% |
| 3B | Methyl acetate | 7.64% | 9.48% |
| 4B | Xylene | 15.28% | 17.11% |
| 5B | Polyethylene glycol 400 | 9.41% | 8.14% |

Properties of Formulations #300 where (A) is Foul release performance (ASTM)5479-94(2013)), (B) is GNP/Graphite dispersion (Microscope (20×zoom—3 images—Area 1 mm²)), (C) is Bubbles on surface (Microscope (20×zoom—3 images—Area 1 mm²)), (D) Contact angle (ASTM 07334-08), (F) is Water resistance (ASTM 0870-15), (G) is Hardness (0 shore hardness; ASTM 0-2240), (H) is Flexibility (cylindrical bending test ASTM D522), (1) is Adhesion (Mpa; ASTM D 4541), and (J) is Corrosion performance (salt fog hours; B117-19), (K) is Wet friction coefficient (ASTM 02047).

| # | (A) | (B) | (C) | (D) | (F) | (G) | (H) | (I) | (J) | (K) |
|---|---|---|---|---|---|---|---|---|---|---|
| 1 | (5) | | (1) | 94 | (1) | | (1) | 8-9 | | 0.340 |

Composition #301

| # Part A | Component | %, wt | %, vol |
|---|---|---|---|
| 1A | Epoxy Bisphenol A (2,2-Bis(4′-glycidyloxyphenyl)propane) | 37% | 36.11% |
| 2A | Propane, 2,2-bis[p-(2,3-epoxypropoxy)phenyl]-, | 22% | 22.78% |
| | pre-polymers | | |
| 3A | Additol VXW 6208 | 2% | 2.00% |
| 4A | K-SPERSE A504 | 0% | 0.22% |
| 5A | Graphene nanoplatelets | 0% | 0.18% |
| 6A | Graphite Flakes | 6% | 2.98% |
| 7A | Rheology modifying additive-Bentonite clay | 3% | 2.31% |
| 8A | Ca Magnesium Silicate (talc, filler) | 7% | 5% |
| 9A | ADDITOL VXW 6210N | 2% | 2.44% |
| 10A | Benzyl alcohol | 4% | 4.75% |
| 11A | Polydimethylsiloxane (BYK-Silclean 3701) | 7% | 8.48% |
| 12A | Alkyl Glycidyl Ether | 9% | 11.79% |
| # Part B | Component | %, wt | %, vol |
| 1B | Phenalkamine | 89.77% | 88.68% |
| 2B | 2,4,6-tris[(dimethyllamino)methyl]phenol | 1.10% | 1.09% |
| 3B | Methyl Ethyl Ketone | 4.68% | 5.84% |
| 4B | Polyethylene glycol 400 | 3.04% | 2.70% |

Properties of Formulations #301 where (A) is Foul release performance (ASTM D5479-94(2013)), (B) is GNP/Graphite dispersion (Microscope (20×zoom—3 images—Area 1 mm²)), (C) is Bubbles on surface (Microscope (20×zoom—3 images—Area 1 mm²)), (D) Contact angle (ASTM D7334-08), (F) is Water resistance (ASTM D870-15), (G) is Hardness (D shore hardness; ASTM D-2240), (H) is Flexibility (cylindrical bending test ASTM D522), (1) is Adhesion (Mpa; ASTM D 4541), and (J) is Corrosion performance (salt fog hours; B117-19), (K) is Wet friction coefficient (ASTM D2047).

| # | (A) | (B) | (C) | (D) | (F) | (G) | (H) | (I) | (J) | (K) |
|---|---|---|---|---|---|---|---|---|---|---|
| 1 | (5) | | (1) | 70 | (1) | | (1) | | | 0.38 |

Legend of Results

Property (A)—(1), (2), (3), (4), (5). Meaning: (1) All fouling growths and its permanently adhered. (2) All fouling growths and can be cleaned with a hand tool (plastic scraper). (3) Fouling growth and can be cleaned by a plastic scraper (15 knots or more remove the fouling). (4) Fouling growth and is easier to remove (5 knots, speed of a boat). (5)—Fouling growth and falls off by itself.

Property (B)—(1) >2 graphene/graphite flakes agglomerated. (2) Between 1-2 graphene/graphite flakes agglomerated. (3) All graphene/graphite flakes well dispersed per microstructure at 20× magnification—surface area of 250 um².

Property (C)—(1) >2 bubbles. (2) Between 1-2 bubbles. (3) <1 bubble per surface area of 250 um² (20× magnification).

Property (D) —Angle 90,Neutral. 90 to >100, Hydrophobic. <90, Hydrophilic.

Property (F)—(1) Makes water finger print over time, loss of color. (2) No water finger print in short times (24 hours exposition), finger print >24 hours and loss of color over time. (3) Does not make water fingerprint over time, no loss of color.

Property (G)—Soft, 0-10. Medium hard, 10 to <30. Hard, 30 to <60. Extra hard—60 to 100.

Property (H)—(1) Bend to 10 mm without cracks. (2) Bend between 10-8 mm without cracks. (3) Bend from <8 mm (cylindrical bend test).

Property (I)—Lower adhesion <5 MPA. Good/better adhesion, between 5-10 MPA. Higher adhesion >10 MPA.

Property (J)—Standard dependent on the paint system. For epoxy: 500 hours is poorer resistance; 500-1500 is considered good/better resistance (1000 hours equals to 10 years of life service); >1500 is considered higher corrosion resistance.

Property (K)—Also referred to as “slip”, the lower the wet friction coefficient, the less likelier the topcoat to develop the biofouling; industry standard—in a range from 0.03 to 0.08; conventional epoxy-based coatings (e.g., control coatings)—exhibit slip values between 0.20 and 0.6.

### Example 2—Shelf-Life of Compositions for a Coating (Formulations) Under Heat

Objective

Observe separation of additives and graphene (i.e., shelf life) of a composition for coating under at 50° C. temperature by acceleration. Stored for 30 days to observe.

Methodology

Shelf life additives: 1. S-NCN (NACCONOL 90G); 2. S-SP (SOLPLUS D610); 3. S-KS (K-SPERSE A504).

Prepared composition for a coating with shelf life additives, by adding 0.1% and 0.5% of the additives into the epoxy-functional monomers and a diluent (alkyl glycidyl ether (AGE) and benzyl alcohol); mixed under medium shear around 1500 rpm for 15 min at room temperature; Then, added graphene nanoplatelets (G) and graphite flakes (G1) into the composition under medium shear mixer around 3000 rpm for 30 min at room temperature; Finally, 50 ml of composition was stored under 50° C. in incubator to see the shelf life.

Experiment Results and Conditions

Room temperature: 21° C.; Humidity: ˜35%-40%; Dew point: 13 C; Storage amount: 50 g; Solutions storage temperature: 50° C. in incubator; Storage time: 30 days.

Sample ID:
1. Resin and G+G1 (Pure epoxy, No additive)
2. Added S-NCN (0.5%)
3. Added S-NCN (0.1%)
4. Added S-SP (0.5%)
5. Added S-SP (0.1%)
6. Added S-KS (0.5%)
7. Added S-KS (0.1%)

Sample 1—pure Epoxy+(AGE and 10% Benzyl Alcohol)+G and G1; Sample 2—with pure Epoxy+(AGE and 10% 10% Benzyl Alcohol)+G and G1+0.5% S-NCN; Sample 3—with pure Epoxy+(AGE and 10% Benzyl Alcohol)+G and G1+0.1% S-NCN; Sample 4—with pure Epoxy+(AGE and 10% Benzyl Alcohol)+G and G1+0.5% SOLDPLUS D610; Sample 5—with pure Epoxy+(AGE and 10% Benzyl Alcohol)+G and G1+0.1% SOLDPLUS D610; Sample 6—with pure Epoxy+(AGE and 10% Benzyl Alcohol) +G and G1+0.5% K Sperse A504; Sample 7—with pure Epoxy+(AGE and 10% Benzyl Alcohol)+G and G1+0.1% of K Sperse A504.

Further, it was found that the following did not work as dispersants or shelf-life additives:

| Surfactant | Chemical formula | Type |
|---|---|---|
| Triton X100 | [symbol] C [symbol] H [symbol] | Non-ionic liquid - |
| | (OCH [symbol] CH [symbol] ) [symbol] OH [symbol] | micellar avg. mol. wt. |
| | [symbol] 9-10 | 80 [symbol] 000 |
| Sodium dodecylbenzene | CH [symbol] (CH [symbol] ) [symbol] C [symbol] H [symbol] SO [symbol] N [symbol] | Ionic solid |
| sulfonate (SDBS) | | |
| Sodium dodecylsulphate | CH [symbol] (CH [symbol] ) [symbol] OSO [symbol] N [symbol] | Anionic detergent |
| Gum arabic | | branched |
| | | polysaccharide |
| Linear or branched | H(NHCH [symbol] CH [symbol] ) [symbol] NH [symbol] | Hydrophilic polymer |
| poly(ethyleneimine) | | |
| Poly(sodium styrene sulfonate) | (C [symbol] H [symbol] N [symbol] O [symbol] S) [symbol] | Anionic |
| [symbol] (PSS) | | polyelectrolyte |
| Nonionic polymeric, ethyl | variable | Polymer |
| cellulose | | |
| Tetradecyltrimethylammonium | C [symbol] BrN | cationic |
| bromide (CTAB) | | |
| Polyoxyethylene (40) | (C [symbol] H [symbol] O) [symbol] C [symbol] H [symbol] O [symbol] 40 | Non-ionic |
| nonylphenylether (CO890) | | |
| Polycarboxylate (H [symbol] 4N) | | Polymer |

[symbol]

indicates data missing or illegible when filed

### Conclusion

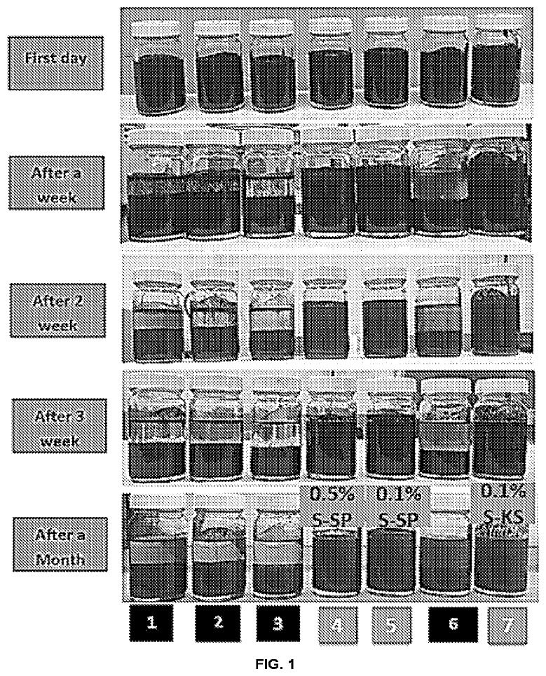

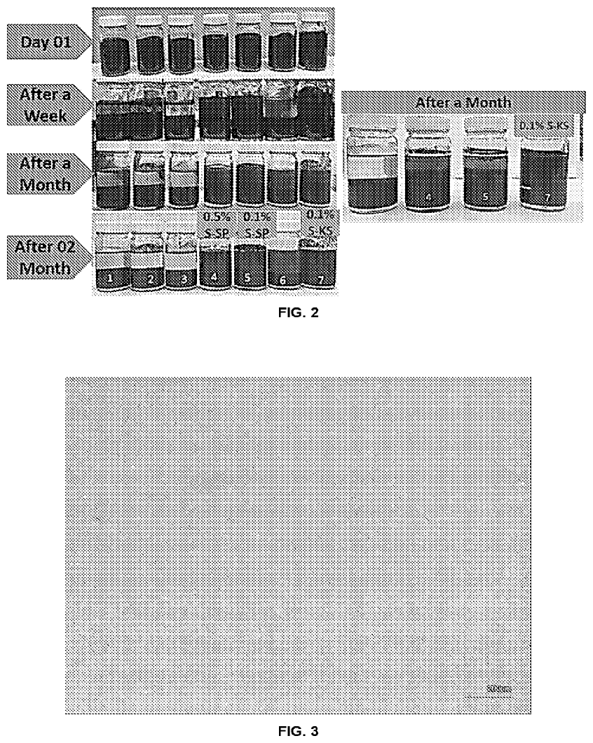

See FIGS. 1 and 2.

After a month, separation of the epoxy-functional monomers and shelf-life additives from the graphene and graphite solutions was observed, which was stored under 50° C. in an incubator. Powder part of sample separated and stayed at bottom of the container; 0.1% and 0.5% of S-SP used in sample did act to prevent separation under heat conditions; 0.1% of S-KS also prevented the separation of the graphene and graphite. Other ratio of additives failed to prevent separation, making additional layer in the compositions. Both separated parts were re-mixable using a mixer.

After 2 months, the 0.1% and 0.5% SSP, and 0.1% S-KS containing samples showed stability of mixing under heat at 50° C. degrees. Then those 3 weight percentages of shelf life additives (of samples 4, 5, and 7) were added into full compositions based on composition 51, as delineated above. The 0.1% SKS-containing composition showed paint stability after a month (see samples 4, 5, 7 (0.1% S-KS) under ‘After a Month’; FIG. 2).

### Example 3A—Basic Method for Preparing a Composition for a Coating

Pilot Scale

Diluted mixture of Epoxy-functional monomers preparation:
1) Make sure that vessel and High Shear Mixer (HSM) are clean and valves are closed, set HSM to UP position
2) Tare scale
3) Add correct amount of Benzyl Alcohol according to product specification
4) Tare the scale again
5) Add requested amount of alkyl glycidyl ether (AGE) in the vessel following the product specification recipe
6) Tare the scale
7) Add required amount of Epoxy-based resininto the mixture slowly due high viscosity of the material
8) Set the mixer to DOWN position and make sure that the head of the HSM is completely immersed into the mixture
9) Set 4000 RPM and mix at least 20 minutes, make sure that the mixture is completely homogeneous
10) Observe if there are bubbles in the mixture, if yes keep the diluted mixture of epoxy-functional monomers (diluted resin) under rest for 1 hour until degassing process is completed.

Composition for a Coating Preparation:
1) Make sure that the diluted resin is completely free of bubbles
2) Confirm that HSM head is immersed into the diluted resin
3) Using a laboratory scale, weight necessary amount of epoxy-functionalized silane and add into the diluted resin
4) Set 5000 RPM and turn the HSM ON then mix at least 5 minutes
5) Take note of the mixture temperature using the infrared (IR) thermometer
6) After 5 minutes, turn the mixer OFF
7) Using a laboratory scale and weigh required amount of dispersant VWX 6208, and add into the mixture
8) Set 5000 RPM and turn the HSM ON then mix at least 5 minutes
9) Take note of the mixture temperature using the IR thermometer
10) After 5 minutes, turn the mixer OFF
11) Using laboratory scale weigh correct amount of graphene nanoplatelets and graphite flakes separately
12) Set 1000 RPM and turn the HSM ON
13) Using a suction wand, add the amount graphene nanoplatelets and graphite flakes into the solution
14) Make sure the graphene nanoplatelets and graphite flakes are mixed well into the solution
15) Once added, set 5000 RPM to the HSM and mix at least for 15 minutes
16) Take note of the mixture temperature using the IR thermometer
17) Turn the HSM OFF
18) Using laboratory scale, weigh necessary amount of defoamer VXW 6210N and add into the composition
19) Set 5000 RPM and turn the HSM ON
20) Take note of the mixture temperature using the IR thermometer
21) After 5 minutes turn the HSM OFF
22) Using laboratory scale, weigh necessary amount of BYK-Silclean and add into the composition
23) Set 5000 RPM and turn the HSM ON to mix at least for 5 minutes
24) Take note of the mixture temperature using the IR thermometer
25) After 5 minutes turn the HSM OFF
26) Set the HSM to the UP position
27) Be ready to put the composition for a coating into cans using bottom valve.

### Example 3B—a Method for Preparing a Composition for a Coating Comprising Epoxy-Functional Epoxide-Slioxane Monomers

| Method steps: Formulation 208-Si | | | |
|---|---|---|---|
| # Part A, | | | |
| component | Component | %, wt. | %, vol. |
| 1A | Hybrid epoxy-siloxane resin | 30-40% | 30-40% |
| | (Silikopon ED) | | |
| 2A | Defoamer - Tego Airex 900 | 0.5-1% | 0.5-1% |
| 3A | Dispersant - K-Sperse A504 | 0.5-1% | 0.5-1% |
| 4A | Methyl acetate | 1-2% | 1-5% |

Mix 10 mins @ 1.0 krpm, use disk impeller (Cowles, 1-20 hp)

| | | | |
|---|---|---|---|
| 5A | Titanium Dioxide | 20-30% | 1-10% |
| 6A | Fumed silica | 1-2% | 1-2% |

Grind 25 mins @ 5.0 krpm, use disk impeller(Cowles, 1-20 hp)

| | | | |
|---|---|---|---|
| 7A | Organo-modified derivative of | 1-2% | 1-2% |
| | castor oil | | |

Hold at 55-60 C. for 10 minutes, grind

| | | | |
|---|---|---|---|
| 8A | Ca Magnesium Silicate | 1-5% | 0.5-1% |
| | (talc, filler) | | |
| 9A | Fluorohydroxylalkylated | 1-5% | 1-5% |
| | dimethyl siloxane oligomer | | |

Grind 10 mins @ 3.0 krpm, use disk impeller (Cowles, 1-20 hp)

| | | | |
|---|---|---|---|
| 10A | Hybrid epoxy-siloxane resin | 10-20% | 30-40% |
| | (Silikopon ED) | | |
| 11A | Methyl acetate | 1-5% | 1-5% |
| 12A | Epoxy-functional | 1-5% | 1-5% |
| | polydimethylsiloxane | | |
| 13A | Hydroxyalkyl-modified | 10-20% | 10-20% |
| | polydimethylsiloxane | | |
| | oligomer | | |

Letdown 10 mins @ 1.0 krpm, use disk impeller (Cowles, 1-20 hp)

| | | | |
|---|---|---|---|
| # Part B, | | | |
| component | | | |
| 1B | Aminopropyltriethoxysilane | 100.00% | 100.00% |

### Example 4—Basic Comparison of a Cured Epoxy-Based Coating Versus a Control Coating

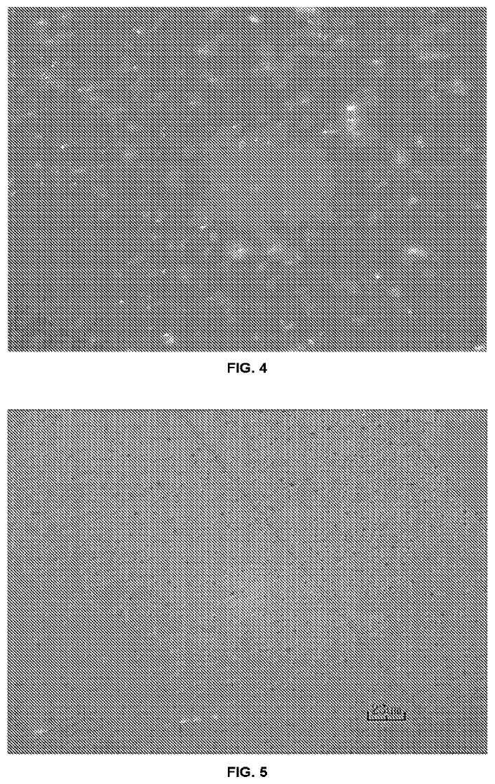

FIG. 3 depicts the microstructure of a cured coating of present disclosure. FIG. 3 depicts the porosity and defect-free nature of the coating's surface (coating comprises 5 wt % graphite flakes (10 microns flake size) and 0.3 wt % of Graphene nanoplatelets (sample with all additives and components). FIG. 4 depicts a 1000× magnification of FIG. 3.

In contrast. FIG. 5 depicts the microstructure of a control epoxy-based coating, under magnification from an optical microscope. The micro-porosity (black holes) present in the surface of the coating allows oxygen diffusion, and can therefore expose a substrate to corrosion over time.

Methods: Coating method is by brushing. Cold rolled carbon steel substrate (white metal sandblasted) for all samples and results showed. The figures depict characteristic microstructures obtained with different compositions as observed by different methods.

FIG. 3—Confocal microscope/optical microscope combined: Magnification lens 5×. Depicts the uniformity of a coating derived from above-described composition 43, and that there is also no bumps, peaks, or valleys. Depicts a uniform coated surface with a uniform graphene dispersion (small white flakes), with the little black holes being pores.

FIG. 4—Optical microscope: Magnification Lens 100×. Depicts a coating derived from above-described composition 64, and that there is homogeneity, that the coating is porous free, and that there is dispersion of graphene nanoplatelets.

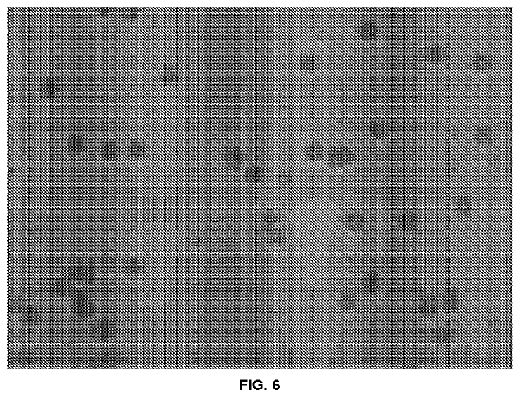

FIGS. 5 and 6—50 and 100× magnification lens. Depicts a coating derived from above-described composition 75, having about 10% of the surface area covered by porosity (which reduces corrosion resistance, but may not be an issue for applications where corrosion is not necessary). 10% porosity is not suitable for corrosion protection purposes.

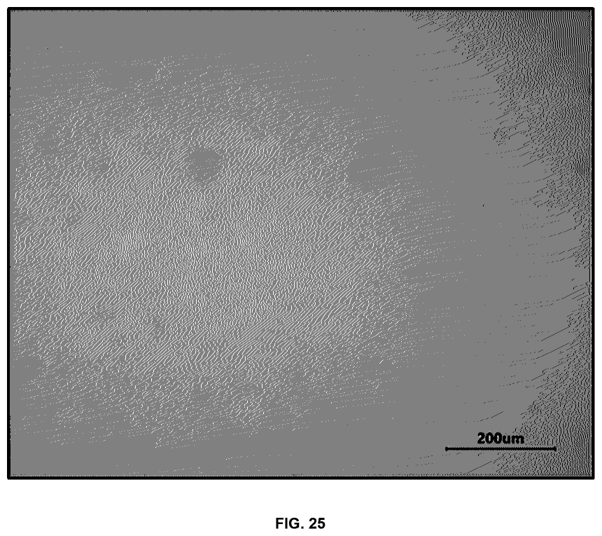

FIG. 25—Optical microscope: Magnification Lens 10×. Depicts a coating derived from above-described composition 206-Si, and that the coating appears porous free, with a smooth and slick surface.

Degree of porosity can be determined by counting: the number of pores; the size of the pores under the microscope. A surface is considered to have a high porosity if more than 10% of the total surface being analyzed is porous. Factors that control and/or impact porosity include: viscosity (air entrapment); reactions that produce gases; VOC entrapment; bubbles that become naturally incorporated during mixing of the epoxy resin and hardener (use of a defoamer can help to mitigate this by “pushing the air bubbles out”; and VOC content creates a pathway for entrapped air to come out of the coating).

### Example 5—FTIR Study of Pre-Cured Composition and Hardener and Cured Coating

Methods

FTIR (Dalhouse University—Dentistry Campus) was used to manipulate samples and analyze cured coatings, liquid components, and solid components to acquire spectra results. The spectra data was acquired using the following settings—X axis: Wavenumber (1/cm) and Y axis: Absorbance (Abs). In addition, the software Spectragryph v1.2 (Free trial version) was used to interpret the FTIR spectra. Considerations: environment temperature of the laboratory was 23° C., a total of 27 samples were run including solid (dried coating), powder additives, liquid additives and liquid coating.

Results

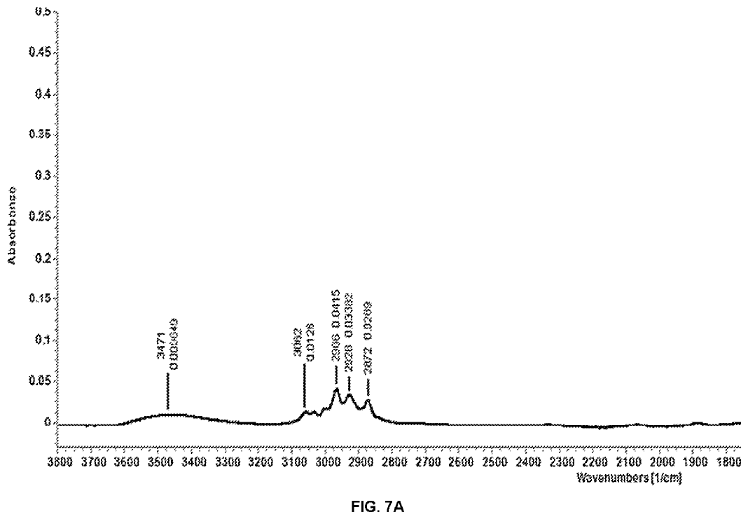

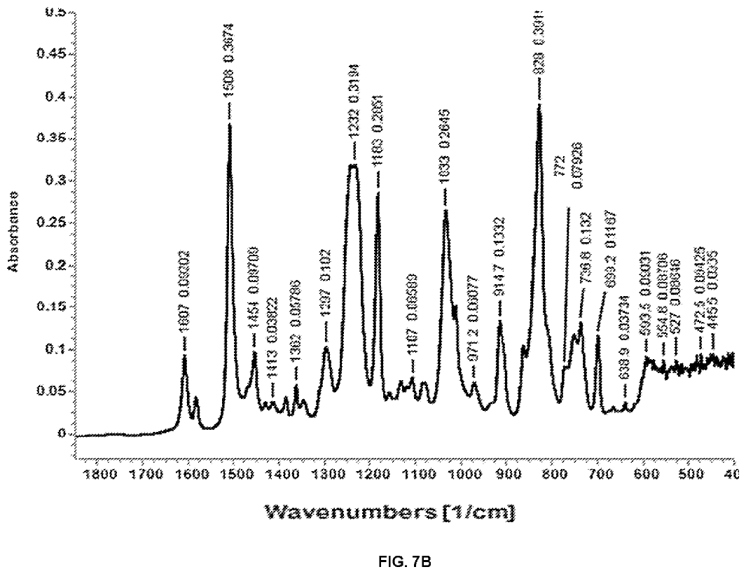

Epoxy Resin: FTIR spectrum of a particular resin was gathered to analyze the main functional group and chemical bond that characterized the resin. There are some studies that correlates the peak at 915 cm⁻¹ as the deformation of C—O bond from the oxirane group (C—O—C Epoxy ring). The most important reactions for the cure of epoxy resins involve either electrophilic attack on the oxygen atom or nucleophilic attack on one of the ring carbon atoms. This bond disposition improves the reactivity due its high strain. The different electronegativity of carbon and oxygen makes the carbon atoms of the ring to be electrophilic. Thus epoxides can perform ring opening reactions towards nucleophiles. The polarity of the oxirane ring makes possible detection by FTIR spectroscopy, as FIG. 7 depicts the main peaks and its corresponding position of absorption band (Absorbance vs Wavenumber (cm⁻¹)). Table 1.0B lists the main peaks of the FTIR spectrum as depicted in FIG. 7, and the related chemical bonds, that were used to identify which functional groups belonged to the epoxy resin, and thereby identify the resin. The FTIR spectra interpretation suggested that the specific epoxy resin compound was the oligomer diglycidylether of bisphenol A (DGEBA) (2,2-Bis[4-(glycidyloxy)phenyl] propane), which is commonly used as a polyepoxy resin use as surface protective coatings—which consumes about 50% of all epoxy resins produced.

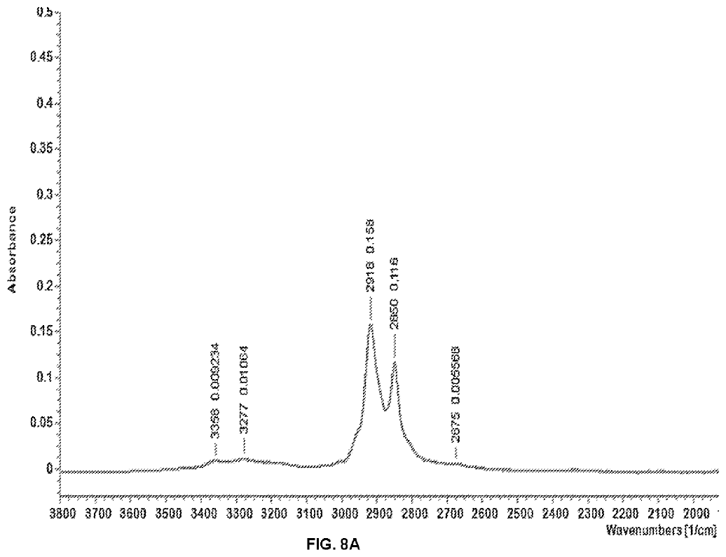

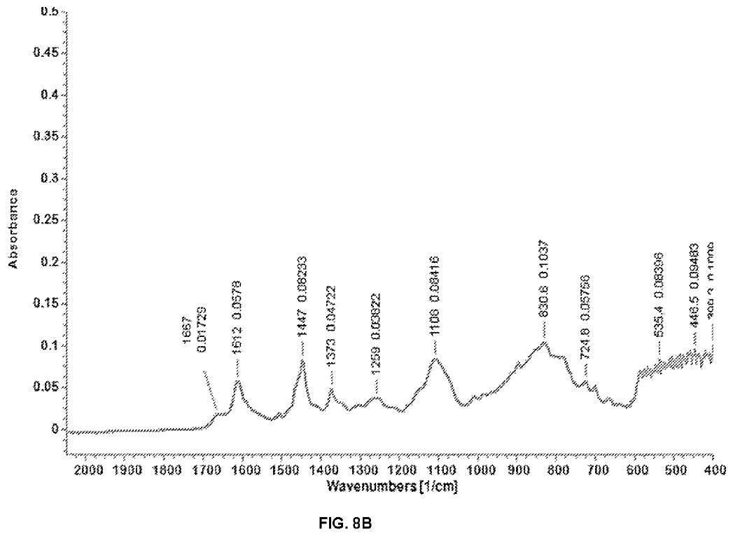

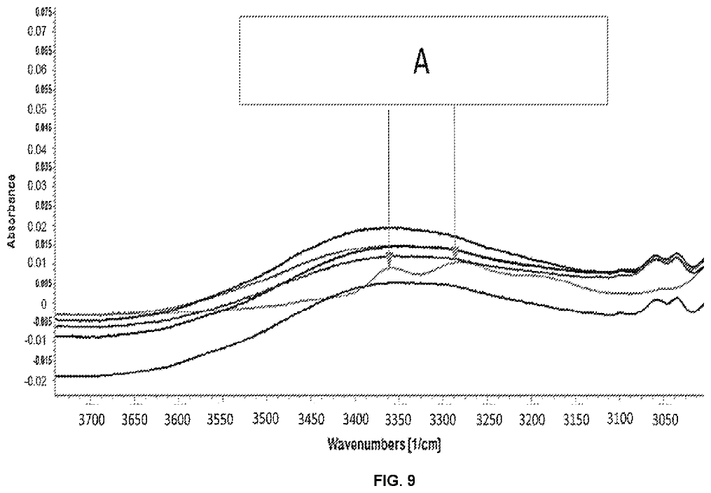

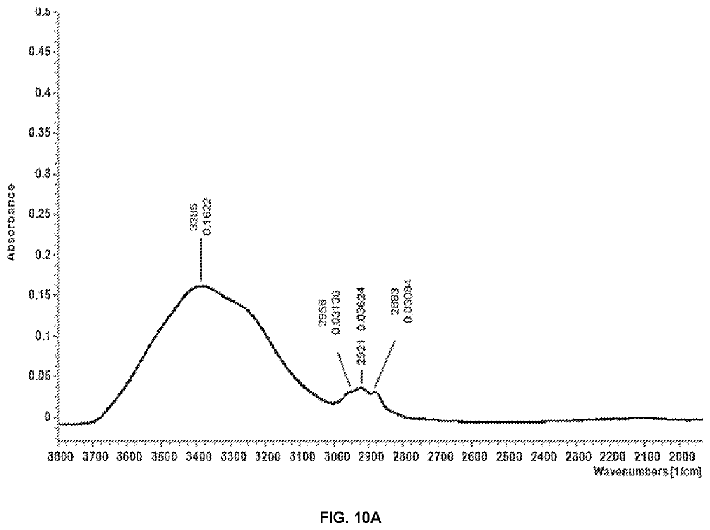

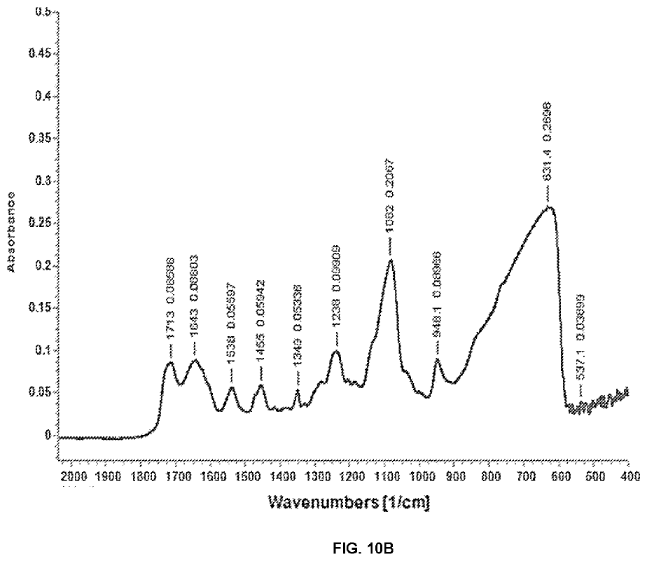

Hardener: FTIR spectra depicted in FIG. 8 shows peaks related to a type of hardener, the crosslinker or curing agent used to react with polyepoxy resins. The reaction generally involves formation of a rigid 3D network due a high rate of crosslink formation (high reactivity between the epoxy group and the the nucleophilic group from the hardener compound). The most common hardeners have more than two reactive functional groups, that means functionality is f>2, often f≥4. According to the literature, the mechanism of curing can occur by homopolymerisation initiated by a catalytic curing agent or a polyaddition/copolymerisation reaction with a multifunctional curing agent as well. There is a wide range of curing agents types that are commercially available, the most common hardeners includes amines (Aliphatic, Cycloaliphatic, Aromatic), polyamides and carboxylic acid functional polyesters. Table 2 lists the main peaks of the hardener functional groups. Amines functional groups are common substances used as hardener for epoxy resin. According to literature, FTIR characterizes stretching vibration of N—H bonds originally from amine groups at range of 3300-3500 cm⁻¹. In this case, two weak peaks were found to be —NH₂, —NH due stretching vibrations at 3358 and 3277 cm⁻¹. Unfortunately, the wavenumber range that determine O—H bonds in the cured system was located at a similar range of —NH₂, —NH forming a overlay and hiding the N—H bond of the cured coating compound as shown in FIG. 9. FTIR analysis showed a wn range between 2918-2850 cm⁻¹ that indicated a C—H stretching vibration, the presence of the aliphatic chain in the hardener could be seen. The hardener characterization using FTIR was not completed, as the low absorption signal of the N—H bond made evaluation more difficult. Usual hardeners are amine based. In this case, the hardener can be a mixture of amine, polyamide-based, and fatty acid long chain due the probable presence of the C═O bond at absorption peak 1667 cm⁻¹. Additional research and tests can be done to check the Hardener compound, with some information from the supplier as well. The following information gives common requirements for amine identification in FTIR spectra: primary and secondary amines give absorptions of moderate strength in the 3300-3500 cm⁻¹ region. Primary amines exhibit two peaks in this region due to symmetric and asymmetric stretching of the two N—H bonds. Secondary amines exhibit a single peak.

AV3 Additive (Additol VXW 6208): In the FTIR spectrum (FIG. 10, Table 3) of AV3 Additive there was a OH (hydroxyl) absorption centered around 3385 cm⁻¹ when the hydroxyl peak was extremely broad and C—O peak at 1082 cm⁻¹. Also, there were three peaks in the region between 2883 and 2956 cm⁻¹ which indicated the presence of C—H (alkyl). The relatively weak absorption peak of C═O at 1713 cm⁻¹ suggested a carbonyl functional group from the carboxylic acid with long C—H chain (fatty). The AV3 Additive seemed to be an alcohol due the OH absorption strength at 3385 cm⁻¹. It is possible that isolated carbonyl and hydroxyl groups could be present in the molecule, suggesting that this substance may be a mixture of alcohol and fatty organic acid. Hydroxyl groups may catalyse the reaction between hardener and epoxy groups. This can be important for the kinetics of cure with amine hardeners. (AV3=OH Catalyst).

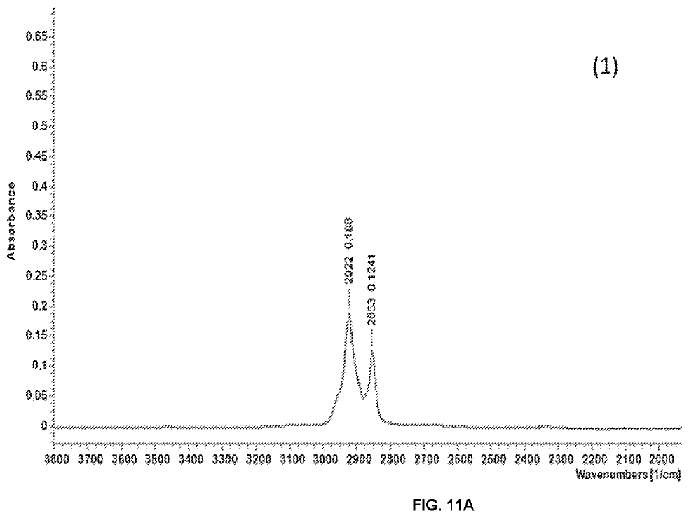

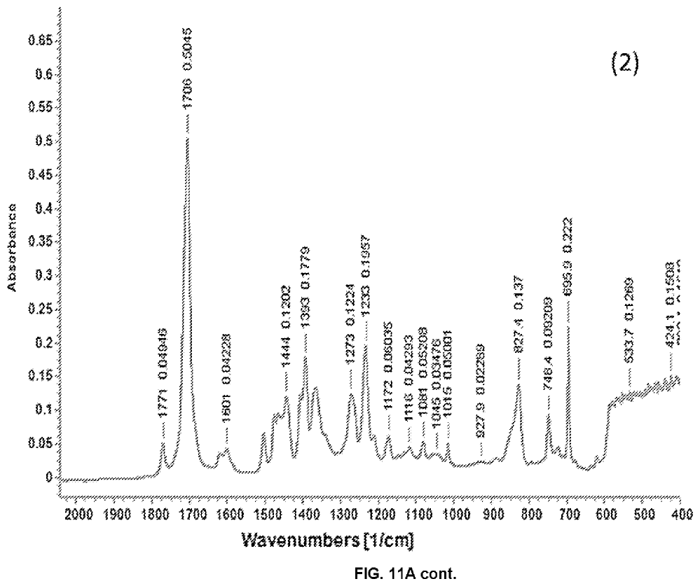

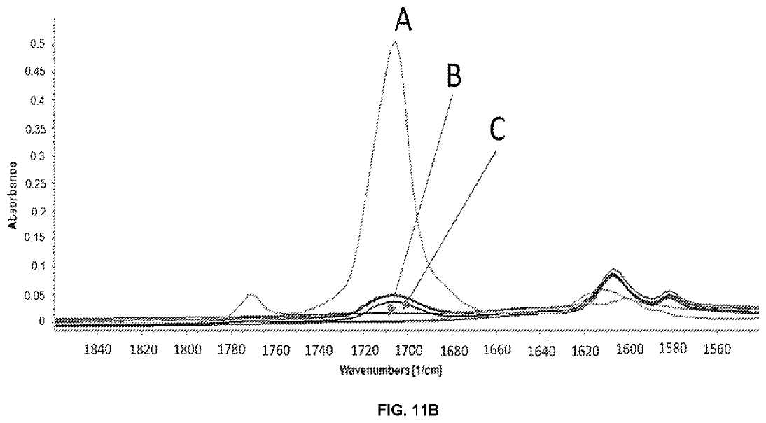

BMI 1700 Additive: This is a low molecular weight bismaleimide oligomer that helps to improve adhesion between a coating and a variety of substrates. According to supplier information, this compound improves toughness and hydrophobicity in the cross-linked systems. The FTIR spectrum (FIG. 11A, Table 4) showed that at absorption band between 2922-2853 cm⁻¹ there was a C—H bond from the alkyl group of the molecule. There was a strong peak at 1706 cm⁻¹ which indicated a C═O bond. The absorption band of the C—O bond was found at the range between 1275-1020 cm⁻¹. Regarding the BM11700 additive, a spectrum comparison between different pre-cured compositions demonstrated that this additive was not added into the above-described compositions 42 and 48, while the compared, above-described compositions 112-BMI, 113-BMI, 107-BMI matched with the band at 1706 cm⁻¹ related to the C═O bond (FIG. 11B).

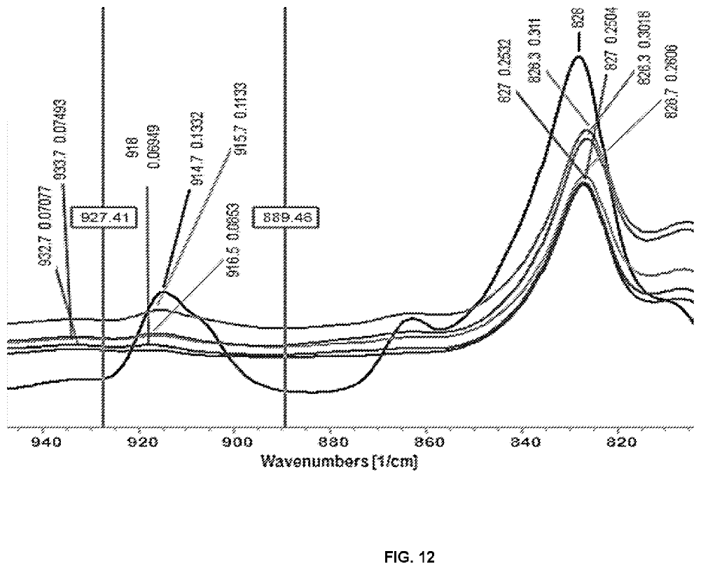

Residual Evaluation of Polyepoxy Resin in Coatings: FIG. 12 depicts the peak for the C—O bond from the oxirane group present in the polyepoxy resin; the C—O deformation band is centered at −915 cm⁻¹. Considering the chemical reactions and crosslinking formation, the concentration of epoxy groups can be monitored according time evolution. In this specific case, the time was neglected to compare the conversion rate of the epoxy group to identify the best composition with the lowest amount of unreacted epoxy group amount in the cured coating. According to the FTIR analysis, considering an integration in the wavenumber range between 927.41 and 889.46, composition 113-BMI showed the lowest result of integrated area in comparison to the other coating compositions (42; 48; 112-BMI; 107-BMI). The integration area of the C—O bond at ˜915 cm⁻¹ demonstrated the area of the spectrum of composition 113-BMI was lower than others, which suggested that a higher amount of the oxirane group reacted to produce the crosslinked 3D chain in the cured coating. The average result at this specific integrated area was 0.07, while the result of the integrated area for composition 113-BMI was 0.000267, meanwhile the compositions 42 and 112-BMI presented similar average results which suggested a higher amount of the oxirane group remained unreacted, and a lower conversion of the C—O bond. There were other differences between the compositions that could be evaluated in the FTIR spectrum, and one of them was the hardener residual amount that could not be evaluated in this case due the OH absorption overlay mentioned above (Hardener). The comparison between epoxy resin and final epoxy-based coating depicted a clear method to quantify and evaluate the curing rate and residual amounts.

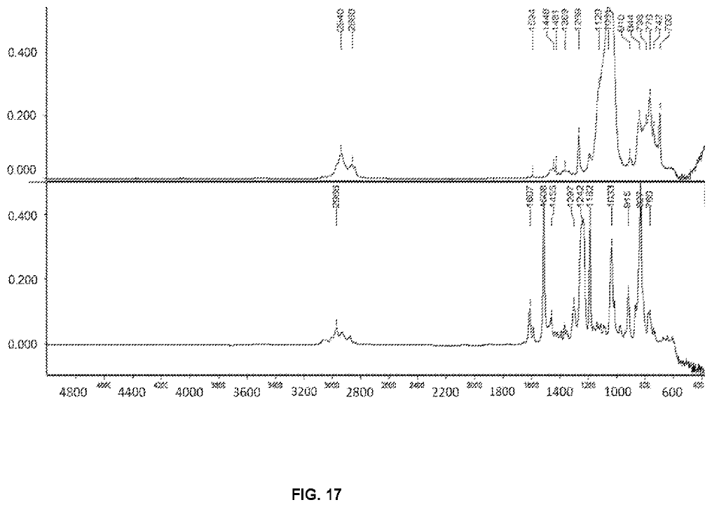

Also see FIGS. 17-18, 22-24, and Table 1.0A, and Table 7.

### Example 6—Example of Applying Herein Described Curing Compositions

Section 1. Product Description

The following describes an example application of a two-component epoxy-based coating formulated to provide protection against corrosion and marine biofouling, suitable for application on fiberglass, steel, aluminum, copper, wood, plastics, primers, and tie coats.

Section 2. Surface Preparation

The surface was cleaned with acetone (or similar solvent) and wiped with a clean cloth to remove any contaminants such as oil, grease, and dust. It was ensured the surface was dry, and then the surface was sanded with 80 grit sandpaper. For steel surfaces, said surface was sanded or grinded until bright metal was visible. For surfaces that were already coated, any peeling or flaking material was removed and the remainder sanded down with 80 grit sandpaper. Dust that resulted from the surface preparation was removed. The dust was disposed of according to local environmental and health & safety regulations. Appropriate protective equipment was used, such as filtered breathing masks, goggles, etc. when preparing the surface.

Section 3. Application/Composition Information

| | |
|---|---|
| Recommended temperature range | 0° C. (60° F.) to 25° C. (77° F.) |
| Pot life at 21° C. (70° F.) | 30 min |
| Time to recoat | 6 hours-1 day |
| Curing time at 21° C. (70° F.) | 20 hours |

Constituents of Component A*:

| | | Concen- | Common |
|---|---|---|---|
| | | tration | name/ |
| Chemical Name | CAS No. | (%) | Synonyms |
| 2,2-Bis(4- | 1675-54-3 | 60-100 | |
| glycidyloxyphenyl)propane | | | |
| Benzyl alcohol | 100-51-6 | 10-30 | |
| Graphite | 7782-42-5 | 0.1-10 | Few-layered |
| | | | graphene |
| Metal content | 12190-70-4 | 5-20 | |

*Not all constituents listed

Constituents of Component B*:

| | | Concentration |
|---|---|---|
| Chemical Name | CAS No. | (%) |
| Cashew, nutshell liq. Polymer with | 68413-29-6 | >90 |
| diethylenetriamine and formaldehyde | | |
| N-(2-Aminoethyl)-1,2-ethanediamine | 111-40-0 | <10 |

*Not all constituents listed

Component A was combined with component B, using a 2.7:1 weight ratio of A:B or mixing one glass can (hardener) with one aluminum can (paint). Only as much coating as could be applied in 20 minutes was combined. At higher temperatures, the coating cured more quickly. When the two components were combined, they reacted exothermically, producing heat. Larger volumes of the coating generated more heat, and therefore had a shorter pot life. The coating was applied using brush, roller, or airless sprayer.

Section 4. Safety

Appropriate and well-fitting personal protective equipment (PPE) was worn when applying. Appropriate PPE included safety glasses, a filtered air mask with cartridges suitable for volatile organics, gloves, and clothing that covered the arms and legs. Paint coveralls were worn during painting to protect clothing and hair from exposure to the paint.

Section 5. Airless Sprayers

The recommended minimum pressure was 3000 psi. The recommended minimum tip size was 0.017 in (0.432 mm). All airless spray equipment was purged and cleaned within 20 minutes of loading the equipment with the product. The spray pattern was tested on a piece of cardboard before applying the coating to the surface. Spraying began at the lowest pressure setting and with a brief triggering of the spray gun. The spray pattern was checked for gaps, and the pressure was gently increased until the gaps disappeared. If the gaps remained, the tip was checked for blockages. If there were no blockages, the coating was thinned with a small quantity of an appropriate thinner and the process was repeated. When spraying, the spray gun was held perpendicular to the surface and the gun was moved in a smooth line, maintaining a perpendicular angle for the entire sweep. Tilting the spray gun side to side was avoided while spraying.

Section 6. Multiple Coats

The coating was allowed to cure until it was touch-dry but still tacky (6 hours −1 day at room temperature) before the next coat was applied. Once the coating cured completely (thumbnail hard, no deformation when touched) it was sanded with 80 grit sandpaper before another coating was applied.

### Example 7—Scratch Resistance Testing

Pencil hardness test (ASTM D3363) is a simple method to quantify and grade abrasive resistance of marine coating technologies.

With the Pencil hardness test, a ‘minor scratch’ result meant that the pencil left a graphite marking without doing physical damage to the integrity of the coating, or left a slight indentation when applied. A ‘major scratch’ result meant visible damage was done to the coating upon application of the pencil (for example, cracking, delamination, grooving, etc.); and/or the substrate surface was exposed by the pencil and the coating failed shortly after the major scratch was landed (for example, due to corrosion).

As part of the test, pencils were moved at a fixed pressure of 750 g and a contact angle of 45° relative to a coated panel.

Formulations #43 and 206-Si (see formulation tables of Example 1 above) showed no visible damage at a pencil hardness of 9H.

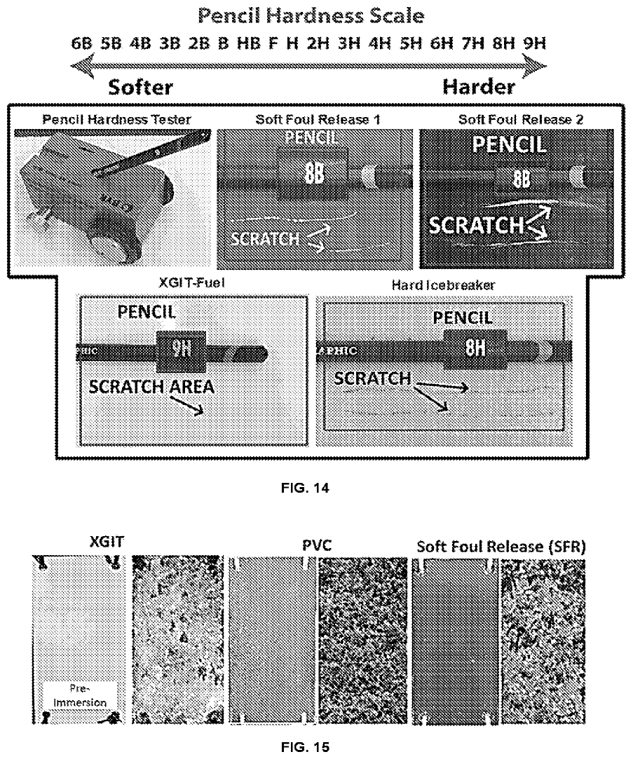

In contrast, the commercial marine coatings all exhibited scratches. There was a relatively minor scratch on the “hard icebreaker” coating (Ecospeed Hydrex) when scratched using a pencil hardness of 8H; and relatively major scratches on each of the soft foul release systems (Intersleek IS1100 SR and Hempaguard, respectively) when scratched using a pencil hardness of 8B (the softest pencil lead available). See FIG. 14.

Intersleek 1100SR, is an amphiphilic siloxane based coating that contains fluoro-modified hydroxyl-containing silicone oils (for example, a triglyciryde which has siloxane chains instead of the aliphatic chains). The hardness (hence durability) of this product was found to be significantly lower than that of the tested compositions of the present disclosure (pencil hardness of 8H vs 6H), suggesting that cured epoxy-based coatings of the present disclosure technology may combine the benefits of amphiphilicity-modifying additives while being free of the softness-related issues of such systems.

### Example 8—Static Biofouling Growth and Surface Cleaning Performance Tests

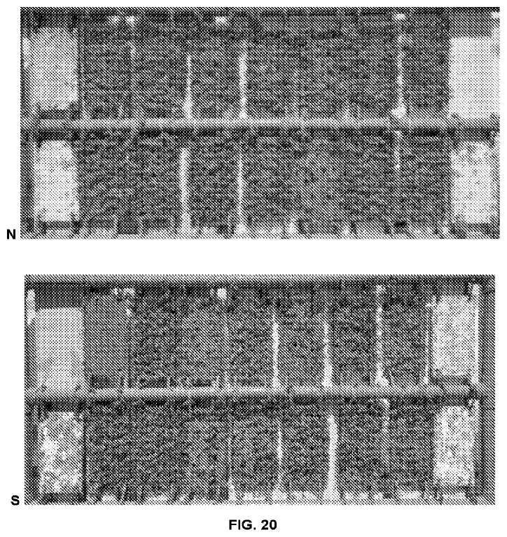

Cleanability of the epoxy-based coatings of the present disclosure was investigated via a series of tests conducted at the Centre for Corrosion & Biofouling Control at the Florida Institute of Technology. See FIG. 15 depicting results for composition 206-Si (XGIT) relative to controls (PVC, SFR); and see FIG. 20 depicting results for compositions #1, 43, 206-Si (XGIT), 300, 301 relative to controls (PVC, SFR); legend provided below.

In respect of FIG. 15: Panels coated with the epoxy-based coatings of the present disclosure (see FIG. 15, XGIT; composition 206-Si) were left stationary for a period of 1 month (left in ocean, port waters, Florida at temperatures from 5 to 25° C.) and then cleaned using a water jet with a controlled pressure gauge. Panels coated with (i) PVC, and (ii) a soft foul release system (SFR; Intersleek 1100SR, an amphiphilic siloxane based coating that contains fluoro-modified hydroxyl-containing oils, as described in Example 7) were used as negative controls, and subjected to the same tests; see FIG. 15, PVC and SRF).

In respect of FIG. 20: Depicted are the results of a 1 month static biofouling test performed in Florida (January/February). A total of 5 different formulas were tested, each deployed in triplicate. A positive control (Intersleek 1100SR) and negative (polyvinyl chloride) plates were tested alongside the tested compositions #1, 43, 206-Si (XGIT), 300, 301 (from Example 1 above). FIG. 20 shows that the composition 206-Si was characterized with lower fouling rates compared to the other samples, including the positive control IS 1100SR. Both sides of each sample was analyzed visually and using a software (for example Image J) to estimate fouling rate, ensuring the factor of the geo-positioning (facing north or south) was also taken into account.

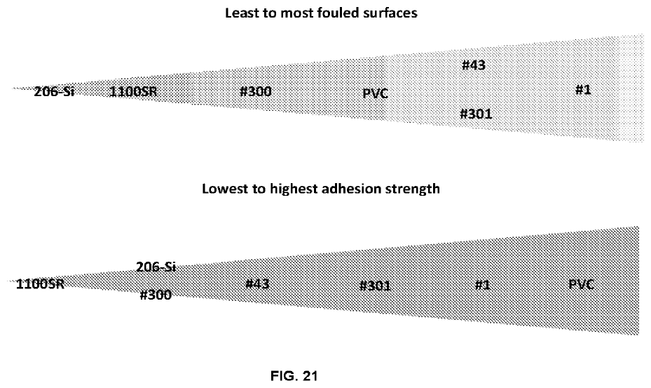

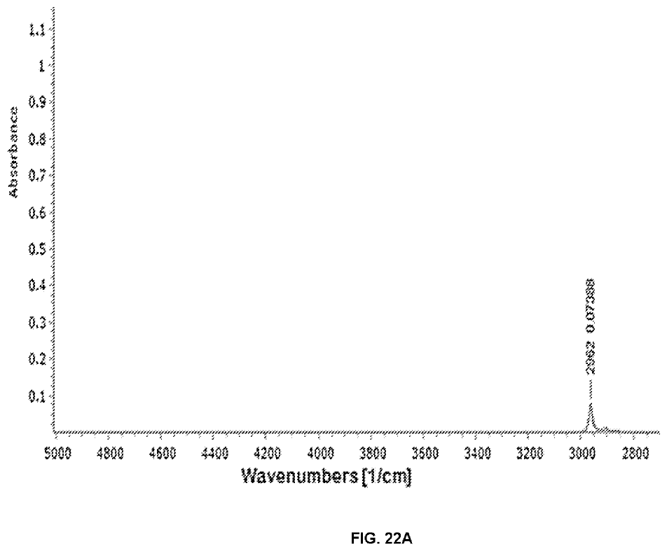

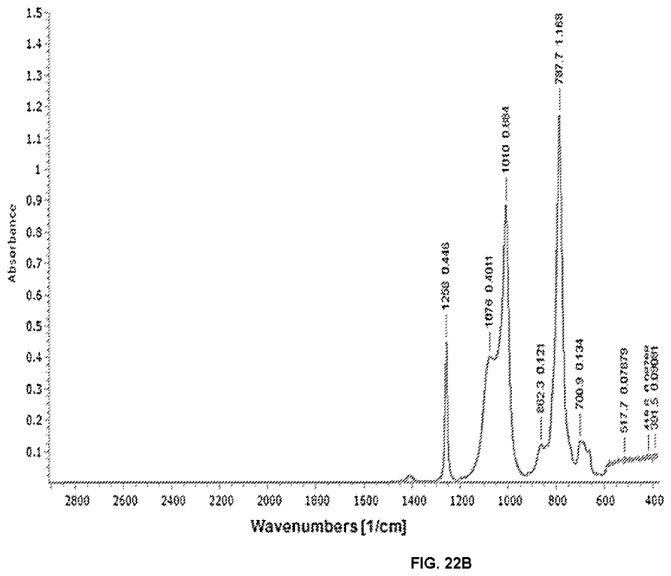

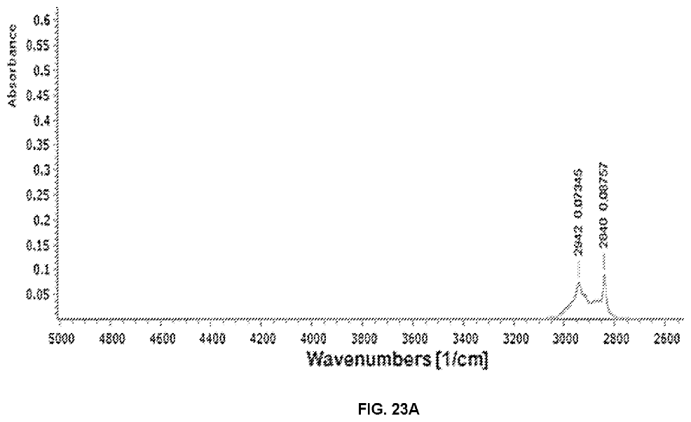

FIG. 21 graphically depicts the fouling results of FIG. 20, as well as fouling adhesion strength. All panels were cleaned using a water pressure gun at varying pressure, the pressure value required to remove 95% of the bio-fouling being recorded for each sample. The higher pressure required to clean the panel, the lower its cleanability and higher the adhesion of bio-fouling to the panel. Compositions 206-Si and #300 were found to provide good results in both inhibiting fouling growth, and cleanability, alongside Intersleek 1100SR.

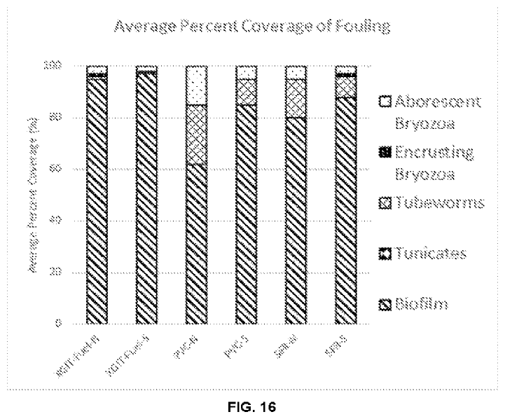

Further, FIG. 16 displays an average percent coverage of each species of biofouling the North (-N) and South (-S) facing panels were exposed to for the stationary period (see FIG. 16, XGIT-N/S, PVC-N/S, SFR-N/S). This includes, biofilm, tunicates, tubeworms, encrusting bryozoan, aborescent bryozoan, where tubeworms are amongst the more problematic biofouling specifies for, for example, marine vessels.

Tables 5.0 and 6.0 show a comparative analysis of different marine coating types (SFR, SPC, Hard Ceramic/Ultra-Hard) versus the epoxy-based coatings of the present disclosure (XGIT; composition 206-Si) based on their cleanability and antifouling performance. The results illustrate the robustness and foul resistant properties of the epoxy-based coatings of the present disclosure as cleanable hard-foul release topcoats. The coatings may provide fuel savings through their low hull roughness, low fouling adhesion, and improved ability to undergo cleaning and maintenance. The achieved fuel savings using the epoxy-based coatings of the present disclosure may lower the cost to ship-owners, decrease their environmental impact, and decrease operational costs.

Legend of FIG. 20:

N-Side of the rack facing North
(Going left to right, panels 0-9):

| | 0 | 1 | 2 | 3 | 4 | 5 | 6 | 7 | 8 |
|---|---|---|---|---|---|---|---|---|---|
| Top | 206- | #43 | #1 | #301 | #43 | #300 | #1 | PVC | Empty |
| | Si | | | | | | | | |
| Bottom | 206- | #300 | #301 | #43 | #300 | IS | #1 | #301 | 206- |
| | Si | | | | | 1100SR | | | Si |

S-Side of the rack facing South (Going left to right, panels 0-9):

| | 0 | 1 | 2 | 3 | 4 | 5 | 6 | 7 | 8 |
|---|---|---|---|---|---|---|---|---|---|
| Top | Empty | IS | #1 | #300 | #43 | #301 | #1 | #43 | 206- |
| | | 1100SR | | | | | | | Si |
| Bottom | 206- | #301 | #1 | PVC | #300 | #43 | #301 | #300 | 206- |
| | Si | | | | | | | | Si |

TABLE 1.0A
Main FTIR peaks of epoxy-function epoxide-siloxane monomers and
functional amphiphillic additives-fingerprint peaks and bandwidths.

| Band, cm⁻¹ | Bond | Function |
|---|---|---|
| 1260 | 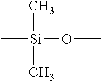 | Si—CH₃ group recognized by a strong, sharp band at about 1260 cm⁻¹. |
| 865-750 | 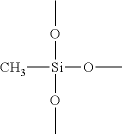 | Recognized by one or more strong bands in the range 865-750 cm⁻¹. |
| 845 | 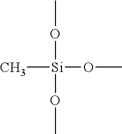 | In many copolymers containing dimethyl D units (random or alternative, not block), the 860 cm⁻¹ band shifts to 845 cm⁻¹ and becomes stronger. |
| 1130-1000 | Si—O—Si | Siloxanes show one or more very strong infrared |
| | | bands in the region of 1130-1000 cm⁻¹. As the |
| | | siloxane chains become longer or branched, the |
| | | Si—O—Si absorption becomes broader and more |
| | | complex, showing two or more overlapping bands. |
| 1080-1040 | Si—CH2—Si | The disilylmethylene band is strong and sharp. The |
| | | sharpness helps distinguish it from Si—O—Si bands. |

TABLE 1.0B
Main FTIR peaks of Epoxy Resin
Polyepoxy Resin

| Seq | Band (cm⁻¹) | Function |
|---|---|---|
| 1 | 3471 | Phenyl O—H stretching vibration (slight sharp |
| | | band), |
| 2 | 3062 | C—H Stretching (oxirane ring) |
| 3 | 2966-2872 | C—H of CH2 and CH aromatic and aliphatic |
| | | Stretching |
| 4 | 1607 | C═C Stretching (aromatic rings) |
| 5 | 1508 | C—C Stretching (aromatic rings) |
| 6 | 1033 | C—O—C Stretching (ether) |
| 7 | 915 | C—O Stretching (oxirane group) |
| 8 | 828 | C—O—C Stretching (oxirane group) 1,4- |
| | | substitution of ar-ring |

TABLE 2.0
Main FTIR peaks of Hardener
Hardener/Curing Agent

| Seq | Band (cm⁻¹) | Function |
|---|---|---|
| 1 | 3300-3500 | N—H Stretching (amine or amide group) |
| 2 | 2918-2850 | C—H Stretching (aliphatic chain) —CH2 and |
| | | —CH3 |
| 3 | 1667 | C═O Stretching (if polyamide) |
| 4 | 1108 | C—O Stretching - C—N group |
| 5 | 1612 | N—H Bending (from primary or secondary |
| | | amine or amide) |

TABLE 3.0
Main FTIR peaks of AV3 Additive

| Seq | Band (cm⁻¹) | Function |
|---|---|---|
| 1 | 3385 | O—H Stretching (Alcohol) |
| 2 | 2883-2956 | C—H Stretching (Alkyl) |
| 3 | 1643-1713 | C═O Streching (weak) |
| 4 | 1082 | C—O Stretching (Alcohol) |

TABLE 4.0
Main FTIR peaks of BMI 1700 Additive
BMI 1700 Additive

| Seq | Band (cm⁻¹) | Function |
|---|---|---|
| 1 | 2922-2853 | C—H (Stretching) |
| 2 | 1706 | C═O (Stretching) strong |
| 3 | 1020-1275 | C—O (stretching) |

TABLE 5.0
Comparative analysis of epoxy-based coatings of the present disclosure (XGIT)
and marine coatings based on their cleanability and antifouling performance

| | | | Biocidal/ | Ultra Hard/ |
|---|---|---|---|---|
| | | Soft Foul | Ablative SPC | Ceramic |
| | (XGIT; 206-Si) | Release | Antifouling | Coating |
| Biocide or | None | Silicone oil | Cuprous oxide, | None |
| Leaching | | | Zinc oxide | |
| Material (ASTM | | | | |
| D6903-07) | | | | |
| Ability to Clean | Yes | Yes | No, depends | Yes |
| in Port*** | | | on port | |
| | | | jurisdiction | |
| Static | 4% - Hard | 15% - Hard | No data | No data |
| Immersion at | fouling | fouling | | |
| CCBC | | | | |
| (Average | | | | |
| Surface % | | | | |
| Coverage) | | | | |
| Suitable Hull | Plastic | Water-jets | Not | Special tooling |
| Cleaning | Scrapers, water- | | recommended | required for the |
| Equipment | jets, ROV | | | underwater |
| | (brush, jets) | | | cleaning |
| Maintenance & | A layer of primer | A layer of | A layer of | One layer |
| Repair | and a topcoat | primer, tie-coat | primer and a | required |
| | optional | and a top-coat | topcoat | |
| | | is required | required | |
| Applied | 10 KPa - brush | 10 KPa - brush | 10KPa - brush | N/A |
| Cleaning Force | 3000 KPa - jet | 1000 KPa - jet | | |
| (CCBC, | | | | |
| Florida) | | | | |
| Paint Damage | Jets - no visible | Jets - no | N/A | Polishing effect |
| and | damage | visible damage | | as a result of |
| Roughness | Brushes - no | Brush - | | mechanical |
| Post-Cleaning | damage | mechanical | | cleaning |
| (ASTM F941) | | damage | | |
| Pencil | >8H | 6B | 2H | >8H |
| Hardness | | | | |
| (ASTM D3363) | | | | |

TABLE 6.0
Comparative analysis of epoxy-based coatings of the present disclosure (XGIT)
and marine coatings based on their cleanability and antifouling performance

| | | Hard Foul | | |
|---|---|---|---|---|
| | Soft Foul | Release | Biocidal/Ablative | |
| | Release | (XGIT; 206- | SPC Antifouling | Hard/Ceramic |
| | Coating | Si) | Coating | Coating |
| Biocide or | Silicone oil | None | Cuprous oxide, | None |
| Leaching | | | Zinc oxide | |
| Material | | | | |
| Ability to | Able | Able | Unable, depends | Able |
| clean in | | | on the port | |
| port*** | | | jurisdiction | |
| Dry film | Negligible | Negligible | Approx. 20% per | Negligible |
| thickness loss | | | annum | |
| Repairs | Patchwork, a | Patchwork, a | Patchwork, a | Patchwork, one |
| | layer of | layer of primer | layer of primer | layer required |
| | primer, tie- | and a topcoat | and a topcoat | |
| | coat and a | optional | required | |
| | top-coat is | | | |
| | required | | | |
| 1-month | 85% - biofilm | 96% - biofilm | 100% - biofilm | No data |
| Static | 15% - hard | 4% - hard | | |
| Immersion | fouling | fouling | | |
| (average | | | | |
| surface % | | | | |
| coverage) | | | | |
| Grooming | Water-jets | Scrapers, | Not | Scrapers, |
| mode/ | | water-jets, | recommended | water-jets, |
| equipment | | ROV (brush, | | ROV (brush, |
| | | jets) | | jets) |
| | | | | Note: special |
| | | | | tooling required |
| | | | | for the |
| | | | | underwater |
| | | | | cleaning |
| Fouling | 100% | 100% | 100% | 100% |
| removal | | | | |
| efficiency | | | | |
| Equipment | Negligible | Negligible | Minor wear-off | Minor wear-off |
| wear-off | | | (ROV brushes) | (ROV brushes |
| Compatibility | Needs a tie- | Compatible | Compatible | Compatible |
| with Epoxy- | coat | | | |
| primer | | | | |
| Applied | 10 KPa - brush | 10 KPa - brush | 10KPa - brush | N/A |
| cleaning force | 1000 KPa - jet | 3000 KPa - jet | | |
| (CCBC, | | | | |
| Florida) | | | | |
| Paint damage | Jets - no | Jets - no | N/A | Polishing effect |
| and | visible | visible | | as a result of |
| roughness | damage | damage | | mechanical |
| post-cleaning | Brush - | Brushes - no | | cleaning |
| | mechanical | damage | | |
| | damage | | | |
| Adhesion | Adhesion: | Adhesion: ca. | Adhesion: N/A | 17 MPa |
| strength | 1 MPa | 5 MPa to | | |
| | | epoxy primer | | |
| | | 7 MPa to | | |
| | | blasted steel | | |
| Pencil | 6B | >8H | 2H | >8H |
| Hardness | | | | |
| (ASTM D3363) | | | | |

TABLE 7.0
Main FTIR peaks of FIGS. 7-8, 10, 11A, 12, 17-18, 22-24
FIG. 7-FTIR peaks (relative peak areas provided in brackets):
3471 (0.0096); 3092 (0.0126); 2966 (0.0415); 2928 (0.0338); 2872 (0.0269); 1607
(0.0920); 1508 (0.3674); 1454 (0.0970); 1413 (0.0382); 1392 (0.0679); 1297
(0.102); 1232 (0.3194); 1183 (0.2851); 1107 (0.0659); 1033 (0.2645); 971 (0.0677);
914 (0.1332); 826 (0.3911); 772 (0.079); 736 (0.132); 699 (0.116); 639 (0.0373);
554 (0.087); 527 (0.086)
FIG. 8-FTIR peaks (relative peak areas provided in brackets):
3358 (0.0092); 3277 (0.0106); 2918 (0.158); 2850 (0.116); 2875 (0.0057); 1667 (0.0173);
1612 (0.0578); 1447 (0.0823); 1373 (0.0472); 1259 (0.0382); 1108 (0.0842); 830
(0.1037); 724 (0.0576); 535 (0.0837)
Fig 10-FTIR peaks (relative peak areas provided in brackets):
3385 (0.1622); 2965 (0.0314); 2921 (0.0362); 2883 (0.0306); 1713 (0.0859); 1643
(0.0880); 1538 (0.0559); 1455 (0.0594); 1349 (0.0534); 1238 (0.0990); 1082 (0.2067);
948 (0.069); 631 (0.2698)
Fig 11A-FTIR peaks (relative peak areas provided in brackets):
2922 (0.188); 2853 (0.1241); 1771 (0.0495); 1706 (0.5045); 1601 (0.0423); 1444
(0.1202); 1393 (0.1779); 1273 (0.1224); 1233 (0.1957); 1172 (0.0603); 1116 (0.0429);
1081 (0.0520); 1045 (0.0347); 1015 (0.05); 827 (0.137); 748 (0.092); 695 (0.222)
FIG.12-FTIR peaks (relative peak areas provided in brackets):
932 (0.0707); 933 (0.0749); 918 (0.0894); 914 (0.1332); 915 (0.1133); 916 (0.0853);
827 (0.2533); 826 (0.311); 828; 827 (0.2504); 826 (0.3018); 826 (0.2606)
FIG. 17-FTIR peaks:

| Top Spectrum: | Bottom Spectrum: |
|---|---|
| 2940; 2860; 1594; 1448; 1431; 1369; | 2966; 1607; 1508; 1455; 1297; 1242; |
| 1269; 1129; 1061; 910; 844; 798; 770; | 1182; 1033; 915; 827; 760 |

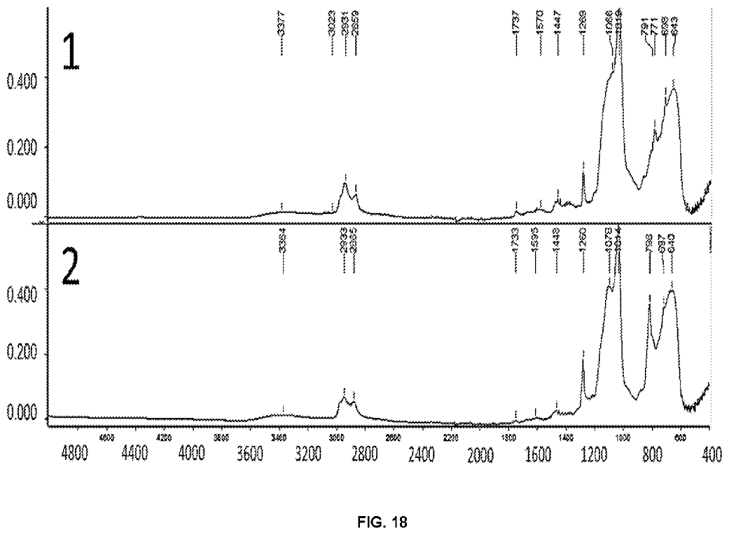

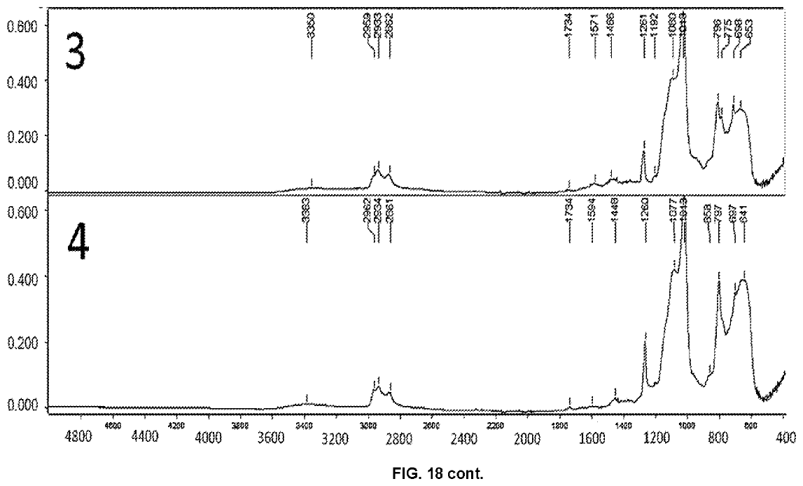

FIG. 18-FTIR peaks:

| #1: | #2: | #3: | #4: |
|---|---|---|---|
| 3377, 3023, | 3364, 2933, | 3350, 2959, | 3383, 2962, 2934, |
| 2931, 2859, | 2865, 1733, | 2933, 2862, | 2861, 1734, 1594, |
| 1737, 1570, | 1595, 1448, | 1734, 1571, | 1448, 1260, 1077, |
| 1447, 1269, | 1260, 1078, | 1466, 1261, | 1013, 858, 797, |
| 1066, 1019, | 1014, 796, 697, | 1192, 1080, | 697, 641 |
| 791, 771, 696, | 640 | 1018, 796, 775, | |
| 643 | | 698, 653 | |

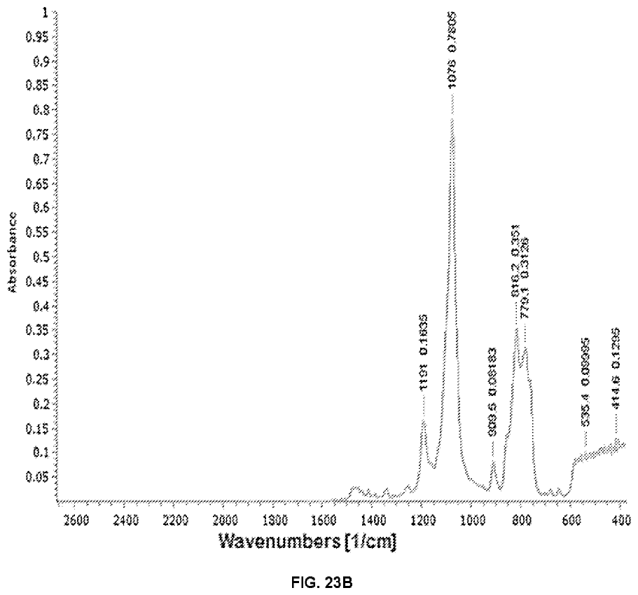

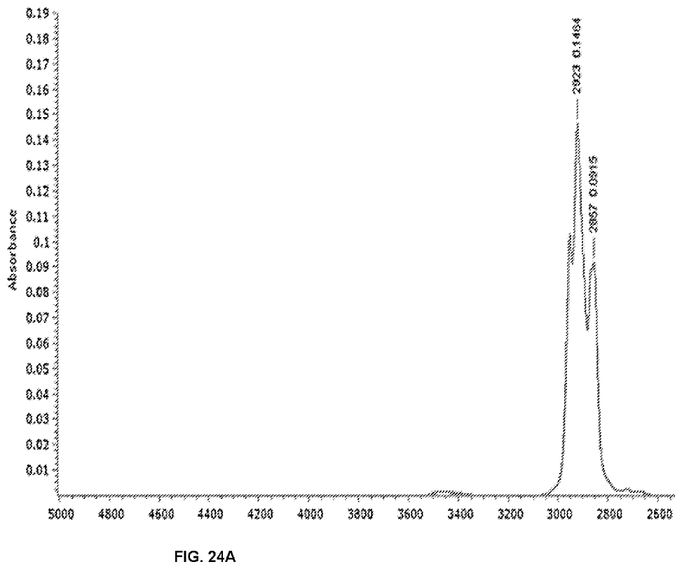

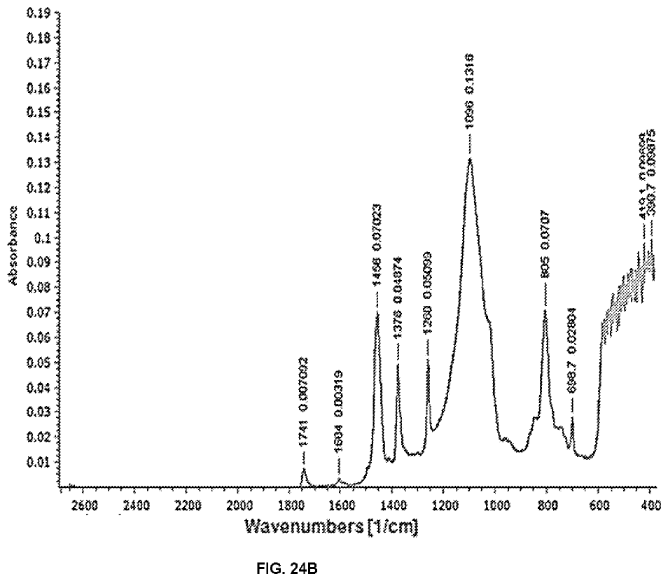

FIG. 22-FTIR peaks (relative peak areas provided in brackets):
2962 (0.0739); 1258 (0.446); 1076 (0.401); 1010 (0.884); 862 (0.121); 787.7 (1.168),
700 (0.134); 517 (0.078)
FIG. 23-FTIR peaks (relative peak areas provided in brackets):
2942 (0.0735), 2840 (0.0876), 1191 (0.1635), 1076 (0.7805), 909 (0.0818), 816 (0.351),
779 (0.3126), 535 (0.1)
FIG. 24-FTIR peaks (relative peak areas provided in brackets):
2923 (0.1464), 2857 (0.0915), 1741 (0.0071), 1604 (0.0032), 1456 (0.0702), 1376
(0.0487), 1260 (0.051), 1096 (0.1316), 805 (0.0707), 698 (0.0280)

The embodiments described herein are intended to be examples only. Alterations, modifications and variations can be effected to the particular embodiments by those of skill in the art. The scope of the claims should not be limited by the particular embodiments set forth herein, but should be construed in a manner consistent with the specification as a whole.

All publications, patents and patent applications mentioned in this Specification are indicative of the level of skill those skilled in the art to which this invention pertains and are herein incorporated by reference to the same extent as if each individual publication patent, or patent application was specifically and individually indicated to be incorporated by reference.

The invention being thus described, it will be obvious that the same may be varied in many ways. Such variations are not to be regarded as a departure from the spirit and scope of the invention, and all such modification as would be obvious to one skilled in the art are intended to be included within the scope of the following claims.

What is claimed is:

1. A composition for a coating, comprising:
epoxy-functional monomers;
a diluent; and
a sufficient amount of a hydrophobicity-modifying additive that is reactive in an epoxide polymerization to provide a coating formed from the composition having a contact angle of at least 90° when measured with an Ossila Goniometer following ASTM D7334-08(2013).

2. The composition of claim 1, further comprising a sufficient amount of a wear-inhibiting additive to provide a coating formed from the composition having improved corrosion resistance of at least 1000 hours when measured by salt fog resistance, an increased mechanical strength with a D-shore hardness of at least 40D, or a bending strength of at least 10 mm when measured by a cylindrical bed test.

3. The composition of claim 1 or 2, further comprising a sufficient amount of an amphiphilicity-modifying additive to provide a coating formed from the composition having a wet coefficient of friction of ≤0.2 when measured using an ASM 925 COF meter following ASTM D2047.

4. The composition of claim 2 or 3, further comprising at least one dispersant for dispersing the wear-inhibiting additive in the composition.

5. The composition of any one of claims 1 to 4, further comprising at least one defoamer.

6. The composition of any one of claims 1 to 5, further comprising at least one rheological additive.

7. The composition of any one of claims 1 to 6, wherein the epoxy-functional monomers comprise:
bisphenol diglycidyl ethers;
epoxy-functional epoxide-siloxane monomers;
a reaction product of epichlorohydrin and one or more of hydroxyl-functional aromatics, alcohols, thiols, acids, acid anhydrides, cycloaliphatics and aliphatics, polyfunctional amines, and amine functional aromatics;
a reaction product of the oxidation of unsaturated cycloaliphatics; or
a combination thereof.

8. The composition of any one of claims 1 to 7, wherein the epoxy-functional monomers comprise:
bisphenol diglycidyl ethers;
epoxy-functional epoxide-siloxane monomers; or
a combination thereof.

9. The composition of claim 7 or 8, wherein the bisphenol diglycidyl ethers are derived from bisphenol A, bisphenol F, bisphenol S, or a combination thereof.

10. The composition of any one of claims 7 to 9, wherein the epoxy-functional epoxide-siloxane monomers comprise an epoxide backbone comprising siloxane or polysiloxane side-chains.

11. The composition of claim 10, wherein the epoxide backbone is a polyether backbone.

12. The composition of claim 10 or 11, wherein the siloxane or polysiloxane side-chain are linear, branched, or crosslinked.

13. The composition of any one of claims 10 or 12, wherein at least one of the siloxane or polysiloxane side-chains is a cross-linked silicone resin.

14. The composition of any one of claims 7 to 13, wherein the epoxy-functional epoxide-siloxane monomers comprise a reaction product of isocyanate and/or polyurethane oligomers, silane oligomers, and epoxy oligomers.

15. The composition of any one of claims 7 to 14, wherein the epoxy-functional epoxide-siloxane monomer comprises an epoxy-functional epoxide-siloxane pre-polymer.

16. The composition of any one of claims 7 to 15, wherein the epoxy-functional epoxide-siloxane monomer comprises a 3-ethylcyclohexylepoxy copolymer modified with dimethylsiloxane side-chains, an epoxy bisphenol A (2,2-Bis(4′-glycidyloxyphenyl)propane) modified with the poly-dimethylsiloxane side-chains, a siloxane modified hybrid epoxy resin, a siliconeepoxide resin, an epoxy-functional epoxide-backbone functionalized with a crosslinked silicone resin comprising terminal alkoxy groups, or a combination thereof.

17. The composition of any one of claims 7 to 16, wherein the epoxy-functional epoxide-siloxane monomer comprises Silikopon® ED, Silikopon® EF, EPOSIL Resin 5550®, or a combination thereof.

18. The composition of any one of claims 1 to 17, wherein the diluent comprises a reactive diluent that is reactive in an epoxide polymerization, a non-reactive diluent, or a combination thereof.

19. The composition of claim 18, wherein the diluent is reactive as a curing catalyst.

20. The composition of claim 18 or 19, wherein the reactive diluent comprises poly[(phenyl glycidyl ether)-co-formaldehyde], alkyl (C12-C14) glycidyl ether, phenyl glycidyl ether, butyl glycidyl ether, 2-ethylhexyl glycidyl ether, o-cresol glycidyl ether, cycloaliphatic glycidyl ether, dipropylene glycol n-propyl ether, dipropylene glycol dimethyl ether, or a combination thereof.

21. The composition of claim 20, wherein the reactive diluent comprises poly[(phenyl glycidyl ether)-co-formaldehyde],alkyl (C12-C14) glycidyl ether, or a combination thereof.

22. The composition of any one of claims 18 to 21, wherein the reactive diluent comprises the hydrophobicity-modifying additive.

23. The composition of any one of claims 18 to 22, wherein the non-reactive diluent comprises xylene, methyl acetate, methyl ethyl ketone, nonyl phenol, cyclohexanedimethanol, n-butyl alcohol, benzyl alcohol, isopropyl alcohol, propylene glycol, phenol, or a combination thereof.

24. The composition of claim 23, wherein the non-reactive diluent comprises benzyl alcohol, xylene, methyl acetate, methyl ethyl ketone, or a combination thereof.

25. The composition of any one of claims 1 to 24, wherein the hydrophobicity-modifying additive comprises at least one Si-based additive, at least one fluoro-based additive, at least one maleimide-based additive, or a combination thereof.

26. The composition of any one of claims 1 to 25, wherein the hydrophobicity-modifying additive comprises at least one Si-based additive, at least one maleimide-based additive, or a combination thereof.

27. The composition of claim 25 or 26, wherein the hydrophobicity-modifying additive comprises a bis-maleimide oligomer, an epoxy-functional silane, an epoxy-functional polydialkylsiloxane, or a combination thereof.

28. The composition of claim 27, wherein the hydrophobicity-modifying additive comprises an epoxy-functional silane, an epoxy-functional polydialkylsiloxane, or a combination thereof.

29. The composition of claim 27 or 28, wherein the hydrophobicity-modifying additive comprises an epoxy-functional polydialkylsiloxane.

30. The composition of any one of claims 25 to 29, wherein the bis-maleimide oligomer comprises BMI 689, BMI 737, BMI 1100, BMI 1400, BMI 1500, BMI 1700, or a combination thereof.

31. The composition of any one of claims 25 to 30, wherein the bis-maleimide oligomer comprises BMI 1400, BMI 1500, BMI 1700, or a combination thereof.

32. The composition of claim 31, wherein the BMI 1400, BMI 1500, or BMI 1700 is present in a range of about 10 wt % to about 20 wt %.

33. The composition of any one of claims 25 to 32, wherein the epoxy-functional silane comprises glycidoxypropyltrimethoxysilane.

34. The composition of claim 33, wherein the glycidoxypropyltrimethoxysilane is present in a range of about 0 wt % to about 6 wt %, or in a range of about 1 wt % to about 2 wt %.

35. The composition of any one of claims 25 to 34, wherein the epoxy-functional polydialkylsiloxane comprises epoxy-functional polydimethylsiloxane.

36. The composition of claim 35, wherein the epoxy-functional polydimethylsiloxane is present in a range of about 0.05 wt % to about 10 wt %, or in a range of about 0.5 wt % to about 8 wt %.

37. The composition of any one of claims 25 to 36, wherein the at least one fluoro-based additive comprises poly(3,3,3-trifluoropropylmethylsiloxane), or a fluoroalkylated acrylate oligomer, or a combination thereof.

38. The composition of claim 37, wherein the fluoroalkylated acrylate oligomer comprises Sartomer® CN4002.

39. The composition of claim 37 or 38, wherein the fluoroalkylated acrylate oligomer is present in a range of about 0.05 wt % to about 5 wt %, or about 0.05 wt % to about 3 wt %.

40. The composition of any one of claims 25 to 39, wherein the sufficient amount of the hydrophobicity-modifying additive provides a coating formed from the composition having a contact angle of about 90° to about 130°, or about 90° to about 120°, about 95° to about 120°, about 100° to about 120°, or about 100° to about 115°.

41. The composition of claim 2, or any one of claims 3 to 40 when dependent on claim 2, wherein the wear-inhibiting additive comprises unmodified graphene nanoplatelets, unmodified graphite flakes, carbon black, fullerene, titanium dioxide, aluminum oxide, Ca magnesium silicate, zinc oxide, or a combination thereof.

42. The composition of claim 41, wherein the wear-inhibiting additive comprises unmodified graphene nanoplatelets, unmodified graphite flakes, titanium dioxide, aluminum oxide, Ca magnesium silicate, or a combination thereof.

43. The composition of claim 41 or 42, wherein the unmodified graphene nanoplatelets have a flake size of at least 3 μm; or about 3 μm to about 50 μm; or about 5 μm to about 10 μm.

44. The composition of any one of claims 41 to 43, wherein the unmodified graphene nanoplatelets are present in a range of about 0.05 wt % to about 5 wt %; or about 0.3 wt %.

45. The composition of any one of claims 41 to 44, wherein the unmodified graphite flakes have a flake size of at least 3 μm; or about 3 μm to about 50 μm; or about 10 μm to about 20 μm.

46. The composition of any one of claims 41 to 45, wherein the unmodified graphite flakes are present in a range of about 0.1 wt % to about 10 wt %; or about 5 wt %.

47. The composition of any one of claims 41 to 46, wherein the titanium dioxide, aluminum oxide, or Ca magnesium silicate, or combination thereof are present in a range of about 5 wt % to about 30 wt %; or about 10 wt % to about 25 wt %; or about 5 wt % to about 10 wt %.

48. The composition of any one of claims 41 to 47, wherein the sufficient amount of the wear-inhibiting additive provides a coating formed from the composition having improved corrosion resistance of about 1500 hours to about 8500 hours, or about 4000 hours to about 7000 hours when measured by salt fog resistance; or an increased mechanical strength with a D-shore hardness of about 65D to about 90D, or about 65D to about 85D, or about 70D to about 80D.

49. The composition of claim 3, or any one of claims 4 to 48 when dependent on claim 3, wherein the amphiphilicity-modifying additive comprises a polyether, a polysiloxane, a polyelectrolyte, a polyatomic alcohol, or a combination thereof.

50. The composition of claim 49, wherein the polyether comprises a polyalkylene glycol.

51. The composition of claim 50, wherein the polyalkylene glycol is present in a range of about 0.5 wt % to about 10 wt %, or about 1 wt % to about 5 wt %.

52. The composition of claim 50 or 51, wherein the polyalkylene glycol comprises polyethylene glycol, polyethylene glycol 400, LIPOXOL® 400, or a combination thereof.

53. The composition of any one of claims 49 to 52, wherein the polysiloxane comprises a hydroxyl-functionalized polysiloxane, a hydroxyalkyl-functionalized polysiloxane, a fluorohydroxyalkyl-functionalized polysiloxane, or a combination thereof.

54. The composition of claim 53, wherein the polysiloxane is present in a range of about 1 wt % to about 20 wt %, or about 5 wt % to about 15 wt %.

55. The composition of claim 53 or 54, wherein the polysiloxane comprises Silmer® OHT Di-10, Silmer® OHT Di-50, Silmer® OHT Di-100, Silmer® OHFB10, or a combination thereof.

56. The composition of any one of claims 49 to 55, wherein the polyelectrolyte comprises an ammonium-functionalized polysiloxane.

57. The composition of claim 56, wherein the ammonium-functionalized polysiloxane. comprises a dialkyl quaternary ammonium modified-polysiloxane.

58. The composition of claim 56 or 57, wherein the polyelectrolyte is present in a range of about 0.5 wt % to about 10 wt %, or about 1 wt % to about 5 wt %.

59. The composition of any one of claims 56 to 58, wherein the polyelectrolyte comprises Silquat®3180.

60. The composition of any one of claims 49 to 59, wherein the polyatomic alcohol comprises glycerol.

61. The composition of claim 60, wherein the polyatomic alcohol is present in a range of about 0.5 wt % to about 10 wt %, or about 1 wt % to about 5 wt %.

62. The composition of claim 49 to 61, wherein the sufficient amount of the amphiphilicity-modifying additive provides a coating formed from the composition having a wet coefficient of friction when measured using an ASM 925 COF meter following ASTM D2047 of about 0.05 to about 0.2; or about 0.05 to about 0.15; or about 0.06 to about 0.11; or about 0.08 to about 0.12.

63. The composition of claim 4, or any one of claims 5 to 62 when dependent on claim 4, wherein the at least one dispersant is a polymeric dispersant.

64. The composition of claim 63, wherein the polymeric dispersant is Additol VXW 6208, Soldplus D610, K-Sperse A504, or a combination thereof.

65. The composition of claim 63 or 64, wherein the polymeric dispersant is present in a range of about 0.1 wt % to about 5 wt %.

66. The composition of claim 5, or any one of claims 6 to 65 when dependent on claim 5, wherein the defoamer comprises a silicone-modified defoamer.

67. The composition of claim 66, wherein the silicone-modified defoamer comprises Additol VXW 6210N, BYK-A 530, Tego Airex 900® or a combination thereof.

68. The composition of claim 67, wherein the silicone-modified defoamer comprises Additol VXW 6210N.

69. The composition of claim 67 or 68, wherein the Additol VXW 6210N is present in a range of about 0.5 wt % to about 6 wt %.

70. The composition of any one of claims 67 to 69, wherein the silicone-modified defoamer comprises Tego Airex 900®.

71. The composition of claim 70, wherein the Tego Airex 900® is present in a range of about 0.05 wt % to about 2 wt %.

72. The composition of claim 6, or any one of claims 7 to 71 when dependent on claim 6, wherein the at least one rheological additive comprises a fumed silica, a castor oil derivative; bentonite, montmorillonite, a modified montmorillonite clay; or a combination thereof.

73. The composition of claim 72, wherein the castor oil derivative, bentonite, montmorillonite, modified montmorillonite clay, or combination thereof is present in a range of about 0.01 wt % to about 3 wt %.

74. The composition of claim 72 or 73, wherein the castor oil derivative is Thixatrol ST®.

75. The composition of any one of claims 1 to 74, further comprising a hardener, the hardener being reactive in curing the composition to form a coating.

76. The composition of claim 75, wherein the hardener comprises an amine hardener, an amide hardener, or a combination thereof.

77. The composition of claim 75 or 76, wherein the amine hardener, amide hardener, or combination thereof comprises: a reaction product of triethylenetetramine with phenol and formaldehyde and polyethylenepolyamines; polyamide; triethylenetetramine and polyoxypropylenediamine; polyether amine; polyamine; phenalkamine and polyamide; phenalkamine; or a combination thereof.

78. The composition of any one of claims 75 to 77, wherein the amine hardener comprises primary amine-modified phenalkamine, benzyl dimethylamine, N,N-di-(2-hydroxyethyl)aniline, triethanolamine, aminopropyltriethoxysilane, bis(3-triethoxysilylpropyl)amine, or a combination thereof.

79. The composition of claim 75 or 76, wherein the hardener comprises an silamine hardener.

80. The composition of claim 79, wherein the silamine hardener comprises aminopropyltriethoxysilane (Andisil 1100), bis(3-triethoxysilylpropyl)amine (Dynasylan 1146), or N-2-aminoethyl-3-aminopropyltrimethoxysilane (Dynasylan DAMO), or a combination thereof.

81. The composition of any one of claims 75 to 80, wherein the hardener comprises a low-temperature hardener.

82. The composition of claim 81, wherein the low-temperature hardener comprises phenalkamine.

83. The composition of any one of claims 75 to 82, wherein the hardener further comprises a curing catalyst.

84. The composition of claim 83, wherein the curing catalyst comprises a low-temperature curing catalyst.

85. The composition of claim 83 or 84, wherein the curing catalyst comprises 2,4,6-tris[(dimethyllamino)methyl]phenol, benzyl dimethylamine (BDMA), imidazole, N,N-di-(2-hydroxyethyl)aniline, 2,4,6-tris[(dimethyllamino)methyl]phenol, triethanolamine, or a combination thereof.

86. The composition of any one of claims 1 to 85, wherein the composition is a solvent-borne composition.

87. The composition of any one of claims 1 to 86, wherein the composition is free of elastomeric monomers, pre-polymers, or resins; and/or epoxy-functional elastomeric monomers, pre-polymers, or resins.

88. The composition of claim 87, wherein the composition is free of elastomeric monomers, pre-polymers, or resins, and/or epoxy-functional elastomeric monomers, pre-polymers, or resins that comprise, or consist essentially of butenes, polybutenes, butadienes, polybutadienes, nitrites acrylonitiriles, polysulfides, urethanes, urethane-modified resins (for example, urethane-modified epoxy resins), or combinations thereof.

89. A reaction product of the composition of any one of claims 1 to 74 and 86 to 88, and a hardener.

90. Use of a composition for a coating of any one of claims 1 to 88 for forming a coating on a substrate.

91. The use of claim 90, wherein the substrate is a surface of marine equipment, or a marine vessel, such as a boat or ship.

92. A kit comprising a composition for a coating of any one of claims 1 to 88 and instructions for use.

93. A kit comprising a composition for a coating of any one of claims 1 to 74 and 86 to 89, and instructions for use with a hardener.

94. The kit of claim 93, further comprising a hardener.

95. The kit of claim 94, wherein the hardener comprises an amine hardener, an amide hardener, or a combination thereof; for example, wherein the amine hardener, amide hardener, or combination thereof comprises: a reaction product of triethylenetetramine with phenol and formaldehyde and polyethylenepolyamines; polyamide; triethylenetetramine and olyoxypropylenediamine; polyether amine; polyamine; phenalkamine and polyamide; phenalkamine; or a combination thereof.

96. The kit of claim 94 or 95, wherein the amine hardener comprises primary amine-modified phenalkamine, benzyl dimethylamine, N,N-di-(2-hydroxyethyl)aniline, triethanolamine, aminopropyltriethoxysilane, bis(3-triethoxysilylpropyl)amine, or a combination thereof.

97. The kit of claim 94, wherein the hardener comprises an silamine hardener; for example, wherein the silamine hardener comprises aminopropyltriethoxysilane (Andisil 1100), bis(3-triethoxysilylpropyl)amine (Dynasylan 1146), or N-2-aminoethyl-3-aminopropyltrimethoxysilane (Dynasylan DAMO), or a combination thereof.

98. The kit of any one of claims 94 to 96, wherein the hardener comprises a low-temperature hardener, such as phenalkamine.

99. The kit of any one of claims 94 to 98, wherein the hardener further comprises a curing catalyst.

100. The kit of claim 99, wherein the curing catalyst comprises a low-temperature curing catalyst, such as 2,4,6-tris[(dimethyllamino)methyl]phenol.

101. A coating comprising a reaction product of a composition for a coating of any one of claims 1 to 74 and 86 to 88 and a hardener.

102. The coating of claim 101, wherein the hardener comprises an amine hardener, an amide hardener, or a combination thereof; for example, wherein the amine hardener, amide hardener, or combination thereof comprises: a reaction product of triethylenetetramine with phenol and formaldehyde and polyethylenepolyamines; polyamide; triethylenetetramine and olyoxypropylenediamine; polyether amine; polyamine; phenalkamine and polyamide; phenalkamine; or a combination thereof.

103. The coating of claim 101 or 102, wherein the amine hardener comprises primary amine-modified phenalkamine, benzyl dimethylamine, N,N-di-(2-hydroxyethyl)aniline, triethanolamine, aminopropyltriethoxysilane, bis(3-triethoxysilylpropyl)amine, or a combination thereof.

104. The coating of claim 101, wherein the hardener comprises an silamine hardener; for example, wherein the silamine hardener comprises aminopropyltriethoxysilane (Andisil 1100), bis(3-triethoxysilylpropyl)amine (Dynasylan 1146), or N-2-aminoethyl-3-aminopropyltrimethoxysilane (Dynasylan DAMO), or a combination thereof.

105. The coating of any one of claims 101 to 104, wherein the hardener comprises a low-temperature hardener, such as phenalkamine.

106. The coating of any one of claims 101 to 105, wherein the hardener further comprises a curing catalyst.

107. The coating of claim 106, wherein the curing catalyst comprises a low-temperature curing catalyst, such as 2,4,6-tris[(dimethyllamino)methyl]phenol.

108. An additives composition for use in forming a coating, the composition comprising
a sufficient amount of a hydrophobicity-modifying additive that is reactive in an epoxide polymerization for forming a coating having a contact angle of at least 90° when measured with an Ossila Goniometer following ASTM D7334-08(2013); and
a sufficient amount of a wear-inhibiting additive for forming a coating having improved corrosion resistance of at least 1000 hours when measured by salt fog resistance, an increased mechanical strength with a D-shore hardness of at least 40D, or a bending strength of at least 10 mm when measured by a cylindrical bed test.

109. The additives composition of claim 108, further comprising a sufficient amount of an amphiphilicity-modifying additive to provide a coating formed from the composition having a wet coefficient of friction of 0.2 when measured using an ASM 925 COF meter following ASTM D2047.

110. The additives composition of claim 108 or 109, further comprising at least one dispersant for dispersing the wear-inhibiting additive.

111. The additives composition of any one of claims 108 to 110, further comprising at least one defoamer.

112. The additives composition of any one of claims 108 to 111, further comprising at least one rheological additive.

113. The additives composition of any one of claims 108 to 112, wherein the hydrophobicity-modifying additive comprises at least one Si-based additive, at least one fluoro-based additive, at least one maleimide-based additive, or a combination thereof.

114. The additives composition of any one of claims 108 to 113, wherein the hydrophobicity-modifying additive comprises at least one Si-based additive, at least one maleimide-based additive, or a combination thereof.

115. The additives composition of claim 113 or 114, wherein the hydrophobicity-modifying additive comprises a bis-maleimide oligomer, an epoxy-functional silane, an epoxy-functional polydialkylsiloxane, or a combination thereof.

116. The additives composition of claim 115, wherein the hydrophobicity-modifying additive comprises an epoxy-functional silane, an epoxy-functional polydialkylsiloxane, or a combination thereof.

117. The additives composition of claim 115 or 116, wherein the hydrophobicity-modifying additive comprises an epoxy-functional polydialkylsiloxane.

118. The additives composition of any one of claims 113 to 117, wherein the bis-maleimide oligomer comprises BMI 689, BMI 737, BMI 1100, BMI 1400, BMI 1500, BMI 1700, or a combination thereof.

119. The additives composition of any one of claims 113 to 118, wherein the bis-maleimide oligomer comprises BMI 1400, BMI 1500, or BMI 1700, or a combination thereof; for example, in a range of about 10 wt % to about 20 wt %.

120. The additives composition of any one of claims 113 to 119, wherein the epoxy-functional silane comprises glycidoxypropyltrimethoxysilane; for example, in a range of about 0 wt % to about 6 wt %, or in a range of about 1 wt % to about 2 wt %.

121. The additives composition of any one of claims 113 to 120, wherein the epoxy-functional polydialkylsiloxane comprises epoxy-functional polydimethylsiloxane, for example, in a range of about 0.05 wt % to about 10 wt %, or in a range of about 0.5 wt % to about 8 wt %.

122. The additives composition of any one of claims 113 to 121, wherein the at least one fluoro-based additive comprises poly(3,3,3-trifluoropropylmethylsiloxane), a fluoroalkylated acrylate oligomer, or a combination thereof.

123. The additives composition of claim 122, wherein the fluoroalkylated acrylate oligomer comprises Sartomer® CN4002; for example, in a range of about 0.05 wt % to about 5 wt %, or about 0.05 wt % to about 3 wt %.

124. The additives composition of any one of claims 108 to 122, wherein the sufficient amount of the hydrophobicity-modifying additive is sufficient for forming a coating having a contact angle of about 90° to about 130°, or about 90° to about 120°, about 95° to about 120°, or about 100° to about 120°, or about 100° to about 115°.

125. The additives composition of any one of claims 108 to 124, wherein the wear-inhibiting additive comprises unmodified graphene nanoplatelets, unmodified graphite flakes, carbon black, fullerene, titanium dioxide, aluminum oxide, Ca magnesium silicate, zinc oxide, or a combination thereof.

126. The additives composition of claim 125, wherein the wear-inhibiting additive comprises unmodified graphene nanoplatelets, unmodified graphite flakes, titanium dioxide, aluminum oxide, Ca magnesium silicate, or a combination thereof.

127. The additives composition of claim 125 or 126, wherein the unmodified graphene nanoplatelets have a flake size of at least 3 μm; or about 3 μm to about 50 μm; or about 5 μm to about 10 μm.

128. The additives composition of any one of claims 125 to 127, wherein the unmodified graphene nanoplatelets are present in a range of about 0.05 wt % to about 5 wt %; or about 0.3 wt %.

129. The additives composition of any one of claims 125 to 128, wherein the unmodified graphite flakes have a flake size of at least 3 μm; or about 3 μm to about 50 μm; or about 10 μm to about 20 μm.

130. The additives composition of any one of claims 125 to 129, wherein the unmodified graphite flakes are present in a range of about 0.1 wt % to about 10 wt %; or about 5 wt %.

131. The additives composition of any one of claims 125 to 130, wherein the titanium dioxide, aluminum oxide, or Ca magnesium silicate, or combination thereof are present in a range of about 5 wt % to about 30 wt %; or about 10 wt % to about 25 wt %; or about 5 wt % to about 10 wt %.

132. The additives composition of any one of claims 108 to 131, wherein the sufficient amount of the wear-inhibiting additive is sufficient for forming a coating having improved corrosion resistance of about 1500 hours to about 8500 hours, or about 4000 hours to about 7000 hours when measured by salt fog resistance; or an increased mechanical strength with a D-shore hardness of about 65D to about 90D, or about 65D to about 85D, or about 70D to about 80D.

133. The additives composition of claim 109, or any one of claims 110 to 132 when dependent on claim 109, wherein the amphiphilicity-modifying additive comprises a polyether, a polysiloxane, a polyelectrolyte, a polyatomic alcohol, or a combination thereof.

134. The additives composition of claim 133, wherein the polyether comprises a polyalkylene glycol; for example, in a range of about 0.5 wt % to about 10 wt %, or about 1 wt % to about 5 wt %.

135. The additives composition of claim 133 or 134, wherein the polyalkylene glycol comprises polyethylene glycol, polyethylene glycol 400, LIPOXOL® 400, or a combination thereof.

136. The additives composition of any one of claims 133 to 135, wherein the polysiloxane comprises a hydroxyl-functionalized polysiloxane, a hydroxyalkyl-functionalized polysiloxane, a fluorohydroxyalkyl-functionalized polysiloxane, or a combination thereof; for example, in a range of about 1 wt % to about 20 wt %, or about 5 wt % to about 15 wt %.

137. The additives composition of claim 136, wherein the polysiloxane comprises Silmer® OHT Di-10, Silmer® OHT Di-50, Silmer® OHT Di-100, Silmer® OHFB10, or a combination thereof.

138. The additives composition of any one of claims 133 to 137, wherein the polyelectrolyte comprises an ammonium-functionalized polysiloxane; for example, a dialkyl quaternary ammonium modified-polysiloxane.

139. The additives composition of claim 138, wherein the polyelectrolyte is present in a range of about 0.5 wt % to about 10 wt %, or about 1 wt % to about 5 wt %.

140. The additives composition of claim 138 or 139, wherein the polyelectrolyte comprises Silquat®3180.

141. The additives composition of any one of claims 133 to 140, wherein the polyatomic alcohol comprises glycerol; for example, in a range of about 0.5 wt % to about 10 wt %, or about 1 wt % to about 5 wt %.

142. The additives composition of claim 133 to 141, wherein the sufficient amount of the amphiphilicity-modifying additive provides a coating formed from the composition having a wet coefficient of friction when measured using an ASM 925 COF meter following ASTM D2047 of about 0.05 to about 0.2; or about 0.05 to about 0.15; or about 0.06 to about 0.11; or about 0.08 to about 0.12.

143. The additives composition of claim 110, or any one of claims 111 to 142 when dependent on claim 110, wherein the at least one dispersant is a polymeric dispersant; for example, wherein the polymeric dispersant is Additol VXW 6208, Soldplus D610, K-Sperse A504, or a combination thereof; and wherein the polymeric dispersant is optionally present in a range of about 0.1 wt % to about 5 wt %.

144. The additives composition of claim 111, or any one of claims 112 to 143 when dependent on claim 111, wherein the defoamer comprises a silicone-modified defoamer; for example, Additol VXW 6210N, BYK-A 530, Tego Airex 900®, or a combination thereof.

145. The additives composition of claim 144, wherein the silicone-modified defoamer comprises Additol VXW 6210N; for example, in a range of about 0.5 wt % to about 6 wt %.

146. The additives composition of claim 144 or 145, wherein the silicone-modified defoamer comprises Tego Airex 900®, for example, in a range of about 0.05 wt % to about 2 wt %.

147. The additives composition of claim 112, or any one of claims 113 to 146 when dependent on claim 112, wherein the at least one rheological additive comprises a fumed silica, a castor oil derivative, such as Thixatrol ST®; bentonite, montmorillonite, or a modified montmorillonite clay; or combination thereof; for example, in a range of about 0.01 wt % to about 3 wt %.

148. A kit comprising the additives composition of any one of claims 108 to 147 and instructions for adding said additives to a composition for a coating.

149. The kit of claim 148, wherein the composition for a coating comprises epoxy-functional monomers and a diluent.

150. The kit of claim 149, wherein the epoxy-functional monomers comprise:
bisphenol diglycidyl ethers;
epoxy-functional epoxide-siloxane monomers;
a reaction product of epichlorohydrin and one or more of hydroxyl-functional aromatics, alcohols, thiols, acids, acid anhydrides, cycloaliphatics and aliphatics, polyfunctional amines, and amine functional aromatics;
a reaction product of the oxidation of unsaturated cycloaliphatics; or
a combination thereof.

151. The kit of claim 149 or 150, wherein the epoxy-functional monomers comprise bisphenol diglycidyl ethers, such as bisphenol diglycidyl ethers derived from bisphenol A, bisphenol F, bisphenol S, or a combination thereof; epoxy-functional epoxide-siloxane monomers, such as epoxy-functional epoxide-siloxane monomers that comprise an epoxide backbone comprising siloxane or polysiloxane side-chains; or a combination thereof.

152. The kit of claim 151, wherein the epoxide backbone is a polyether backbone; and/or the siloxane or polysiloxane side-chains are linear, branched, or crosslinked.

153. The kit of claim 151 or 152, wherein at least one of the siloxane or polysiloxane side-chains is a cross-linked silicone resin.

154. The kit of any one of claims 150 to 153, wherein the epoxy-functional epoxide-siloxane monomers comprise a reaction product of isocyanate and/or polyurethane oligomers, silane oligomers, and epoxy oligomers.

155. The kit of any one of claims 150 to 154, wherein the epoxy-functional epoxide-siloxane monomers comprise an epoxy-functional epoxide-siloxane pre-polymer.

156. The kit of any one of claims 150 to 155, wherein the epoxy-functional epoxide-siloxane monomers comprise a 3-ethylcyclohexylepoxy copolymer modified with dimethylsiloxane side-chains, an epoxy bisphenol A (2,2-Bis(4′-glycidyloxyphenyl)propane) modified with the poly-dimethylsiloxane side-chains, a siloxane modified hybrid epoxy resin, a siliconeepoxide resin, an epoxy-functional epoxide-backbone functionalized with a crosslinked silicone resin comprising terminal alkoxy groups, or a combination thereof; and/or Silikopon® ED, Silikopon® EF, EPOSIL Resin 5550®, or a combination thereof.

157. The kit of any one of claims 149 to 156, wherein the epoxy-functional monomers do not comprise elastomeric monomers, pre-polymers, or resins; and/or epoxy-functional elastomeric monomers, pre-polymers, or resins; such as butenes, polybutenes, butadienes, polybutadienes, nitrites acrylonitiriles, polysulfides, urethanes, urethane-modified resins (for example, urethane-modified epoxy resins), or combinations thereof.

158. The kit of any one of claims 148 to 157, wherein the diluent comprises a reactive diluent that is reactive in an epoxide polymerization, a non-reactive diluent, or a combination thereof; and/or the diluent is reactive as a curing catalyst.

159. The kit of claim 158, wherein the reactive diluent comprises poly[(phenyl glycidyl ether)-co-formaldehyde], alkyl (C12-C14) glycidyl ether, phenyl glycidyl ether, butyl glycidyl ether, 2-ethylhexyl glycidyl ether, o-cresol glycidyl ether, cycloaliphatic glycidyl ether, dipropylene glycol n-propyl ether, dipropylene glycol dimethyl ether, or a combination thereof; wherein the reactive diluent preferably comprises poly[(phenyl glycidyl ether)-co-formaldehyde],alkyl (C12-C14) glycidyl ether, or a combination thereof.

160. The kit of any one of claims 148 to 159, wherein the non-reactive diluent comprises xylene, methyl acetate, methyl ethyl ketone nonyl phenol, cyclohexanedimethanol, n-butyl alcohol, benzyl alcohol, isopropyl alcohol, propylene glycol, phenol, or a combination thereof; wherein the non-reactive diluent preferably comprises benzyl alcohol, xylene, methyl acetate, methyl ethyl ketone, or a combination thereof.

161. The kit of any one of claims 148 to 160, wherein the composition for a coating further comprises a hardener.

162. The kit of claim 161, wherein the hardener comprises an amine hardener, an amide hardener, or a combination thereof; for example, wherein the amine hardener, amide hardener, or combination thereof comprises: a reaction product of triethylenetetramine with phenol and formaldehyde and polyethylenepolyamines; polyamide; triethylenetetramine and olyoxypropylenediamine; polyether amine; polyamine; phenalkamine and polyamide; phenalkamine; or a combination thereof.

163. The kit of claim 161 or 162, wherein the amine hardener comprises primary amine-modified phenalkamine, benzyl dimethylamine, N,N-di-(2-hydroxyethyl)aniline, triethanolamine, aminopropyltriethoxysilane, bis(3-triethoxysilylpropyl)amine, or a combination thereof.

164. The kit of claim 161, wherein the hardener comprises an silamine hardener; for example, wherein the silamine hardener comprises aminopropyltriethoxysilane (Andisil 1100), bis(3-triethoxysilylpropyl)amine (Dynasylan 1146), or N-2-aminoethyl-3-aminopropyltrimethoxysilane (Dynasylan DAMO), or a combination thereof.

165. The kit of any one of claims 161 to 164, wherein the hardener comprises a low-temperature hardener; such as, phenalkamine.

166. The kit of any one of claims 161 to 165, wherein the hardener further comprises a curing catalyst, such as 2,4,6-tris[(dimethyllamino)methyl]phenol, benzyl dimethylamine (BDMA), imidazole, N,N-di-(2-hydroxyethyl)aniline, 2,4,6-tris[(dimethyllamino)methyl]phenol, triethanolamine, or a combination thereof.

167. The kit of claim 166, wherein the curing catalyst comprises a low-temperature curing catalyst; such as 2,4,6-tris[(dimethyllamino)methyl]phenol.

168. A method of forming a composition for a coating, comprising:
mixing a hydrophobicity-modifying additive into a first mixture comprising epoxy-functional monomers and a diluent; and
forming the composition for a coating.

169. The method of claim 168, further comprising mixing a wear-inhibiting additive and a dispersant into the first mixture.

170. The method of claim 168 or 169, further comprising mixing an amphiphilicity-modifying additive into the first mixture.

171. The method of any one of claims 168 to 170, further comprising mixing a rheological additive and/or a defoamer into the first mixture.

172. The method of claim 169, wherein mixing the hydrophobicity-modifying additive, the wear-inhibiting additive, and the dispersant into the first mixture comprises:
mixing the dispersant into the first mixture to form a second mixture;
mixing the wear-inhibiting additive into the second mixture to form a third mixture; and
mixing the hydrophobicity-modifying additive into the third mixture to form a fourth mixture.

173. The method of claim 172, further comprising mixing a rheological additive into the second mixture or the third mixture.

174. The method of claim 172 to 173, further comprising mixing an amphiphilicity-modifying additive into the third mixture or the fourth mixture.

175. The method of claim 172, wherein mixing the hydrophobicity-modifying additive, the wear-inhibiting additive, and the dispersant into the first mixture comprises:
mixing a first hydrophobicity-modifying additive into the first mixture to form a second mixture;
mixing the dispersant into the second mixture to form a third mixture;
mixing the wear-inhibiting additive into the third mixture to form a fourth mixture;
mixing a defoamer into the fourth mixture to form a fifth mixture; and
mixing a second hydrophobicity-modifying additive into the fifth mixture to form a sixth mixture.

176. The method of claim 175, further comprising mixing an amphiphilicity-modifying additive into the first mixture or the second mixture.

177. The method of claim 175 or 176, further comprising mixing an amphiphilicity-modifying additive into the fifth mixture or the sixth mixture.

178. The method of any one of claims 175 to 177, further comprising mixing a rheological additive into the third mixture or the fourth mixture.

179. The method of any one of claims 168 to 178, further comprising mixing a defoamer into the first mixture.

180. A method of forming a composition for a coating, comprising:
mixing a dispersant into a first mixture comprising a first epoxy-functional monomer and diluent to form a second mixture;
mixing a wear-inhibiting additive into the second mixture to form a third mixture;
mixing a rheological additive into the third mixture to form a fourth mixture;
optionally mixing a first amphiphilicity-modifying additive into the fourth mixture;
mixing a hydrophobicity-modifying additive into the fourth mixture to form a fifth mixture;
mixing a second amphiphilicity-modifying additive into the fifth mixture to form a sixth mixture;
optionally mixing a defoamer into the first or second mixture, or optionally mixing a defoamer into the fifth or sixth mixture;
optionally mixing a mixture comprising a second epoxy-functional monomer and diluent into the the fifth or sixth mixture; and
forming the composition for a coating.

181. A method of forming a composition for a coating, comprising:
mixing epoxy-functional monomers and a diluent to form a first mixture;
mixing into the first mixture
a hydrophobicity-modifying additive,
a wear-inhibiting additive,
a dispersant,
an amphiphilicity-modifying additive,
a defoamer, and/or
a rheological additive; and
forming the composition for a coating.

182. The method of any one of claims 168 to 181, wherein mixing the hydrophobicity-modifying additive comprises adding a sufficient amount of the hydrophobicity-modifying additive to provide a coating formed from the composition having a contact angle of at least 90° when measured with an Ossila Goniometer following ASTM D7334-08(2013); for example, the hydrophobicity-modifying additive is added in an amount sufficient to provide a coating formed from the composition having a contact angle of about 90° to about 130°, or about 90° to about 120°, about 95° to about 120°, or about 100° to about 120°, or about 100° to about 115°.

183. The method of any one of claims 168 to 182, wherein the hydrophobicity-modifying additive comprises at least one Si-based additive, at least one fluoro-based additive, at least one maleimide-based additive, or a combination thereof.

184. The method of any one of claims 168 to 183, wherein the hydrophobicity-modifying additive comprises a bis-maleimide oligomer, an epoxy-functional silane, an epoxy-functional polydialkylsiloxane, or a combination thereof.

185. The method of claim 183 or 184, wherein the bis-maleimide oligomer comprises BMI 689, BMI 737, BMI 1100, BMI 1400, BMI 1500, BMI 1700, or a combination thereof; wherein the bis-maleimide oligomer preferably comprises BMI 1400, BMI 1500, BMI 1700, or a combination thereof, optionally in an amount of about 10 wt % to about 20 wt %.

186. The method of any one of claims 183 to 185, wherein the epoxy-functional silane comprises glycidoxypropyltrimethoxysilane, wherein the glycidoxypropyltrimethoxysilane is optionally added in an amount of about 0 wt % to about 6 wt %, or in a range of about 1 wt % to about 2 wt %.

187. The method of any one of claims 183 to 186, wherein the epoxy-functional polydialkylsiloxane comprises epoxy-functional polydimethylsiloxane wherein the epoxy-functional polydimethylsiloxane is optionally added in an amount of about 0.05 wt % to about 10 wt %, or in a range of about 0.5 wt % to about 8 wt %.

188. The method of any one of claims 183 to 187, wherein the at least one fluoro-based additive comprises poly(3,3,3-trifluoropropylmethylsiloxane), a fluoroalkylated acrylate oligomer, or a combination thereof.

189. The method of claim 188, wherein the fluoroalkylated acrylate oligomer comprises Sartomer® CN4002; for example, in a range of about 0.05 wt % to about 5 wt %, or about 0.05 wt % to about 3 wt %.

190. The method of any one of claims 169 to 189, wherein mixing the wear-inhibiting additive comprises adding a sufficient amount of the wear-inhibiting additive to provide a coating formed from the composition having improved corrosion resistance of at least 1000 hours when measured by salt fog resistance, an increased mechanical strength with a D-shore hardness of at least 40D, or a bending strength of at least 10 mm when measured by a cylindrical bed test.

191. The method of claim 190, wherein the wear-inhibiting additive is added in an amount sufficient to provide a coating formed from the coating composition having improved corrosion resistance of about 1500 hours to about 8500 hours, or about 4000 hours to about 7000 hours when measured by salt fog resistance; or an increased mechanical strength with a D-shore hardness of about 65D to about 90D, or about 65D to about 85D, or about 70D to about 80D.

192. The method of any one of claims 169 to 191, wherein the wear-inhibiting additive comprises unmodified graphene nanoplatelets, unmodified graphite flakes, carbon black, fullerene, titanium dioxide, aluminum oxide, Ca magnesium silicate, zinc oxide, or a combination thereof; wherein the wear-inhibiting additive preferably comprises unmodified graphene nanoplatelets, unmodified graphite flakes, titanium dioxide, aluminum oxide, Ca magnesium silicate, or a combination thereof.

193. The method of claim 192, wherein the unmodified graphene nanoplatelets have a flake size of at least 3 μm; or about 3 μm to about 50 μm; or about 5 μm to about 10 μm.

194. The method of claim 192 or 193, wherein the unmodified graphene nanoplatelets are added in an amount of about 0.05 wt % to about 5 wt %; or about 0.3 wt %.

195. The method of any one of claims 192 to 194, wherein the unmodified graphite flakes have a flake size of at least 3 μm; or about 3 μm to about 50 μm; or about 10 μm to about 20 μm.

196. The method of any one of claims 192 to 195, wherein the unmodified graphite flakes are added in an amount of about 0.1 wt % to about 10 wt %; or about 5 wt %.

197. The method of any one of claims 192 to 196, wherein the titanium dioxide, aluminum oxide, or Ca magnesium silicate, or combination thereof are present in a range of about 5 wt % to about 30 wt %; or about 10 wt % to about 25 wt %; or about 5 wt % to about 10 wt %.

198. The method of any one of claims 170 to 197, wherein mixing the amphiphilicity-modifying additive comprises adding a sufficient amount of the amphiphilicity-modifying additive to provide a coating formed from the composition having a wet coefficient of friction of ≤0.2 when measured using an ASM 925 COF meter following ASTM D2047.

199. The method of claim 198, wherein the amphiphilicity-modifying additive is added in an amount sufficient to provide a coating formed from the composition having a wet coefficient of friction when measured using an ASM 925 COF meter following ASTM D2047 of about 0.05 to about 0.2; or about 0.05 to about 0.15; or about 0.06 to about 0.11; or about 0.08 to about 0.12.

200. The method of any one of claims 170 to 199, wherein the amphiphilicity-modifying additive comprises a polyether, a polysiloxane, a polyelectrolyte, a polyatomic alcohol, or a combination thereof.

201. The method of claim 200, wherein the polyether comprises a polyalkylene glycol; for example, in a range of about 0.5 wt % to about 10 wt %, or about 1 wt % to about 5 wt %.

202. The method of claim 201, wherein the polyalkylene glycol comprises polyethylene glycol, polyethylene glycol 400, LIPOXOL® 400, or a combination thereof.

203. The method of any one of claims 200 to 202, wherein the polysiloxane comprises a hydroxyl-functionalized polysiloxane, a hydroxyalkyl-functionalized polysiloxane, a fluorohydroxyalkyl-functionalized polysiloxane, or a combination thereof; for example, in a range of about 1 wt % to about 20 wt %, or about 5 wt % to about 15 wt %.

204. The method of claim 203, wherein the polysiloxane comprises Silmer® OHT Di-10, Silmer® OHT Di-50, Silmer® OHT Di-100, Silmer® OHFB10, or a combination thereof.

205. The method of any one of claims 200 to 204, wherein the polyelectrolyte comprises an ammonium-functionalized polysiloxane; for example, a dialkyl quaternary ammonium modified-polysiloxane.

206. The method of claim 205, wherein the polyelectrolyte is present in a range of about 0.5 wt % to about 10 wt %, or about 1 wt % to about 5 wt %.

207. The method of claim 205 or 206, wherein the polyelectrolyte comprises Silquat®3180.

208. The method of any one of claims 200 to 207, wherein the polyatomic alcohol comprises glycerol; for example, in a range of about 0.5 wt % to about 10 wt %, or about 1 wt % to about 5 wt %.

209. The method of any one of claims 168 to 208, wherein the dispersant is a polymeric dispersant; for example, wherein the polymeric dispersant is Additol VXW 6208, Soldplus D610, K-Sperse A504, or a combination thereof.

210. The method of claim 209, wherein the polymeric dispersant is added in an amount of about 0.1 wt % to about 5 wt %.

211. The method of any one of claims 168 to 210, wherein the epoxy-functional monomers comprise:
bisphenol diglycidyl ethers;
epoxy-functional epoxide-siloxane monomers;
a reaction product of epichlorohydrin and one or more of hydroxyl-functional aromatics, alcohols, thiols, acids, acid anhydrides, cycloaliphatics and aliphatics, polyfunctional amines, and amine functional aromatics;
a reaction product of the oxidation of unsaturated cycloaliphatics; or
a combination thereof.

212. The method of claim 211, wherein the epoxy-functional monomers comprise bisphenol diglycidyl ethers, such as bisphenol diglycidyl ethers derived from bisphenol A, bisphenol F, bisphenol S, or a combination thereof; epoxy-functional epoxide-siloxane monomers, such as epoxy-functional epoxide-siloxane monomers that comprise an epoxide backbone comprising siloxane or polysiloxane side-chains; or a combination thereof.

213. The method of claim 212, wherein the epoxide backbone is a polyether backbone; and/or the siloxane or polysiloxane side-chains are linear, branched, or crosslinked.

214. The method of claim 212 or 213, wherein at least one of the siloxane or polysiloxane side-chains is a cross-linked silicone resin.

215. The method of any one of claims 211 to 214, wherein the epoxy-functional epoxide-siloxane monomer comprises a reaction product of isocyanate and/or polyurethane oligomers, silane oligomers, and epoxy oligomers.

216. The method of any one of claims 211 to 215, wherein the epoxy-functional epoxide-siloxane monomer comprises an epoxy-functional epoxide-siloxane pre-polymer.

217. The method of any one of claims 211 to 216, wherein the epoxy-functional epoxide-siloxane monomers comprise a 3-ethylcyclohexylepoxy copolymer modified with dimethylsiloxane side-chains, an epoxy bisphenol A (2,2-Bis(4′-glycidyloxyphenyl)propane) modified with the poly-dimethylsiloxane side-chains, a siloxane modified hybrid epoxy resin, a siliconeepoxide resin, an epoxy-functional epoxide-backbone functionalized with a crosslinked silicone resin comprising terminal alkoxy groups, or a combination thereof; and/or Silikopon® ED, Silikopon® EF, EPOSIL Resin 5550®, or a combination thereof.

218. The method of any one of claims 168 to 217, wherein the epoxy-functional monomers do not comprise elastomeric monomers, pre-polymers, or resins; and/or epoxy-functional elastomeric monomers, pre-polymers, or resins; such as butenes, polybutenes, butadienes, polybutadienes, nitrites acrylonitiriles, polysulfides, urethanes, urethane-modified resins (for example, urethane-modified epoxy resins), or combinations thereof.

219. The method of any one of claims 168 to 218, wherein the diluent comprises a reactive diluent that is reactive in an epoxide polymerization, a non-reactive diluent, or a combination thereof; and/or the diluent is reactive as a curing catalyst.

220. The method of claim 219, wherein the reactive diluent comprises poly[(phenyl glycidyl ether)-co-formaldehyde], alkyl (C12-C14) glycidyl ether, phenyl glycidyl ether, butyl glycidyl ether, 2-ethylhexyl glycidyl ether, o-cresol glycidyl ether, cycloaliphatic glycidyl ether, dipropylene glycol n-propyl ether, dipropylene glycol dimethyl ether, or a combination thereof; wherein the reactive diluent preferably comprises poly[(phenyl glycidyl ether)-co-formaldehyde], alkyl (C12-C14) glycidyl ether, or a combination thereof.

221. The method of claim 219 or 220, wherein the non-reactive diluent comprises xylene, methyl acetate, methyl ethyl ketone, nonyl phenol, cyclohexanedimethanol, n-butyl alcohol, benzyl alcohol, isopropyl alcohol, propylene glycol, phenol, or a combination thereof; wherein the non-reactive diluent preferably comprises benzyl alcohol, xylene, methyl acetate, methyl ethyl ketone, or a combination thereof.

222. The method of any one of claims 168 to 221, wherein the defoamer comprises a silicone-modified defoamer; for example, Additol VXW 6210N, BYK-A 530, Tego Airex 900®, or a combination thereof.

223. The method of claim 222, wherein the Additol VXW 6210N is added in an amount of about 0.5 wt % to about 6 wt %.

224. The method of claim 222 or 223, wherein the silicone-modified defoamer comprises Tego Airex 900®, for example, in a range of about 0.05 wt % to about 2 wt %.

225. The method of any one of claims 168 to 224, wherein the at least one rheological additive comprises a fumed silica, a castor oil derivative; bentonite, montmorillonite; or a modified montmorillonite clay, or a combination thereof; for example, in a range of about 0.01 wt % to about 3 wt %.

226. The method of claim 225, wherein the castor oil derivative is Thixatrol ST®.

227. The method of any one of claims 168 to 226, further comprising mixing a hardener into the formed composition for a coating.

228. The method of claim 227, wherein the hardener comprises an amine hardener, an amide hardener, or a combination thereof; for example, wherein the amine hardener, amide hardener, or combination thereof comprises: a reaction product of triethylenetetramine with phenol and formaldehyde and polyethylenepolyamines; polyamide; triethylenetetramine and olyoxypropylenediamine; polyether amine; polyamine; phenalkamine and polyamide; phenalkamine; or a combination thereof.

229. The method of claim 227 or 228, wherein the amine hardener comprises primary amine-modified phenalkamine, benzyl dimethylamine, N,N-di-(2-hydroxyethyl)aniline, triethanolamine, aminopropyltriethoxysilane, bis(3-triethoxysilylpropyl)amine, or a combination thereof.

230. The method of claim 227, wherein the hardener comprises an silamine hardener; for example, wherein the silamine hardener comprises aminopropyltriethoxysilane (Andisil 1100), bis(3-triethoxysilylpropyl)amine (Dynasylan 1146), or N-2-aminoethyl-3-aminopropyltrimethoxysilane (Dynasylan DAMO), or a combination thereof.

231. The method of claim 227, wherein the hardener comprises a low-temperature hardener; such as phenalkamine.

232. The method of any one of claims 227 to 231, wherein the hardener further comprises a curing catalyst, such as 2,4,6-tris[(dimethyllamino)methyl]phenol, benzyl dimethylamine (BDMA), imidazole, N,N-di-(2-hydroxyethyl)aniline, 2,4,6-tris[(dimethyllamino)methyl]phenol, triethanolamine, or a combination thereof.

233. The method of claim 232, wherein the curing catalyst comprises a low-temperature curing catalyst; such as 2,4,6-tris[(dimethyllamino)methyl]phenol.

234. The method of any one of claims 168 to 233, wherein the formed composition for a coating is solvent-borne.

235. The method of claim 168, further comprising mixing a hardener into the formed composition for a coating.

236. The method of claim 235, wherein the hardener comprises:
an amine hardener, an amide hardener, or a combination thereof; for example, wherein the amine hardener, amide hardener, or combination thereof comprises: a reaction product of triethylenetetramine with phenol and formaldehyde and polyethylenepolyamines; polyamide; triethylenetetramine and olyoxypropylenediamine; polyether amine; polyamine; phenalkamine and polyamide; phenalkamine; or a combination thereof;
an amine hardener comprising primary amine-modified phenalkamine, benzyl dimethylamine, N,N-di-(2-hydroxyethyl)aniline, triethanolamine, aminopropyltriethoxysilane, bis(3-triethoxysilylpropyl)amine, or a combination thereof;
an silamine hardener; for example, wherein the silamine hardener comprises aminopropyltriethoxysilane (Andisil 1100), bis(3-triethoxysilylpropyl)amine (Dynasylan 1146), or N-2-aminoethyl-3-aminopropyltrimethoxysilane (Dynasylan DAMO), or a combination thereof; or
a low-temperature hardener; such as phenalkamine.

237. The method of claim 235 or 236, wherein the hardener further comprises a curing catalyst, such as 2,4,6-tris[(dimethyllamino)methyl]phenol, benzyl dimethylamine (BDMA), imidazole, N,N-di-(2-hydroxyethyl)aniline, 2,4,6-tris[(dimethyllamino)methyl]phenol, triethanolamine, or a combination thereof; wherein, for example, the curing catalyst comprises a low-temperature curing catalyst, such as 2,4,6-tris[(dimethyllamino)methyl]phenol.

238. The method of any one of claims 235 to 237, wherein mixing a hardener into the formed composition for a coating comprises mixing into the hardener:
a wear-inhibiting additive comprising unmodified graphene nanoplatelets, unmodified graphite flakes, or a combination thereof;
an amphiphilicity-modifying additive comprising a polyether, a polysiloxane, a polyelectrolyte, a polyatomic alcohol, or a combination thereof,
such as a polyalkylene glycol (for example, polyethylene glycol, polyethylene glycol 400, LIPOXOL® 400, or a combination thereof); a polysiloxane comprising a hydroxyl-functionalized polysiloxane, a hydroxyalkyl-functionalized polysiloxane, a fluorohydroxyalkyl-functionalized polysiloxane, or a combination thereof (for example, Silmer® OHT Di-10, Silmer® OHT Di-50, Silmer® OHT Di-100, Silmer® OHFB10, or a combination thereof); an ammonium-functionalized polysiloxane (for example, Silquat®3180); glycerol; or a combination thereof;
a dispersant comprising a polymeric dispersant such as Additol VXW 6208, Soldplus D610, K-Sperse A504, or a combination thereof;
a diluent comprising dipropylene glycol n-propyl ether, dipropylene glycol dimethyl ether, or a combination thereof; or a non-reactive diluent such as xylene, methyl acetate, methyl ethyl ketone, nonyl phenol, cyclohexanedimethanol, n-butyl alcohol, benzyl alcohol, isopropyl alcohol, propylene glycol, phenol, or a combination thereof;
a defoamer comprising a silicone-modified defoamer such as Additol VXW 6210N, BYK-A 530, Tego Airex 900®, or a combination thereof; and/or
at least one rheological additive comprising a fumed silica, a castor oil derivative (for example, Thixatrol ST®); bentonite, montmorillonite, a modified montmorillonite clay, or a combination thereof; and
mixing the hardener into the formed composition for a coating.

239. The method of any one of claims 235 to 238, wherein mixing a hydrophobicity-modifying additive into the first mixture comprises mixing the hydrophobicity-modifying additive into the hardener and then mixing the hardener into the formed composition for a coating, wherein the hydrophobicity-modifying additive comprises at least one fluoro-based additive, at least one maleimide-based additive, or a combination thereof; for example, wherein the hydrophobicity-modifying additive comprises a bis-maleimide oligomer such as BMI 689, BMI 737, BMI 1100, BMI 1400, BMI 1500, BMI 1700, or a combination thereof, and/or wherein the at least one fluoro-based additive comprises poly(3,3,3-trifluoropropylmethylsiloxane), a fluoroalkylated acrylate oligomer (such as Sartomer® CN4002), or a combination thereof.

240. The composition of claim 1, further comprising:
a sufficient amount of a wear-inhibiting additive to provide a coating formed from the composition having improved corrosion resistance of at least 1000 hours when measured by salt fog resistance, an increased mechanical strength with a D-shore hardness of at least 40D, or a bending strength of at least 10 mm when measured by a cylindrical bed test, such as a sufficient amount of unmodified graphene nanoplatelets, unmodified graphite flakes, carbon black, fullerene, titanium dioxide, aluminum oxide, Ca magnesium silicate, zinc oxide, or a combination thereof;
at least one dispersant for dispersing the wear-inhibiting additive in the composition; and/or
at least one defoamer.

241. The composition of claim 240, wherein
the epoxy-functional monomers comprise bisphenol diglycidyl ethers, such as bisphenol diglycidyl ethers derived from bisphenol A, bisphenol F, bisphenol S, or a combination thereof; a reaction product of epichlorohydrin and one or more of hydroxyl-functional aromatics, alcohols, thiols, acids, acid anhydrides, cycloaliphatics and aliphatics, polyfunctional amines, and amine functional aromatics; a reaction product of the oxidation of unsaturated cycloaliphatics; or a combination thereof;
the diluent comprises a reactive diluent, such as poly[(phenyl glycidyl ether)-co-formaldehyde], alkyl (C12-C14) glycidyl ether, or a combination thereof; a non-reactive diluent such as xylene, methyl acetate, methyl ethyl ketone, nonyl phenol, cyclohexanedimethanol, n-butyl alcohol, benzyl alcohol, isopropyl alcohol, propylene glycol, phenol, or a combination thereof; or a combination thereof; and/or
the hydrophobicity-modifying additive comprises a bis-maleimide oligomer, such as BMI 689, BMI 737, BMI 1100, BMI 1400, BMI 1500, BMI 1700, or a combination thereof; an epoxy-functional silane, such as glycidoxypropyltrimethoxysilane; an epoxy-functional polydialkylsiloxane, such as epoxy-functional polydimethylsiloxane; or a combination thereof.

242. The composition of claim 241, wherein
the epoxy-functional monomers comprise bisphenol diglycidyl ethers derived from bisphenol A, bisphenol F, bisphenol S, or a combination thereof;
the diluent comprises a poly[(phenyl glycidyl ether)-co-formaldehyde], alkyl (C12-C14) glycidyl ether, benzyl alcohol; or a combination thereof; and/or
the hydrophobicity-modifying additive comprises a BMI 689, BMI 737, BMI 1100, BMI 1400, BMI 1500, BMI 1700, or a combination thereof; glycidoxypropyltrimethoxysilane; epoxy-functional polydimethylsiloxane; or a combination thereof.

243. The composition of any one of claims 240 to 242, wherein
the wear-inhibiting additive comprises unmodified graphene nanoplatelets, unmodified graphite flakes, or a combination thereof;
the at least one dispersant is a polymeric dispersant, such as Additol VXW 6208, Soldplus D610, K-Sperse A504, or a combination thereof; and/or
the defoamer comprises a silicone-modified defoamer, such as Additol VXW 6210N, BYK-A 530, or a combination thereof.

244. The composition of any one of claims 240 to 243, further comprising
an amine hardener, an amide hardener, or a combination thereof; for example, wherein the amine hardener, amide hardener, or combination thereof comprises: a reaction product of triethylenetetramine with phenol and formaldehyde and polyethylenepolyamines; polyamide; triethylenetetramine and polyoxypropylenediamine; polyether amine; polyamine; phenalkamine and polyamide; phenalkamine; or a combination thereof; and
optionally a curing catalyst, such as 2,4,6-tris[(dimethyllamino)methyl]phenol, benzyl dimethylamine (BDMA), imidazole, N,N-di-(2-hydroxyethyl)aniline, 2,4,6-tris[(dimethyllamino)methyl]phenol, triethanolamine, or a combination thereof.

245. The composition of claim 1, further comprising:
a sufficient amount of a wear-inhibiting additive to provide a coating formed from the composition having improved corrosion resistance of at least 1000 hours when measured by salt fog resistance, an increased mechanical strength with a D-shore hardness of at least 40D, or a bending strength of at least 10 mm when measured by a cylindrical bed test, such as a sufficient amount of unmodified graphene nanoplatelets, unmodified graphite flakes, carbon black, fullerene, titanium dioxide, aluminum oxide, Ca magnesium silicate, zinc oxide, or a combination thereof;
at least one dispersant for dispersing the wear-inhibiting additive in the composition;
a sufficient amount of an amphiphilicity-modifying additive to provide a coating formed from the composition having a wet coefficient of friction of ≤0.2 when measured using an ASM 925 COF meter following ASTM D2047;
at least one defoamer; and/or
at least one rheological additive.

246. The composition of claim 245, wherein
the epoxy-functional monomers comprise
bisphenol diglycidyl ethers, such as bisphenol diglycidyl ethers derived from bisphenol A, bisphenol F, bisphenol S, or a combination thereof;
epoxy-functional epoxide-siloxane monomers, such as a 3-ethylcyclohexylepoxy copolymer modified with dimethylsiloxane side-chains, an epoxy bisphenol A (2,2-Bis(4′-glycidyloxyphenyl)propane) modified with the poly-dimethylsiloxane side-chains, a siloxane modified hybrid epoxy resin, a siliconeepoxide resin, an epoxy-functional epoxide-backbone functionalized with a crosslinked silicone resin comprising terminal alkoxy groups, Silikopon® ED, Silikopon® EF, EPOSIL Resin 5550®, or a combination thereof;
a reaction product of epichlorohydrin and one or more of hydroxyl-functional aromatics, alcohols, thiols, acids, acid anhydrides, cycloaliphatics and aliphatics, polyfunctional amines, and amine functional aromatics; a reaction product of the oxidation of unsaturated cycloaliphatics;
or a combination thereof;
the diluent comprises a reactive diluent, such as poly[(phenyl glycidyl ether)-co-formaldehyde], alkyl (C12-C14) glycidyl ether, butyl glycidyl ether, or a combination thereof; non-reactive diluent such as xylene, methyl acetate, methyl ethyl ketone, nonyl phenol, cyclohexanedimethanol, n-butyl alcohol, benzyl alcohol, isopropyl alcohol, propylene glycol, phenol, or a combination thereof; or a combination thereof; and/or
the hydrophobicity-modifying additive comprises an epoxy-functional silane, such as glycidoxypropyltrimethoxysilane; an epoxy-functional polydialkylsiloxane, such as epoxy-functional polydimethylsiloxane; or a combination thereof.

247. The composition of claim 246, wherein
the epoxy-functional monomers comprise
bisphenol diglycidyl ethers derived from bisphenol A, bisphenol F, bisphenol S, or a combination thereof;
epoxy-functional epoxide-siloxane monomers comprising a 3-ethylcyclohexylepoxy copolymer modified with dimethylsiloxane side-chains, an epoxy bisphenol A (2,2-Bis(4′-glycidyloxyphenyl)propane) modified with the poly-dimethylsiloxane side-chains, a siloxane modified hybrid epoxy resin, a siliconeepoxide resin, an epoxy-functional epoxide-backbone functionalized with a crosslinked silicone resin comprising terminal alkoxy groups, Silikopon® ED, Silikopon® EF, EPOSIL Resin 5550®, or a combination thereof;
or a combination thereof;
the diluent comprises alkyl (C12-C14) glycidyl ether, butyl glycidyl ether, xylene, methyl acetate, methyl ethyl ketone, benzyl alcohol, or a combination thereof; and/or
the hydrophobicity-modifying additive comprises glycidoxypropyltrimethoxysilane;
epoxy-functional polydimethylsiloxane; or a combination thereof.

248. The composition of any one of claims 245 to 247, wherein
the wear-inhibiting additive comprises unmodified graphene nanoplatelets, unmodified graphite flakes, titanium dioxide, aluminum oxide, Ca magnesium silicate, or a combination thereof;
the at least one dispersant is a polymeric dispersant, such as Additol VXW 6208, Soldplus D610, K-Sperse A504, or a combination thereof;
the amphiphilicity-modifying additive comprises a polyether, a polysiloxane, a polyelectrolyte, a polyatomic alcohol, or a combination thereof,
such as a polyalkylene glycol (for example, polyethylene glycol, polyethylene glycol 400, LIPOXOL® 400, or a combination thereof); a polysiloxane comprising a hydroxyl-functionalized polysiloxane, a hydroxyalkyl-functionalized polysiloxane, a fluorohydroxyalkyl-functionalized polysiloxane, or a combination thereof (for example, Silmer® OHT Di-10, Silmer® OHT Di-50, Silmer® OHT Di-100, Silmer® OHFB10, or a combination thereof); an ammonium-functionalized polysiloxane (for example, Silquat®3180); glycerol; or a combination thereof;
the defoamer comprises a silicone-modified defoamer, such as Additol VXW 6210N, Tego Airex 900®, or a combination thereof; and/or
the at least one rheological additive comprises a fumed silica, a castor oil derivative (such as Thixatrol ST®); bentonite, montmorillonite; or a modified montmorillonite clay, or a combination thereof.

249. The composition of any one of claims 245 to 248, further comprising an silamine hardener, such as aminopropyltriethoxysilane (Andisil 1100), bis(3-triethoxysilylpropyl)amine (Dynasylan 1146), or N-2-aminoethyl-3-aminopropyltrimethoxysilane (Dynasylan DAMO), or a combination thereof; and
optionally a curing catalyst, such as, such as 2,4,6-tris[(dimethyllamino)methyl]phenol, benzyl dimethylamine (BDMA), imidazole, N,N-di-(2-hydroxyethyl)aniline, 2,4,6-tris[(dimethyllamino)methyl]phenol, triethanolamine, or a combination thereof.
